(19) United States
(12) Patent Application Publication
(10) Pub. No.: US 2026/0279327 A1
(43) Pub. Date: Sep. 17, 2026

(54) NOISE SUPPRESSING APPARATUS, NOISE SUPPRESSION METHOD, AND PROGRAM

(71) Applicant: Sony Group Corporation, Tokyo (JP)

(72) Inventors: Shigetoshi Hayashi, Tokyo (JP); Yoshiyuki Kuroda, Chiba (JP); Tetsunori Itabashi, Kanagawa (JP)

(73) Assignee: Sony Group Corporation, Tokyo (JP)

(21) Appl. No.: 19/166,122

(22) PCT Filed: Mar. 7, 2024
(86) PCT No.: PCT/JP2024/008687

§ 371 Date: Sep. 17, 2025

(30) Foreign Application Priority Data
Mar. 31, 2023 (JP) 2023-058596

(51) Int. Cl. G10K 11/178; B60R 11/02

(52) U.S. Cl. CPC G10K 11/17821; B60R 11/0247; G10K 11/17853

(57) ABSTRACT

The present disclosure relates to a noise suppressing apparatus, a noise suppression method, and a program that make it possible to appropriately reduce noise.

When a sudden sound is sensed on the basis of a sensor signal of a sensor in an FF-scheme NC apparatus, a drive signal to be supplied to an actuator in an FB-scheme NC apparatus is reduced. This can be applied to an NC apparatus.

### TECHNICAL FIELD

The present disclosure relates to a noise suppressing apparatus, a noise suppression method, and a program, and in particular relates to a noise suppressing apparatus, a noise suppression method, and a program that make it possible to appropriately reduce noise.

### BACKGROUND ART

There has been proposed a technology for reducing noise inside a vehicle in which technology a microphone (error microphone) that senses noise is installed at a position near an ear of a user as a control point, and an inverse phase sound is generated such that collected noise is canceled (see PTL 1).

However, in the invention of PTL 1, the microphone that collects noise is installed at a fixed position near an ear of a user as a control point, but there is a fear that noise cannot be reduced appropriately due to changes in seat position or changes in orientation of the head of the user.

In view of this, there is proposed a technology for adaptively reducing noise according to the seat position or the orientation of the head of a user (see PTL 2).

### CITATION LIST

### Patent Literature

[PTL 1]
JP H6-332469A
[PTL 2]
JP 2022-59096A

### SUMMARY

### Technical Problem

However, since changes in the states of tires or road surfaces which are sound sources of noise are not tracked, there is a fear that noise cannot be reduced appropriately. The present disclosure has been made in view of such a situation, and in particular makes it possible to appropriately reduce noise.

### Solution to Problem

A noise suppressing apparatus and a program according to an aspect of the present disclosure are a noise suppressing apparatus and a program including a first processing section that executes a process to reduce noise at a control point by generating and outputting a sound to cancel the noise or a vibration to excite a noise-source vibrating object, on the basis of a first sensor signal including an acceleration of the object, and a second processing section that executes a process to reduce noise at a control point by generating and outputting a sound to cancel the noise or a vibration to excite a noise-source vibrating object, on the basis of a second sensor signal that is different from the first sensor signal and includes an acceleration of the object. When a sudden sound is sensed on the basis of the first sensor signal, a drive signal at the second processing section is adjusted.

A noise suppression method according to an aspect of the present disclosure is a noise suppression method including steps of executing a first process to reduce noise at a control point by generating and outputting a sound to cancel the noise or a vibration to excite a noise-source vibrating object, on the basis of a first sensor signal including an acceleration of the object, and executing a second process to reduce noise at a control point by generating and outputting a sound to cancel the noise or a vibration to excite a noise-source vibrating object, on the basis of a second sensor signal that is different from the first sensor signal and includes an acceleration of the object. When a sudden sound is sensed on the basis of the first sensor signal, a drive signal in the second process is adjusted.

In an aspect of the present disclosure, a first processing section executes a process to reduce noise at a control point by generating and outputting a sound to cancel the noise or a vibration to excite a noise-source vibrating object, on the basis of a first sensor signal including an acceleration of the object, and a second processing section executes a process to reduce noise at a control point by generating and outputting a sound to cancel the noise or a vibration to excite a noise-source vibrating object, on the basis of a second sensor signal that is different from the first sensor signal and includes an acceleration of the object. When a sudden sound is sensed on the basis of the first sensor signal, a drive signal at the second processing section is adjusted.

### BRIEF DESCRIPTION OF DRAWINGS

FIG. 1 is a block diagram depicting a configuration example of a vehicle control system.

FIG. 2 is a figure depicting an example of sensing areas.

FIG. 3 is a figure for explaining an FF-scheme NC apparatus which is a first embodiment of the present disclosure.

FIG. 4 is a functional block diagram for explaining functions realized by the FF-scheme NC apparatus.

FIG. 5 is a functional block diagram for explaining a configuration example of a filter generation processing section that generates a sensor filter set and a cancellation filter set to be used by the NC apparatus in FIG. 4.

FIG. 6 is a functional block diagram for explaining functions realized by a filter designing section in FIG. 4 and FIG. 5.

FIG. 7 is a flowchart for explaining a filter generation process performed by the filter generation processing section in FIG. 5.

FIG. 8 is a flowchart for explaining an NC process performed by the NC apparatus in FIG. 4.

FIG. 9 is a figure for explaining the FF-scheme NC apparatus which is a first modification example of the first embodiment of the present disclosure.

FIG. 10 is a functional block diagram for explaining a configuration example of the filter generation processing section that generates the sensor filter set and the cancellation filter set to be used by the NC apparatus in FIG. 9.

FIG. 11 is a figure for explaining the FF-scheme NC apparatus which is a second modification example of the first embodiment of the present disclosure.

FIG. 12 is a functional block diagram for explaining a configuration example of the filter generation processing section that generates the sensor filter set and the cancellation filter set to be used by the NC apparatus in FIG. 11.

FIG. 13 is a flowchart for explaining the filter generation process performed by the filter generation processing section in FIG. 12.

FIG. 14 is a flowchart for explaining the NC process performed by the NC apparatus in FIG. 11.

FIG. 15 is a figure for explaining the FF-scheme NC apparatus which is a third modification example of the first embodiment of the present disclosure.

FIG. 16 is a functional block diagram for explaining a configuration example of the filter generation processing section that generates the sensor filter set and the cancellation filter set to be used by the NC apparatus in FIG. 15.

FIG. 17 is a flowchart for explaining the filter generation process performed by the filter generation processing section in FIG. 16.

FIG. 18 is a flowchart for explaining the NC process performed by the NC apparatus in FIG. 15.

FIG. 19 is a figure for explaining the FF-scheme NC apparatus which is a fourth modification example of the first embodiment of the present disclosure.

FIG. 20 is a functional block diagram for explaining a configuration example of the filter generation processing section that generates the sensor filter set and the cancellation filter set to be used by the NC apparatus in FIG. 19.

FIG. 21 is a figure for explaining an FB-scheme NC apparatus which is a second embodiment of the present disclosure.

FIG. 22 is a figure for explaining an appearance configuration of the NC apparatus in FIG. 22.

FIG. 23 is a figure for explaining a configuration example of an actuator in the NC apparatus in FIG. 21.

FIG. 24 is a figure for explaining a configuration example of an NC processing section in the NC apparatus in FIG. 21.

FIG. 25 is a flowchart for explaining the NC process performed by the NC apparatus in FIG. 21.

FIG. 26 is a figure for explaining a configuration example of an actuator which is a first modification example of the second embodiment of the present disclosure.

FIG. 27 is a figure for explaining a configuration example of an actuator which is a second modification example of the second embodiment of the present disclosure.

FIG. 28 is a figure for explaining a method of installing the actuator in FIG. 27.

FIG. 29 is a figure for explaining a method of replacing a driving section of the actuator in FIG. 27.

FIG. 30 is a figure for explaining a configuration example of an actuator which is a third modification example of the second embodiment of the present disclosure.

FIG. 31 is a figure for explaining a configuration example of an actuator which is a fourth modification example of the second embodiment of the present disclosure.

FIG. 32 is a figure for explaining a configuration example of an actuator which is a fifth modification example of the second embodiment of the present disclosure.

FIG. 33 is a figure for explaining a configuration example of an actuator which is a sixth modification example of the second embodiment of the present disclosure.

FIG. 34 is a figure for explaining a configuration example of an actuator which is a seventh modification example of the second embodiment of the present disclosure.

FIG. 35 is a figure for explaining compliance characteristics according to temperature of a damper of the actuator.

FIG. 36 is a figure for explaining a configuration example of an NC processing section which is an eighth modification example of the second embodiment of the present disclosure.

FIG. 37 is a flowchart for explaining an operation mode control process performed by the NC processing section in FIG. 36.

FIG. 38 is a figure for explaining a configuration example of an NC processing section which is a ninth modification example of the second embodiment of the present disclosure.

FIG. 39 is a flowchart for explaining an operation mode control process performed by the NC processing section in FIG. 38.

FIG. 40 is a figure for explaining a configuration example of an NC processing section which is a ninth modification example of the second embodiment of the present disclosure.

FIG. 41 is a figure for explaining an example of sensing of roughness of a road surface using a LiDAR.

FIG. 42 is a figure for explaining an NC apparatus combining an FB-scheme NC apparatus and an FF-scheme NC apparatus.

FIG. 43 is a figure for explaining a difference in transmission of a sudden sound between a sensor of the FB-scheme NC apparatus and a sensor of the FF-scheme NC apparatus.

FIG. 44 is a figure for explaining an NC apparatus combining an FB-scheme NC apparatus and an FF-scheme NC apparatus which is a third embodiment of the present disclosure.

FIG. 45 is a functional block diagram for explaining functions realized by the NC apparatus in FIG. 44.

FIG. 46 is a figure for explaining a sudden sound countermeasure process.

FIG. 47 is a flowchart for explaining the sudden sound countermeasure process performed by the NC apparatus in FIG. 45.

FIG. 48 is a figure for explaining a configuration example of an NC apparatus which is a first modification example of the third embodiment of the present disclosure.

FIG. 49 is a figure for explaining an example of a filter gain of an NC filter to cancel a vibration level when a sudden sound occurs.

FIG. 50 is a flowchart for explaining the sudden sound countermeasure process performed by the NC apparatus in FIG. 48.

FIG. 51 is a figure for explaining a configuration example of an NC apparatus which is a second modification example of the third embodiment of the present disclosure.

FIG. 52 is a flowchart for explaining the sudden sound countermeasure process performed by the NC apparatus in FIG. 51.

FIG. 53 is a figure for explaining a configuration example of an NC apparatus which is a third modification example of the third embodiment of the present disclosure.

FIG. 54 is a figure for explaining an NC apparatus which is a fourth modification example of the third embodiment of the present disclosure.

FIG. 55 is a functional block diagram for explaining functions realized by the NC apparatus in FIG. 54.

FIG. 56 is a flowchart for explaining the NC process performed by the NC apparatus in FIG. 55.

FIG. 57 is a figure for explaining an NC apparatus which is a fifth modification example of the third embodiment of the present disclosure.

FIG. 58 is a functional block diagram for explaining functions realized by the NC apparatus in FIG. 57.

FIG. 59 is a flowchart for explaining the NC process performed by the NC apparatus in FIG. 58.

FIG. 60 is a figure for explaining an NC apparatus which is a sixth modification example of the third embodiment of the present disclosure.

FIG. 61 is a functional block diagram for explaining functions realized by the NC apparatus in FIG. 60.

FIG. 62 is a figure for explaining an NC apparatus which is a seventh modification example of the third embodiment of the present disclosure.

FIG. 63 is a figure for explaining a GUI for making settings of an NC apparatus which is an eighth modification example of the third embodiment of the present disclosure.

FIG. 64 depicts a configuration example of a general-purpose computer.

### DESCRIPTION OF EMBODIMENTS

Hereinbelow, preferred embodiments of the present disclosure are explained in detail with reference to the attached figures. Note that, in the present specification and the figures, constituent elements having substantially identical functional configurations are given identical reference signs, and overlapping explanations thereof are omitted.

Hereinbelow, modes for carrying out the present technology are explained. The explanation is given in the following order.
1. Configuration Example of Vehicle Control System
2. First Embodiment
3. First Modification Example of First Embodiment
4. Second Modification Example of First Embodiment
5. Third Modification Example of First Embodiment
6. Fourth Modification Example of First Embodiment
7. Second Embodiment
8. First Modification Example of Second Embodiment
9. Second Modification Example of Second Embodiment
10. Third Modification Example of Second Embodiment
11. Fourth Modification Example of Second Embodiment
12. Fifth Modification Example of Second Embodiment
13. Sixth Modification Example of Second Embodiment
14. Seventh Modification Example of Second Embodiment
15. Eighth Modification Example of Second Embodiment
16. Ninth Modification Example of Second Embodiment
17. Tenth Modification Example of Second Embodiment
18. Third Embodiment
19. First Modification Example of Third Embodiment
20. Second Modification Example of Third Embodiment
21. Third Modification Example of Third Embodiment
22. Fourth Modification Example of Third Embodiment
23. Fifth Modification Example of Third Embodiment
24. Sixth Modification Example of Third Embodiment
25. Seventh Modification Example of Third Embodiment
26. Eighth Modification Example of Third Embodiment
27. Example of Execution by Software

### 1. Configuration Example of Vehicle Control System

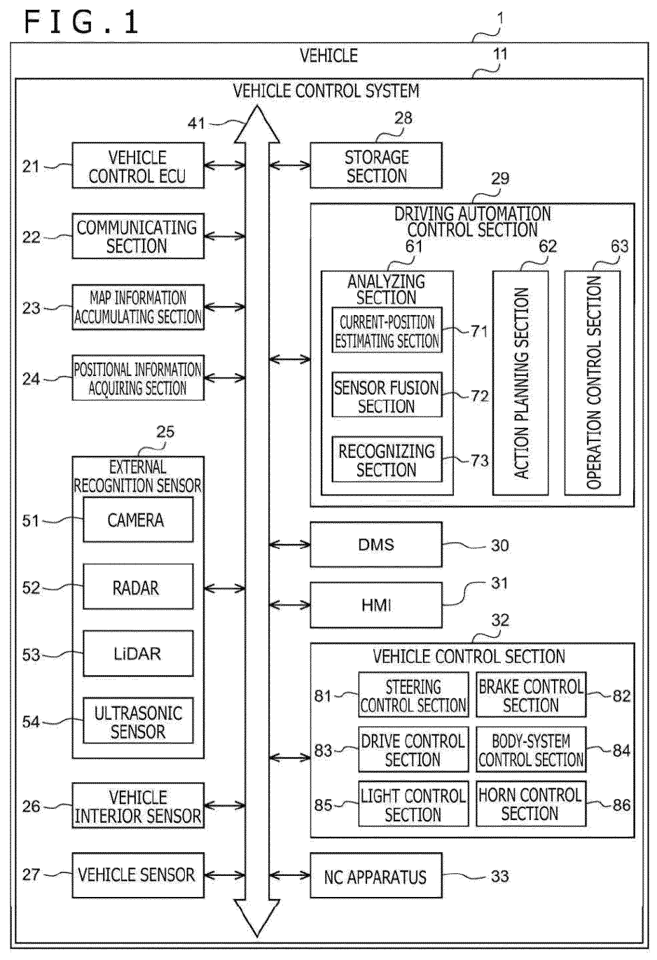

FIG. 1 is a block diagram depicting a configuration example of a vehicle control system 11 which is an example of a moving apparatus control system to which the present technology is applied.

The vehicle control system 11 is provided on a vehicle 1 and performs processes related to driving automation of the vehicle 1. The driving automation includes driving automation of Level 1 to Level 5, and remote driving and remote assistance of the vehicle 1 by a remote driver.

The vehicle control system 11 includes a vehicle control ECU (Electronic Control Unit) 21, a communicating section 22, a map information accumulating section 23, a positional information acquiring section 24, an external recognition sensor 25, a vehicle interior sensor 26, a vehicle sensor 27, a storage section 28, a driving automation control section 29, a DMS (Driver Monitoring System) 30, an HMI (Human Machine Interface) 31, a vehicle control section 32, and an NC (Noise Cancelling) apparatus 33.

The vehicle control ECU 21, the communicating section 22, the map information accumulating section 23, the positional information acquiring section 24, the external recognition sensor 25, the vehicle interior sensor 26, the vehicle sensor 27, the storage section 28, the driving automation control section 29, the DMS 30, the HMI 31, the vehicle control section 32, and the NC apparatus 33 are mutually communicatively connected via a communication network 41. For example, the communication network 41 includes an in-vehicle communication network, a bus, or the like conforming to a digital bidirectional communication standard such as a CAN (Controller Area Network), a LIN (Local Interconnect Network), a LAN (Local Area Network), FlexRay (registered trademark), or Ethernet (registered trademark). Different networks may be used as the communication network 41 depending on types of transferred data. For example, a CAN may be applied to data related to vehicle control, and Ethernet may be applied to large-volume data. Note that, in some cases, the respective sections of the vehicle control system 11 are connected directly bypassing the communication network 41, by use of, for example, wireless communication that is supposed to be used for communication over relatively short distances such as NFC (Near Field Communication) or Bluetooth (registered trademark).

Note that, hereinbelow, the description of the communication network 41 is omitted in a case where the respective sections of the vehicle control system 11 communicate via the communication network 41. For example, in a case where the vehicle control ECU 21 and the communicating section 22 communicate via the communication network 41, it is written simply that the vehicle control ECU 21 and the communicating section 22 communicate. For example, the vehicle control ECU 21 includes various types of processor such as a CPU (Central Processing Unit) or an MPU (Micro Processing Unit). The vehicle control ECU 21 controls all or some of functions of the vehicle control system 11.

The communicating section 22 communicates with various pieces of equipment inside the vehicle and outside the vehicle, other vehicles, servers, base stations, and the like and performs transmission and reception of various types of data. At this time, the communicating section 22 can communicate using a plurality of communication schemes.

Communication with the outside of the vehicle that the communicating section 22 can execute is explained briefly. For example, the communicating section 22 communicates with a server on an external network (hereinbelow, called an external server) or the like via a base station or an access point by a wireless communication scheme such as 5G (5th Generation Mobile Communication System), LTE (Long Term Evolution), or DSRC (Dedicated Short Range Communications). For example, the external network that the communicating section 22 communicates with is the Internet, a cloud network, a proprietary network, or the like. The communication scheme that the communicating section 22 uses for the communication with the external network is not limited to a particular type as long as it is a wireless communication scheme that allows digital bidirectional communication at a predetermined communication speed or higher and over a predetermined distance or longer.

In addition, for example, the communicating section 22 can communicate with a terminal near the vehicle 1, using a P2P (Peer To Peer) technology. For example, the terminal near the vehicle 1 is a terminal attached to a pedestrian or a mobile body such as a bicycle that moves at a relatively low speed, a terminal that is installed in a store or the like and positionally fixed, or an MTC (Machine Type Communication) terminal. Further, the communicating section 22 can also perform V2X communication. V2X communication is, for example, communication between the vehicle 1 and another entity such as vehicle to vehicle communication with another vehicle, vehicle to infrastructure communication with roadside equipment or the like, vehicle to home communication, or vehicle to pedestrian communication with a terminal carried by a pedestrian, and the like.

For example, the communicating section 22 can externally receive (Over The Air) a program for updating software that controls operations performed by the vehicle control system 11. Further, the communicating section 22 can externally receive map information, traffic information, information regarding surroundings of the vehicle 1, or the like. In addition, for example, the communicating section 22 can externally transmit information regarding the vehicle 1, information regarding the surroundings of the vehicle 1, or the like. For example, information regarding the vehicle 1 that the communicating section 22 externally transmits includes data representing a state of the vehicle 1, results of recognition by a recognizing section 73, and the like. Further, for example, the communicating section 22 performs communication compatible with a vehicle emergency call system such as eCall.

For example, the communicating section 22 receives radio beacons, optical beacons, and electromagnetic waves transmitted by a road traffic information communication system (VICS (Vehicle Information and Communication System) (registered trademark)) such as FM multiplex broadcasting.

Communication that the communicating section 22 can execute with the inside of the vehicle is explained briefly. For example, the communicating section 22 can communicate with each piece of equipment inside the vehicle using wireless communication. For example, the communicating section 22 can wirelessly communicate with equipment inside the vehicle by a communication scheme that enables digital bidirectional communication at a predetermined communication speed or higher by wireless communication, such as a wireless LAN, Bluetooth, NFC, or WUSB (Wireless USB). This is not the sole example, and the communicating section 22 can also communicate with each piece of equipment inside the vehicle using wired communication. For example, the communicating section 22 can communicate with each piece of equipment inside the vehicle by wired communication via a cable connected to an unillustrated connection terminal. For example, the communicating section 22 can communicate with each piece of equipment inside the vehicle by a communication scheme that enables digital bidirectional communication at a predetermined communication speed or higher by wired communication, such as USB (Universal Serial Bus), HDMI (High-Definition Multimedia Interface) (registered trademark), or MHL (Mobile High-definition Link).

Here, equipment inside the vehicle means, for example, equipment not connected to the communication network 41 inside the vehicle. For example, equipment inside the vehicle may be mobile equipment or wearable equipment carried by a user inside the vehicle such as a driver, information equipment carried into the vehicle and temporarily installed inside the vehicle, and the like.

The map information accumulating section 23 accumulates externally-acquired maps and/or maps created at the vehicle 1. For example, the map information accumulating section 23 accumulates three-dimensional high-precision maps, global maps that have precision lower than the high-precision maps but cover larger areas, or the like.

For example, the high-precision maps are dynamic maps, point cloud maps, vector maps, or the like. For example, each dynamic map is a map including four layers, which are dynamic information, semi-dynamic information, semi-static information, and static information, and is provided from an external server or the like to the vehicle 1. Each point cloud map is a map including point clouds (point cloud data). For example, each vector map is a map in which traffic information or the like such as positions of lanes or traffic lights is associated with the point cloud map to be adapted to driving automation.

For example, the point cloud map and the vector map may be provided from an external server or the like, or may be created at the vehicle 1 as maps for performing matching with a local map mentioned later on the basis of results of sensing by cameras 51, radars 52, a LiDAR 53, or the like, and accumulated in the map information accumulating section 23. In addition, in a case where a high-precision map is provided from an external server or the like, map data related to a planned path that the vehicle 1 is about to travel, for example, map data of several hundred square meters of area along the planned path, is acquired from the external server or the like in order to reduce the amount of communicated data.

The positional information acquiring section 24 receives GNSS (Global Navigation Satellite System) signals from GNSS satellites and acquires positional information regarding the vehicle 1. The acquired positional information is supplied to the driving automation control section 29. Note that the positional information acquiring section 24 may acquire positional information not necessarily by a scheme using GNSS signals, but by using beacons, for example.

The external recognition sensor 25 includes various types of sensor used for recognition of a condition outside the vehicle 1, and supplies sensor data from each sensor to the respective sections of the vehicle control system 11. The types and number of sensors included in the external recognition sensor 25 can be any types and number.

For example, the external recognition sensor 25 includes the cameras 51, the radars 52, the LiDAR (Light Detection and Ranging, Laser Imaging Detection and Ranging) 53, and ultrasonic sensors 54. This is not the sole example, and the external recognition sensor 25 may include one or more types of sensor among the cameras 51, the radars 52, the LiDAR 53, and the ultrasonic sensors 54. The number of cameras 51, radars 52, LiDAR 53, and ultrasonic sensors 54 is not limited to particular values as long as they can practically be installed on the vehicle 1. In addition, the types of sensor included in the external recognition sensor 25 are not limited to those referred to in this example, and the external recognition sensor 25 may include other types of sensor. An example of a sensing area of each sensor included in the external recognition sensor 25 is mentioned later.

Note that image-capturing schemes adopted by the cameras 51 are not limited to particular ones. For example, cameras that adopt various types of image-capturing scheme such as a ToF (Time Of Flight) camera, a stereo camera, a monocular camera, or an infrared camera that adopt image-capturing schemes that enable distance measurement can be applied as the cameras 51 as necessary. This is not the sole example, and the cameras 51 may be ones that are not related to distance measurement but are for simply acquiring captured images.

In addition, for example, the external recognition sensor 25 can include an environment sensor for sensing an environment of the vehicle 1. The environment sensor is a sensor for sensing the environment related to weather, meteorological phenomena, brightness, or the like, and, for example, can include various types of sensor such as a raindrop sensor, a fog sensor, a sunlight sensor, a snow sensor, or an illuminance sensor.

Further, for example, the external recognition sensor 25 includes a microphone used for sensing sounds around the vehicle 1, positions of sound sources, or the like.

The vehicle interior sensor 26 includes various types of sensor for sensing information regarding the inside of the vehicle, and supplies sensor data from each sensor to the respective sections of the vehicle control system 11. The types and number of the various types of sensor included in the vehicle interior sensor 26 are not limited to particular ones as long as they can practically be installed on the vehicle 1.

For example, the vehicle interior sensor 26 can include one or more types of sensor among a camera, a radar, a seating sensor, a steering wheel sensor, a microphone, and a biosensor. As the camera included in the vehicle interior sensor 26, for example, cameras that adopt various types of image-capturing scheme that enable distance measurement such as a ToF camera, a stereo camera, a monocular camera, or an infrared camera can be used. This is not the sole example, and the camera included in the vehicle interior sensor 26 may be one that is not related to distance measurement but is for simply acquiring captured images. For example, the biosensor included in the vehicle interior sensor 26 is provided on a seat, a steering wheel, or the like and senses various types of bio-information regarding a user.

The vehicle sensor 27 includes various types of sensor for sensing the state of the vehicle 1 and supplies sensor data from each sensor to the respective sections of the vehicle control system 11. The types and number of the various types of sensor included in the vehicle sensor 27 are not limited to particular ones as long as they can practically be installed on the vehicle 1.

For example, the vehicle sensor 27 includes a speed sensor, an acceleration sensor, an angular velocity sensor (gyro sensor), and an IMU (Inertial Measurement Unit) formed by integrating them. For example, the vehicle sensor 27 includes a steering angle sensor that senses a steering angle of a steering wheel, a yaw rate sensor, an accelerator sensor that senses an operation amount of an accelerator pedal, and a brake sensor that senses an operation amount of a brake pedal. For example, the vehicle sensor 27 includes a rotation sensor that senses a rotation speed of an engine or a motor, an air pressure sensor that senses an air pressure of a tire, a skid rate sensor that senses a skid rate of a tire, and a wheel speed sensor that senses a rotation speed of a wheel. For example, the vehicle sensor 27 includes a battery sensor that senses a battery level and temperature, and a shock sensor that senses external shocks.

The storage section 28 includes at least a non-volatile storage medium and/or a volatile storage medium and stores data and programs. For example, the storage section 28 is used as an EEPROM (Electrically Erasable Programmable Read Only Memory) and a RAM (Random Access Memory), and a magnetic storage device such as an HDD (Hard Disc Drive), a semiconductor storage device, an optical storage device, and a magneto-optical storage device can be applied as the storage medium. The storage section 28 stores various types of program and data used by the respective sections of the vehicle control system 11. For example, the storage section 28 includes an EDR (Event Data Recorder) or a DSSAD (Data Storage System for Automated Driving), and stores information regarding the vehicle 1 before and after an event such as an accident and information acquired by the vehicle interior sensor 26.

The driving automation control section 29 controls driving automation functions of the vehicle 1. For example, the driving automation control section 29 includes an analyzing section 61, an action planning section 62, and an operation control section 63.

The analyzing section 61 performs a process of analyzing a condition of the vehicle 1 and a condition around the vehicle 1. The analyzing section 61 includes a current-position estimating section 71, a sensor fusion section 72, and the recognizing section 73.

The current-position estimating section 71 estimates a current position of the vehicle 1 on the basis of sensor data from the external recognition sensor 25 and high-precision maps accumulated in the map information accumulating section 23. For example, the current-position estimating section 71 generates a local map on the basis of sensor data from the external recognition sensor 25 and performs matching between the local map and high-precision maps to thereby estimate the current position of the vehicle 1. For example, the position of the vehicle 1 is represented using a center of an axle of a rear-wheel pair as a reference position.

For example, the local map is a three-dimensional high-precision map, an occupancy grid map (Occupancy Grid Map), or the like created using a technology such as SLAM (Simultaneous Localization and Mapping). For example, the three-dimensional high-precision map is a point cloud map mentioned above or the like. The occupancy grid map is a map that has grid squares with a predetermined size obtained by dividing a three-dimensional or two-dimensional space around the vehicle 1 and represents an object occupancy state of each grid square. For example, the object occupancy state is represented by presence/absence or a presence probability of an object. The local map is used also for, for example, processes of sensing and recognizing the condition outside the vehicle 1 performed by the recognizing section 73.

Note that the current-position estimating section 71 may estimate the current position of the vehicle 1 on the basis of positional information acquired by the positional information acquiring section 24 and sensor data from the vehicle sensor 27.

The sensor fusion section 72 performs a sensor fusion process of combining a plurality of different types of sensor data (e.g., image data supplied from the cameras 51 and sensor data supplied from the radars 52) and obtaining information. Examples of the method of combining the different types of sensor data include synthesis, integration, fusion, concatenation, and the like.

The recognizing section 73 executes a sensing process of sensing the condition outside the vehicle 1 and a recognition process of recognizing the condition outside the vehicle 1.

For example, the recognizing section 73 performs processes of sensing and recognizing the condition outside the vehicle 1 on the basis of information from the external recognition sensor 25, information from the current-position estimating section 71, information from the sensor fusion section 72, and the like.

Specifically, for example, the recognizing section 73 performs processes of sensing and recognizing objects around the vehicle 1, or the like. For example, the object sensing process is a process of sensing the presence/absence, sizes, forms, positions, motions, and the like of objects. For example, the object recognition process is a process of recognizing an attribute, such as type, of an object, identifying a particular object, and so on. It should be noted that the sensing process and the recognition process are not necessarily clearly separate processes, and are overlapping processes in some cases.

For example, the recognizing section 73 senses objects around the vehicle 1 by performing clustering to classify point clouds based on sensor data from the radars 52, the LiDAR 53, or the like into each cluster of point clouds. Thus, the presence/absence, sizes, shapes, and positions of objects around the vehicle 1 are sensed.

For example, the recognizing section 73 senses a motion of an object around the vehicle 1 by performing tracking to track motions of a cluster of point clouds classified by clustering. Thus, a speed and advancing direction (movement vector) of the object around the vehicle 1 are sensed.

For example, the recognizing section 73 senses or recognizes vehicles, humans, bicycles, obstacles, structures, roads, traffic lights, traffic signs, road markings, and the like on the basis of image data supplied from the cameras 51. In addition, the recognizing section 73 may recognize the types of objects around the vehicle 1 by performing a recognition process such as semantic segmentation.

For example, the recognizing section 73 can perform a process of recognizing traffic rules around the vehicle 1 on the basis of maps accumulated in the map information accumulating section 23, results of estimation of the current position by the current-position estimating section 71, and results of recognition of objects around the vehicle 1 by the recognizing section 73. By this process, the recognizing section 73 can recognize positions and states of traffic lights, contents of traffic signs and road markings, contents of traffic regulations, lanes where vehicles are allowed to travel, and the like.

For example, the recognizing section 73 can perform a process of recognizing the environment around the vehicle 1. The environment around the vehicle 1 to be recognized by the recognizing section 73 assumes weather, temperature, humidity, brightness, road surface states, and the like.

The action planning section 62 creates an action plan of the vehicle 1. For example, the action planning section 62 creates the action plan by performing path planning and path tracking processes.

Note that the path planning includes global path planning and local path planning. The global path planning includes a process of planning an approximate path from a start to a goal. The local path planning includes a process which is also called trajectory planning, in which generation of a trajectory, near the vehicle 1 and on the planned path, that allows the vehicle 1 to advance safely and smoothly is performed taking into consideration movement characteristics of the vehicle 1.

The path tracking is a process of planning an operation for allowing the vehicle 1 to travel the path planned by the path planning in a planned length of time safely and accurately. For example, the action planning section 62 can calculate a target speed and a target angular velocity of the vehicle 1 on the basis of results of the path tracking process.

The operation control section 63 controls the operation performed by the vehicle 1, in order to realize the action plan created by the action planning section 62.

For example, the operation control section 63 controls a steering control section 81, a brake control section 82, and a drive control section 83 that are included in the vehicle control section 32 mentioned later to perform lateral vehicle motion control and longitudinal vehicle motion control such that the vehicle 1 advances along the trajectory calculated by the trajectory planning. For example, the operation control section 63 performs control targeted at driver assistance functions such as collision avoidance or shock mitigation, follow-up traveling, cruise control traveling, collision warning regarding the vehicle 1, or lane deviation warning regarding the vehicle 1, and at driving automation such as traveling not dependent on the operation by a driver or a remote driver.

The DMS 30 performs a process of authenticating a driver, a process of recognizing a state of the driver, and the like on the basis of sensor data from the vehicle interior sensor 26, input data input to the HMI 31 mentioned later, and the like. For example, the state of the driver to be recognized assumes physical conditions, a degree of awakening, a degree of concentration, a degree of fatigue, a line-of-sight direction, a degree of drunkenness, driving operation, a posture, and the like.

Note that the DMS 30 may perform a process of authenticating users other than the driver and a process of recognizing the states of the users. In addition, for example, the DMS 30 may perform a process of recognizing the condition of the inside of the vehicle on the basis of sensor data from the vehicle interior sensor 26. For example, the condition of the inside of the vehicle to be recognized assumes temperature, humidity, brightness, smells, and the like.

The HMI 31 is used for inputting various types of data, instructions, and the like, and presents various types of data to a user.

Data input on the HMI 31 is explained briefly. The HMI 31 includes an input device used by a human to input data. The HMI 31 generates an input signal on the basis of data, instructions, or the like input by using the input device, and supplies the input signal to the respective sections of the vehicle control system 11. As the input device, for example, the HMI 31 includes controllers such as a touch panel, a button, a switch, and a lever. This is not the sole example, and the HMI 31 may further include an input device that enables information input by a method not involving manual operation but involving sounds, gestures, or the like. Further, for example, the HMI 31 may use, as an input device, a remote control device that uses infrared rays or radio waves or externally connected equipment such as mobile equipment or wearable equipment that supports operation of the vehicle control system 11.

Data presentation on the HMI 31 is explained briefly. The HMI 31 generates visual information, auditory information, and tactile information for users or the outside of the vehicle. In addition, the HMI 31 performs output control of controlling the output, output contents, output timing, output method, and the like of each piece of the generated information. For example, as visual information, the HMI 31 generates and outputs information represented by images or light such as monitor images representing operation screens, status display regarding the vehicle 1, warning display, or the condition around the vehicle 1. In addition, as auditory information, for example, the HMI 31 generates and outputs information represented by sounds such as audio guidance, warning sounds, or warning messages. Further, as tactile information, for example, the HMI 31 generates and outputs information to be given to tactile sensation of a user by force, vibration, motion, or the like.

For example, a display device that presents visual information by displaying images by itself and a projector device that presents visual information by projecting images can be applied as output devices to which the HMI 31 outputs visual information. Note that, other than a typical display device having a display, for example, the display device may also be a device that displays visual information in a visual field of a user, such as a head-up display, a transmission type display, or a wearable device having an AR (Augmented Reality) function. In addition, the HMI 31 can also use, as an output device that outputs visual information, a display device of a navigation device, an instrument panel, a CMS (Camera Monitoring System), an electronic mirror, a lamp, or the like provided to the vehicle 1.

For example, an audio speaker, headphones, or earphones can be applied as output devices to which the HMI 31 outputs auditory information.

For example, a haptic element using a haptic technology can be applied as an output device to which the HMI 31 outputs tactile information. For example, the haptic element is provided at a portion where a user of the vehicle 1 contacts such as a steering wheel or a seat.

The vehicle control section 32 controls the respective sections of the vehicle 1. The vehicle control section 32 includes the steering control section 81, the brake control section 82, the drive control section 83, a body-system control section 84, a light control section 85, and a horn control section 86.

The steering control section 81 performs sensing and control of a state of a steering system of the vehicle 1, and the like. For example, the steering system includes a steering mechanism including a steering wheel and the like, electric power steering, and the like. For example, the steering control section 81 includes a steering ECU that controls the steering system, an actuator that drives the steering system, and the like.

The brake control section 82 performs sensing and control of a state of a brake system of the vehicle 1, and the like. For example, the brake system includes a brake mechanism including a brake pedal or the like, an ABS (Antilock Brake System), a regenerative brake mechanism, and the like. For example, the brake control section 82 includes a brake ECU that controls the brake system, an actuator that drives the brake system, and the like.

The drive control section 83 performs sensing and control of a state of a drive system of the vehicle 1, and the like. For example, the drive system includes an accelerator pedal, a drive force generating device for generating drive force such as an internal combustion engine or a drive motor, a drive force transmission mechanism for transmitting the drive force to wheels, and the like. For example, the drive control section 83 includes a drive ECU that controls the drive system, an actuator that drives the drive system, and the like.

The body-system control section 84 performs sensing and control of a state of a body system of the vehicle 1, and the like. For example, the body system includes a keyless entry system, a smart key system, a power window device, power seats, an air-conditioning device, airbags, seat belts, a shift lever, and the like. For example, the body-system control section 84 includes a body system ECU that controls the body system, an actuator that drives the body system, and the like.

The light control section 85 performs sensing and control of states of various types of light of the vehicle 1, and the like. For example, lights to be controlled assume headlamps, backlights, fog lights, turn signals, brake lights, projection, bumper display, and the like. The light control section 85 includes a light ECU that controls lights, actuators that drive the lights, and the like.

The horn control section 86 performs sensing and control of a state of a car horn of the vehicle 1, and the like. For example, the horn control section 86 includes a horn ECU that controls the car horn, an actuator that drives the car horn, and the like.

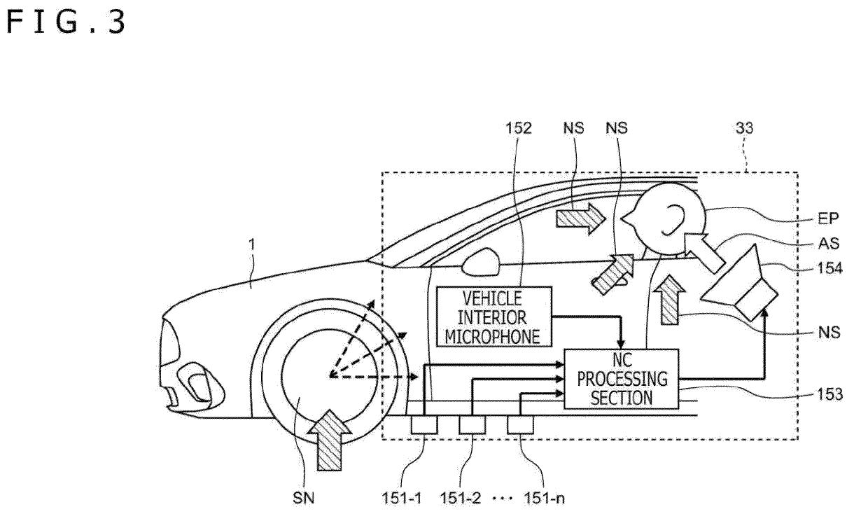

The NC (Noise Cancel or Noise Control) apparatus 33 suppresses noise that occurs during traveling such as road noise or wind noise. Note that a detailed configuration of the NC apparatus 33 is mentioned later with reference to FIG. 3 and the subsequent figures.

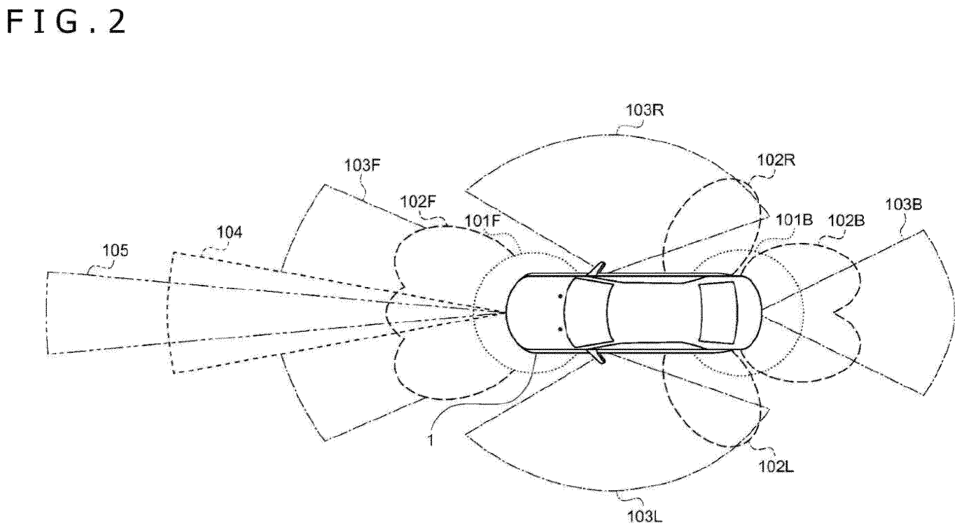

FIG. 2 is a figure depicting an example of sensing areas of the cameras 51, the radars 52, the LiDAR 53, the ultrasonic sensors 54, and the like of the external recognition sensor 25 in FIG. 1. Note that FIG. 2 schematically depicts a state of the vehicle 1 as seen from above. A left end side is a front end (front) side of the vehicle 1, and a right end side is a rear end (rear) side of the vehicle 1.

A sensing area 101F and a sensing area 101B represent an example of sensing areas of the ultrasonic sensors 54. The sensing area 101F covers a vicinity of the front end of the vehicle 1 with a plurality of the ultrasonic sensors 54. The sensing area 101B covers a vicinity of the rear end of the vehicle 1 with a plurality of the ultrasonic sensors 54.

For example, results of sensing in the sensing area 101F and the sensing area 101B are used for parking assistance of the vehicle 1, and the like.

A sensing area 102F to a sensing area 102B represent an example of sensing areas of short-range or middle-range radars 52. In front of the vehicle 1, the sensing area 102F covers positions farther than the sensing area 101F. Behind the vehicle 1, the sensing area 102B covers positions farther than the sensing area 101B. The sensing area 102L covers a vicinity of a rear position of a left side of the vehicle 1. The sensing area 102R covers a vicinity of a rear position of a right side of the vehicle 1.

For example, results of sensing in the sensing area 102F are used for sensing vehicles, pedestrians, and the like that are in front of the vehicle 1, and the like. For example, results of sensing in the sensing area 102B are used for a function to prevent collisions behind the vehicle 1, and the like. For example, results of sensing in the sensing area 102L and the sensing area 102R are used for sensing objects in blind spots on the sides of the vehicle 1, and the like.

A sensing area 103F to a sensing area 103B represent an example of sensing areas of the cameras 51. In front of the vehicle 1, the sensing area 103F covers positions farther than the sensing area 102F. Behind the vehicle 1, the sensing area 103B covers positions farther than the sensing area 102B. The sensing area 103L covers a vicinity of the left side of the vehicle 1. The sensing area 103R covers a vicinity of the right side of the vehicle 1.

For example, results of sensing in the sensing area 103F can be used for recognition of traffic lights and traffic signs, a lane deviation prevention assistance system, and an automatic headlamp control system. For example, results of sensing in the sensing area 103B can be used for parking assistance and a surround view system. For example, results of sensing in the sensing area 103L and the sensing area 103R can be used for the surround view system.

A sensing area 104 represents an example of a sensing area of the LiDAR 53. In front of the vehicle 1, the sensing area 104 covers positions farther than the sensing area 103F. Meanwhile, the sensing area 104 has a narrower range in a left-right direction than the sensing area 103F.

For example, results of sensing in the sensing area 104 are used for sensing objects such as nearby vehicles.

A sensing area 105 represents an example of a sensing area of a long-range radar 52. In front of the vehicle 1, the sensing area 105 covers positions farther than the sensing area 104. Meanwhile, the sensing area 105 has a narrower range in the left-right direction than the sensing area 104.

For example, results of sensing in the sensing area 105 are used for ACC (Adaptive Cruise Control), emergency braking, collision avoidance, and the like.

Note that the sensing area of each sensor of the cameras 51, the radars 52, the LiDAR 53, and the ultrasonic sensors 54 included in the external recognition sensor 25 may have various types of configuration other than that in FIG. 2. Specifically, the ultrasonic sensors 54 may perform sensing also of the sides of the vehicle 1, and the LiDAR 53 may perform sensing of the rear of the vehicle 1. In addition, an installation position of each sensor is not limited to each example mentioned above. In addition, the number of sensors of each type may be one or may be more than one.

### 2. First Embodiment

In recent years, a technology called spatial noise control (hereinbelow, spatial NC) has been attracting attention as a technology to produce silent spaces.

As means for creating silent spaces, active control used for conventional headphone NC (Noise Cancelling) and the like is cited as effective means for a low-frequency range where passive control is considered as less effective.

In recent years, the spatial NC has been anticipated to be applied particularly to applications aimed at mobility. One of the reasons for this is a demand to reduce vehicle body weight in order to achieve environmental compatibility in mobility. That is, while silence has conventionally been achieved by adding noise absorbing materials, weight reduction by omission of various configurations including noise absorbing materials has led to a tendency for body vibration-induced noise to become more noticeable; as a result, there is growing interest in achieving silence through active control.

There are broadly two types of schemes as techniques for achieving silence in a vehicle cabin through active control. In a first scheme, vibrations of noise sources are sensed, and, on the basis of sensing results, such inverse phase sounds that the noise is canceled at sound-receiving points (control points) which are the ears or the like of a listener/viewer are reproduced from speakers.

In addition, in a second scheme, vibrations of panels that are sources of noise sound emission (radiation) are sensed, and, on the basis of sensing results, the vibrations of the panels are directly damped by actuators (exciters).

In the first scheme, a series of signal processing from sensing of the vibrations at the noise sources until reproduction, on the basis of sensing results and by the speakers, of such inverse phase sounds that are to be perceived at the sound-receiving points (control points) and cancel the noise is necessary, but it is sufficient if the series of signal processing is completed until the noise from the noise sources is propagated to the sound-receiving points, it is easier to secure the required time, and accordingly, the series of signal processing is performed by a feedforward scheme.

On the other hand, in the second scheme, it is necessary to sense the vibrations of the panels that emit the noise, and directly damp the vibrations of the panels by using the actuators, it is difficult to secure the time required for the processes, and accordingly, the processes are performed by a feedback scheme.

Hereinbelow, the first scheme in which vibrations of noise sources are sensed and such inverse phase sounds that cancel the noise at sound-receiving points are reproduced from speakers is also called a feedforward scheme (FF-scheme) simply.

In addition, the second scheme in which vibrations of panels that are the sources of noise radiation are sensed and the vibrations of the panels are directly damped by actuators (exciters) is also called a feedback scheme (FB scheme) simply.

First, an FF-scheme NC apparatus 33 is explained as a configuration example of the first embodiment.

More specifically, as depicted in FIG. 3, the FF-scheme NC apparatus 33 includes sensors 151-1 to 151-n, a vehicle interior microphone 152, an NC processing section 153, and a speaker 154.

The sensors 151-1 to 151-n are acceleration sensors that sense vibrations of a noise source SN, and output, to the NC processing section 153, sensor signals as sensing results. The vehicle sensor 27 may be used instead as the sensors 151-1 to 151-n as long as the vehicle sensor 27 functions as acceleration sensors that sense vibrations of the noise source SN.

In a case where it is not necessary to make particular distinctions among the sensors 151-1 to 151-n hereinbelow, the sensors 151-1 to 151-n are also called sensors 151 simply, and this similarly applies also to other configurations. In addition, while it is assumed here that the sensors 151 are acceleration sensors, the sensors 151 may be not acceleration sensors as long as they can sense noise-related information, that is, a physical quantity that makes it possible to grasp a phenomenon such as vibrations that can be the sound source of noise. That is, for example, the sensors 151 may be sensors that are typically called vibration sensors and sense all of displacement, speed, and acceleration as physical quantities included in vibration. In addition, the sensors 151 may be any of acceleration sensors, displacement sensors, and speed sensors. Because of this, the sensor signals may include speed, displacement, and the like in addition to acceleration.

The vehicle interior microphone 152 is a microphone that is provided at a position away from a control point EP which is the position of an ear of a user such as, for example, the ceiling, the floor, or the like in the vehicle cabin and that collects sounds in the vehicle cabin, and outputs the collected sounds as a sound signal to the NC processing section 153.

On the basis of the sensor signals, which are the sensing results of the vibrations of the noise source SN from the sensors 151-1 to 151-n, and the sound signal of the vehicle cabin supplied from the vehicle interior microphone 152, the NC processing section 153 reads out a cancellation filter that has been pre-generated in association, generates an inverse phase sound AS that cancels (negates) noise at the control point EP by signal processing using the cancellation filter, and causes the speaker 154 to emit the inverse phase sound AS.

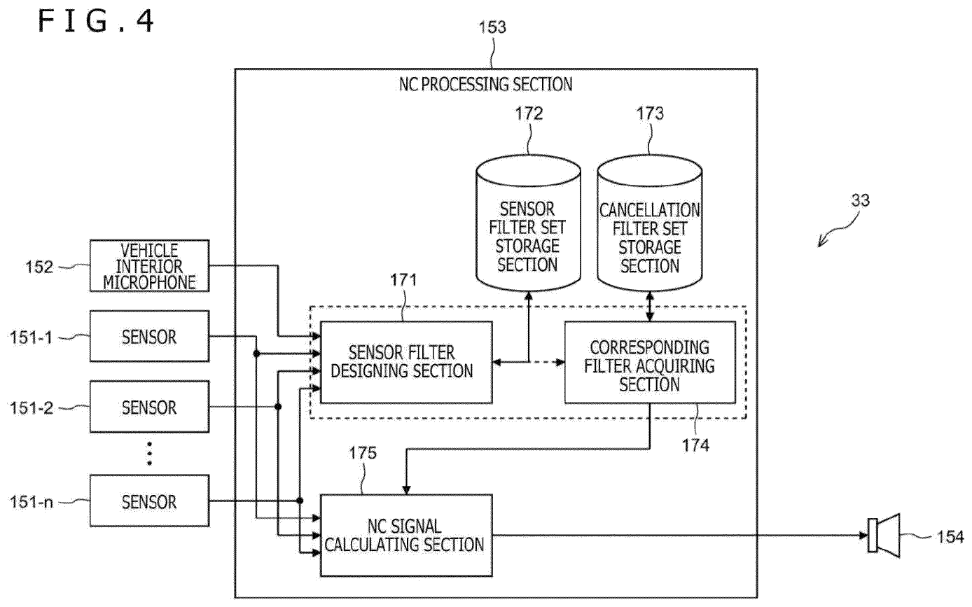

With such a configuration, noise NS generated by the noise source SN is canceled by the inverse phase sound AS emitted by the speaker 154 at the control point EP, and accordingly, noise perceived at the ear of the user is reduced. Note that a detailed configuration of the NC processing section 153 is mentioned later in detail with reference to FIG. 4.

### <Functions Realized by NC Apparatus>

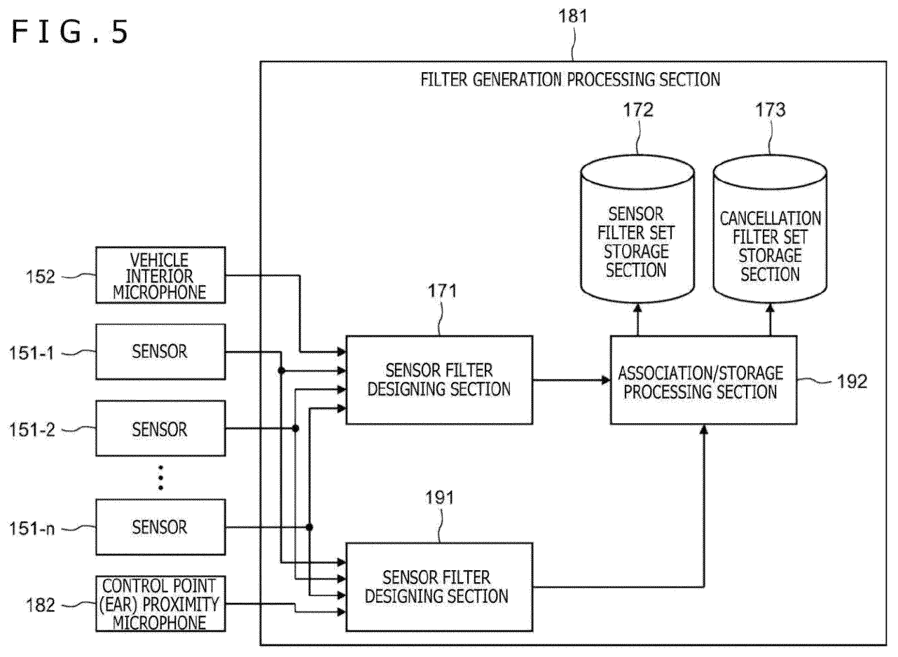

Next, functions realized by the NC apparatus 33 are explained with reference to FIG. 4. Note that, in explaining the functions realized by the NC apparatus 33, a configuration example of a filter generation processing section 181 for generating a cancellation filter used at the NC processing section 153 is explained together with reference to FIG. 5. In addition, components in the filter generation processing section 181 in FIG. 5 that have functions identical to the functions of components in the NC processing section 153 are given identical reference signs, and explanations thereof are omitted as appropriate.

The NC processing section 153 has stored thereon cancellation filters pre-generated by a filter generation process performed by the filter generation processing section 181 (FIG. 5). In a noise cancellation (NC) process, the NC processing section 153 reads out and uses a cancellation filter corresponding to sensing results of the sensors 151-1 to 151-n and sounds collected by the vehicle interior microphone 152, generates an inverse phase sound of the collected sounds, and causes the speaker 154 to emit the inverse phase sound.

More specifically, the NC processing section 153 includes a sensor filter designing section 171, a sensor filter set storage section 172, a cancellation filter set storage section 173, a corresponding filter acquiring section 174, and an NC signal calculating section 175.

In addition, the filter generation processing section 181 (FIG. 5) includes the sensor filter designing section 171, the sensor filter set storage section 172, the cancellation filter set storage section 173, an association/storage processing section 192, and a cancellation filter designing section 191. In addition, the filter generation processing section 181 is supplied with sounds collected at the control point by a control point proximity microphone 182 installed at the control point only at the time of the filter generation process.

Both at the time of the filter generation process and at the time of the noise cancellation process, on the basis of sensing results of the sensors 151-1 to 151-n and sounds collected by the vehicle interior microphone 152, the sensor filter designing section 171 designs, as a sensor filter, an NC filter to generate an inverse phase sound for canceling the sounds collected by the vehicle interior microphone 152.

At the time of the filter generation process, on the basis of sensing results of the sensors 151-1 to 151-n and sounds collected by the control point proximity microphone 182, the cancellation filter designing section 191 designs, as a cancellation filter, an NC filter to generate an inverse phase sound for canceling the sounds collected by the vehicle interior microphone 152.

The control point is the position of an ear where sounds are perceived by the user, and is a position where noise is desired to be canceled at the time of the noise cancellation process. However, since there is a user at the time of noise cancellation, the control point proximity microphone 182 often cannot be provided appropriately. Accordingly, by installing, at the control point, the control point proximity microphone 182 only at the time of the filter generation process, sounds at the position where noise is desired to be canceled are collected, and a cancellation filter is designed in advance on the basis of the sounds collected at the control point.

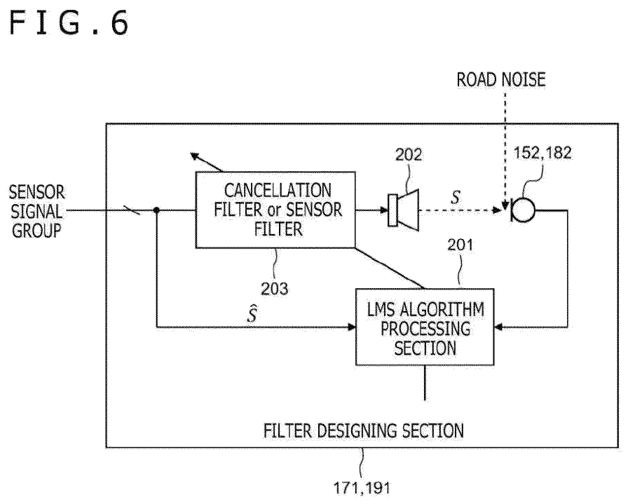

The sensor filter designing section 171 and the cancellation filter designing section 191 have similar basic configurations, and, for example, include an LMS (Least Mean Square) algorithm processing section 201 as depicted in FIG. 6.

The LMS algorithm processing section 201 designs (generates) a sensor filter 203 to generate inverse phase sounds that cancel sounds collected by the vehicle interior microphone 152, which is an error microphone, in real time while traveling under variously changed tire or road surface conditions.

At this time, the LMS algorithm processing section 201 designs the sensor filter 203 in accordance with an LMS algorithm on the basis of secondary path transmission characteristics S between a cancellation speaker 202, which is equivalent to the speaker 154, and the vehicle interior microphone 152 and an estimated value or measurement value S\hat{ } (S with a hat in the figure) of the secondary path transmission characteristics.

In addition, this similarly applies also to the cancellation filter designing section 191, and, on the basis of the secondary path transmission characteristics S between the cancellation speaker 202, which is equivalent to the speaker 154, and the control point proximity microphone 182 and the estimated value or measurement value

S\hat{ } of the secondary path transmission characteristics, the LMS algorithm processing section 201 designs a cancellation filter 203 to generate inverse phase sounds that cancel sounds collected by the control point proximity microphone 182, which is an error microphone, in real time when traveling under variously changed tire or road surface conditions.

Note that the algorithm to design a sensor filter and a cancellation filter may be an algorithm other than the LMS algorithm and, for example, may be an NLMS (Normalized LMS) algorithm, an RLS (Recursive Least Square) algorithm, and a conjugate gradient algorithm.

At the time of the filter generation process, the association/storage processing section 192 (FIG. 5) associates a sensor filter and a cancellation filter generated at the sensor filter designing section 171 and the cancellation filter designing section 191, respectively, with each other by giving the sensor filter and the cancellation filter a corresponding ID or in another manner, and stores the sensor filter and the cancellation filter on the sensor filter set storage section 172 and the cancellation filter set storage section 173, respectively.

A trigger for the association/storage processing section 192 to associate and store a set of a sensor filter and a cancellation filter at the time of real time operation is a timing when a rate of change of filter coefficients is low and the filter coefficients are stable. More specifically, the trigger for associating and storing a set of a sensor filter and a cancellation filter is a timing when it is sensed that the rate of change between steps of the filter coefficients remains lower than a certain value, a timing when it is sensed that a time change rate of an RMS value of an error microphone signal has fallen below a predetermined value, or the like.

In addition, a sensor filter and a cancellation filter do not necessarily have to be generated in real time. A log recording sensing results of all of the control point proximity microphone 182, the vehicle interior microphone 152, and the sensors 151-1 to 151-n may be collected every time the vehicle 1 travels under a different tire or road surface condition, and a sensor filter and a cancellation filter may be generated by an offline operation using the log. In this case, it is sufficient if an ID is allocated to each different tire or road surface condition and the generated filters are stored in association as a set of a sensor filter and a cancellation filter.

At the time of the noise cancellation process, after the acquisition of sensor filters designed on the basis of sensing results of the sensors 151-1 to 151-n and sounds collected by the vehicle interior microphone 152 by the sensor filter designing section 171, the corresponding filter acquiring section 174 of the NC processing section 153 searches a sensor filter set stored on the sensor filter set storage section 172 for a corresponding sensor filter. Then, the corresponding filter acquiring section 174 searches the cancellation filter set storage section 173 for a cancellation filter which is given an ID corresponding to the sensor filter found by the search, and outputs the cancellation filter to the NC signal calculating section 175.

As a method for the corresponding filter acquiring section 174 to select a cancellation filter which is given a corresponding ID on the basis of the generated sensor filter at the time of the noise cancellation process, the Euclidean distance between filter coefficients may be determined directly or the coefficients may be converted to frequency-base coefficients by using FFT or the like to determine the distance. In a case where the frequency that should be focused on is different between a cancellation filter and a sensor filter, it is desirable to use a distance scale, such as a distance scale to give frequency weights in distance calculations, to maximize noise canceling effects.

On the basis of a cancellation filter supplied from the corresponding filter acquiring section 174, the NC signal calculating section 175 executes an NC (noise cancellation) signal calculation process, generates an inverse phase sound for canceling sounds at the control point, and causes the speaker 154 to emit the inverse phase sound.

With such a configuration, at the time of noise cancellation, it becomes possible to indirectly determine a cancellation filter which is optimum at a control point proximity position adaptive to changes in road surface or tire, by use of the vehicle interior microphone 152, even in a state where the control point proximity microphone 182 is not provided.

Thus, it becomes possible to highly precisely realize the noise cancellation process at the control point simply by arranging the vehicle interior microphone 152 at any position away from the ear which is the control point. In addition, it becomes possible to achieve sufficient noise canceling effects for high frequency noise simply by arranging the vehicle interior microphone 152 without providing the control point proximity microphone 182.

### <Filter Generation Process Performed by Filter Generation Processing Section in FIG. 5>

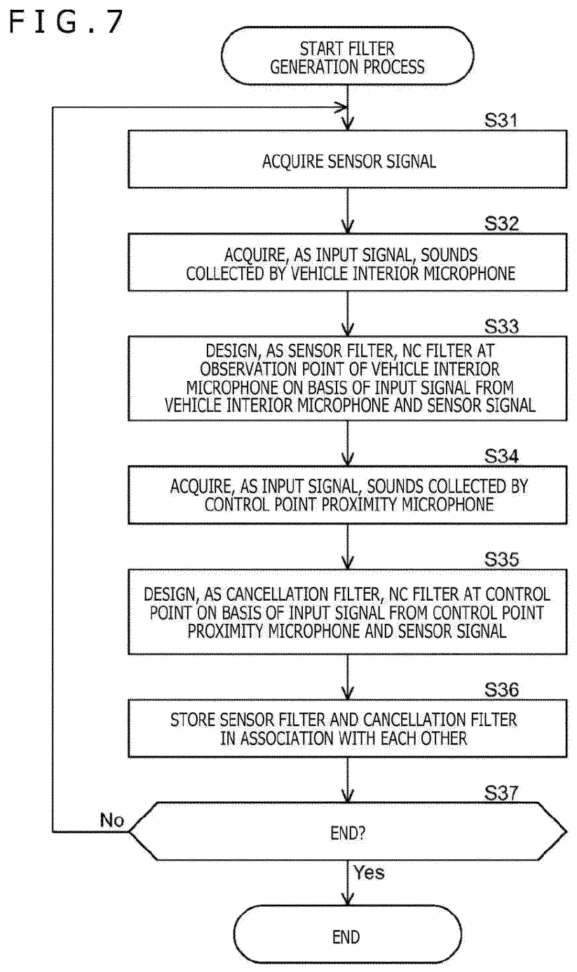

Next, the filter generation process performed by the filter generation processing section 181 in FIG. 5 is explained with reference to a flowchart in FIG. 7. Note that it is assumed that this process is a process performed during traveling under variously changed tire or road surface conditions in a state where, instead of the NC apparatus 33, the filter generation processing section 181 in FIG. 5 is mounted on the vehicle 1. It should be noted that, in a case where information sensed by each of the sensors 151-1 to 151-n, the vehicle interior microphone 152, and the control point proximity microphone 182 is logged during the traveling of the vehicle 1, it is also possible to execute the process offline using the log.

At Step S31, the sensor filter designing section 171 and the cancellation filter designing section 191 of the filter generation processing section 181 acquire sensor signals including sensing results supplied from the sensors 151-1 to 151-n.

At Step S32, the sensor filter designing section 171 acquires, as an input signal, sounds as noise collected by the vehicle interior microphone 152.

At Step S33, the sensor filter designing section 171 designs an NC filter for generating an inverse phase sound of sounds as noise, from the sensor signals including the sensing results supplied from the sensors 151-1 to 151-n and the input signal of the sounds as the noise collected by the vehicle interior microphone 152, and outputs the NC filter as a sensor filter.

At Step S34, the cancellation filter designing section 191 acquires, as an input signal, sounds including noise collected by the control point proximity microphone 182.

At Step S35, the cancellation filter designing section 191 designs an NC filter to generate an inverse phase sound of sounds as noise, from the sensor signals including the sensing results supplied from the sensors 151-1 to 151-n and the input signal of the sounds as the noise collected by the control point proximity microphone 182, and outputs the NC filter as a cancellation filter.

At Step S36, the association/storage processing section 192 associates the sensor filter designed by the sensor filter designing section 171 with the cancellation filter designed by the cancellation filter designing section 191 and stores the sensor filter and the cancellation filter on the sensor filter set storage section 172 and the cancellation filter set storage section 173, respectively.

For example, the association/storage processing section 192 associates the sensor filter designed by the sensor filter designing section 171 with the cancellation filter designed by the cancellation filter designing section 191 by giving the sensor filter and the cancellation filter a common ID, and stores the sensor filter and the cancellation filter on the sensor filter set storage section 172 and the cancellation filter set storage section 173, respectively.

At Step S37, the sensor filter designing section 171 and the cancellation filter designing section 191 determine whether or not the process has been instructed to end, and, in a case where the process has not been instructed to end, the process returns to Step S31, and the subsequent process is repeated.

Then, in a case where the process has been instructed to end at Step S37, the process ends.

By the process mentioned above, a cancellation filter set for canceling noise sensed at the control point in a state where the control point proximity microphone 182 is installed is generated and stored in association with a sensor filter set for canceling noise sensed at the vehicle interior microphone 152.

That is, in the filter generation process mentioned above, a sensor filter for generating an inverse phase sound of sounds collected at the vehicle interior microphone 152 is determined as a label of a cancellation filter for generating an inverse phase sound at the control point targeted by the NC process, the cancellation filter being based on the same sensor signals and sounds collected by the control point proximity microphone 182. Because of this, the sensor filter and the cancellation filter are stored in association with each other, so that the cancellation filter is stored with the label including the sensor filter given thereto.

### <NC Process Performed by NC Apparatus in FIG. 4>

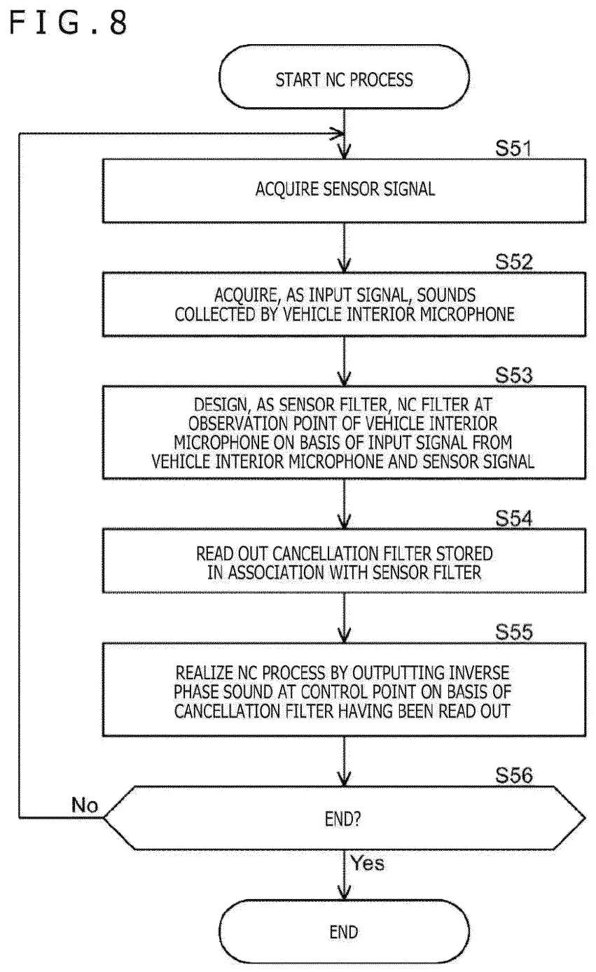

Next, the NC process performed by the NC apparatus 33 in FIG. 4 is explained with reference to a flowchart in FIG. 8. Note that this process presumes that sensor filters and cancellation filters have been stored on the sensor filter set storage section 172 and the cancellation filter set storage section 173 in association with each other by the process explained with reference to the flowchart in FIG. 7.

At Step S51, the sensor filter designing section 171 and the NC signal calculating section 175 of the NC processing section 153 acquire sensor signals including sensing results supplied from the sensors 151-1 to 151-n. At Step S52, the sensor filter designing section 171 acquires, as an input signal, sounds as noise collected by the vehicle interior microphone 152.

At Step S53, the sensor filter designing section 171 designs an NC filter for generating an inverse phase sound of sounds as noise, from the sensor signals including the sensing results supplied from the sensors 151-1 to 151-n and the input signal of the sounds as the noise collected by the vehicle interior microphone 152, and outputs the NC filter as a sensor filter.

At Step S54, the corresponding filter acquiring section 174 acquires the sensor filter designed by the sensor filter designing section 171, and acquires a cancellation filter stored in association with the sensor filter, by searching the cancellation filter set storage section 173.

More specifically, the corresponding filter acquiring section 174 searches the sensor filter set storage section 172 for a sensor filter corresponding to the sensor filter designed by the sensor filter designing section 171.

Then, the corresponding filter acquiring section 174 reads out a cancellation filter stored in association with the ID of the sensor filter found by the search, from the cancellation filter set storage section 173, and outputs the cancellation filter to the NC signal calculating section 175.

At Step S55, the NC signal calculating section 175 realizes the NC process by generating an inverse phase sound of noise estimated to be observed at the control point, by use of the cancellation filter supplied from the corresponding filter acquiring section 174 and by use of sensor signals including sensing results supplied from the sensors 151-1 to 151-n, and causing the speaker 154 to emit the inverse phase sound.

At Step S56, the sensor filter designing section 171 and the NC signal calculating section 175 determine whether or not the process has been instructed to end, and, in a case where the process has not been instructed to end, the process returns to Step S51, and the subsequent process is repeated.

Then, in a case where the process has been instructed to end at Step S56, the process ends.

As mentioned above, the cancellation filter for generating an inverse phase sound at the control point by the filter generation process has been stored in a state of being labeled with the sensor filter. Because of this, it becomes possible to realize the NC process appropriately by generating an inverse phase sound at the control point under the corresponding conditions and causing the inverse phase sound to be emitted, by reading out and using a cancellation filter labeled with a sensor filter determined from sounds collected by the vehicle interior microphone 152 and sensor signals in the NC process.

As a result, at the time of the NC process, it becomes possible to reduce noise at the control point by generating an inverse phase sound to cancel the noise at the control point and causing the speaker 154 to emit the inverse phase sound, by use of a cancellation filter set that has been pre-generated by the filter generation process and is used to cancel noise sensed at the control point, even in a state where the control point proximity microphone 182 is not installed.

Note that it can be said that, by the process mentioned above, the sensor filter designing section 171 and the corresponding filter acquiring section 174 surrounded by a dotted line in FIG. 4 realize a function to provide a cancellation filter at the control point to the NC signal calculating section 175 on the basis of sensor signals of the sensors 151-1 to 151-n and an input signal of sounds as noise collected by the vehicle interior microphone 152.

### 3. First Modification Example of First Embodiment

In the configuration example explained thus far, the NC apparatus 33 is configured to be able to appropriately cancel noise at the control point even in a state where there is not the control point proximity microphone 182 by generating a sensor filter for canceling noise collected by the vehicle interior microphone 152 and storing the sensor filter in association with a cancellation filter for canceling noise collected by the control point proximity microphone 182 at the time of the filter generation process, and reading out the cancellation filter stored in association with the sensor filter for canceling noise collected by the vehicle interior microphone 152, generating an inverse phase sound of noise at the control point, and causing the inverse phase sound to be emitted at the time of the NC process.

However, noise transmitted from the outside of the vehicle cabin to the inside of the vehicle cabin is greater than under normal conditions in some cases, for example, at the time of traveling in a tunnel, and so on. In this case, noise that is unrelated to changes in road surface or tire conditions and close to explosive sounds is input to the vehicle interior microphone 152, and accordingly, there is a possibility that the precision of filter designing at the sensor filter designing section 171 deteriorates undesirably.

In view of this, by providing a vehicle exterior microphone, collecting vehicle exterior noise, and removing vehicle exterior noise components collected at the vehicle exterior microphone from noise sensed at the vehicle interior microphone 152, possible adverse effects generated from noise such as explosive sounds that occur outside the vehicle may be reduced.

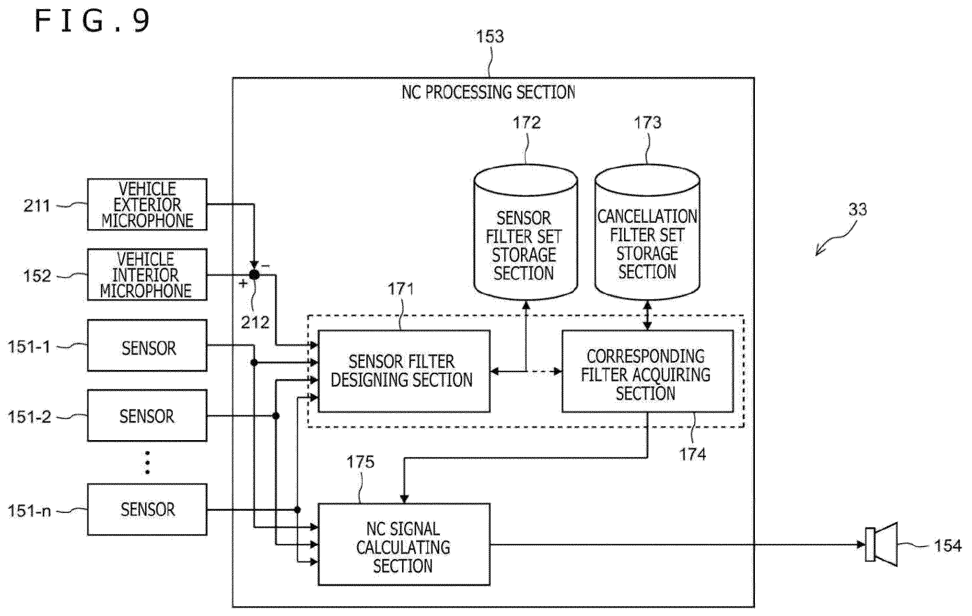

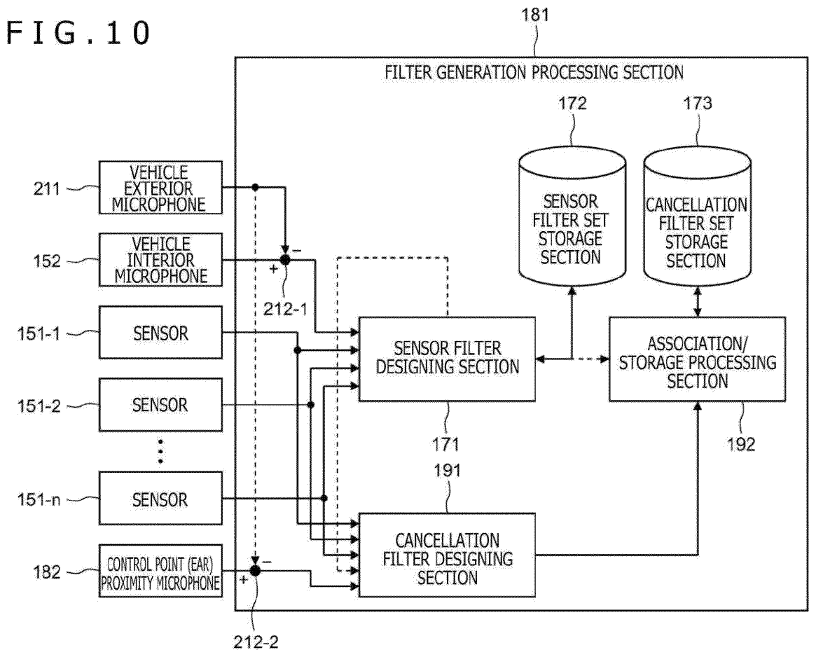

FIG. 9 and FIG. 10 depict configuration examples of the NC apparatus 33 and the filter generation processing section 181 in a case where a microphone is additionally provided outside the vehicle cabin.

Note that components of the NC apparatus 33 in FIG. 9 and the filter generation processing section 181 in FIG. 10 that have functions identical to the functions of components of the NC apparatus 33 in FIG. 4 and the filter generation processing section 181 in FIG. 5 are given identical reference signs, and explanations thereof are omitted.

The NC apparatus 33 in FIG. 9 and the filter generation processing section 181 in FIG. 10 are different from the NC apparatus 33 in FIG. 4 and the filter generation processing section 181 in FIG. 5 in that both the NC apparatus 33 in FIG. 9 and the filter generation processing section 181 in FIG. 10 are additionally provided with a vehicle exterior microphone 211 and computing units 212, 212-1, and 212-2.

The vehicle exterior microphone 211 is installed at a position such as the rear of the vehicle 1 that is less likely to be affected by wind and rain at the time of traveling, collects vehicle exterior noise, and supplies the vehicle exterior noise to the computing units 212, 212-1, and 212-2.

The computing units 212, 212-1, and 212-2 estimate components (pure vehicle exterior noise components) which are collected by the vehicle exterior microphone 211 and uncorrelated with sensor signals which are sensing results of the sensors 151-1 to 151-n.

Further, the computing units 212, 212-1, and 212-2 remove the vehicle exterior noise components corresponding to the vehicle exterior noise supplied from the vehicle exterior microphone 211 from vehicle interior noise supplied from the vehicle interior microphone 152 by subtracting the vehicle exterior noise components from the vehicle interior noise, extract vehicle interior noise components, and supply the vehicle interior noise components to the sensor filter designing section 171 and the cancellation filter designing section 191.

With such a configuration, it becomes possible to reduce adverse effects, on the sensor filter designing section 171 and the cancellation filter designing section 191, of the vehicle exterior noise components that are transmitted into the vehicle cabin and undesirably collected by the vehicle interior microphone 152.

Note that the NC process and the filter generation process performed by the NC apparatus 33 in FIG. 9 and the filter generation processing section 181 in FIG. 10 are similar to the NC process and the filter generation process explained with reference to the flowcharts in FIG. 7 and FIG. 8 except that vehicle exterior noise components are estimated from a signal of vehicle exterior noise collected by the vehicle exterior microphone 211 and are subtracted and removed from vehicle interior noise collected by the vehicle interior microphone 152, and explanations thereof are omitted.

### 4. Second Modification Example of First Embodiment

In the example explained thus far, adverse effects of vehicle exterior noise are reduced by providing the vehicle exterior microphone 211 and subtracting and removing vehicle exterior noise components from vehicle interior noise collected by the vehicle interior microphone 152.

However, sounds (noise) that occur outside the vehicle cabin include sounds that cannot avoid becoming suddenly loud, such as honking horns or passing sounds of nearby large trucks, in some cases. In such a case, effects of vehicle exterior noise on the input to the vehicle interior microphone 152 become dominant, and there is a possibility that simple estimation and subtraction, by the computing units 212, 212-1, and 212-2, of vehicle exterior noise components input by the vehicle interior microphone 152 cannot sufficiently reduce adverse effects of the vehicle exterior noise.

Since sensor filters and cancellation filters basically cancel noise that occurs in the vehicle cabin by causing an inverse phase sound of the noise to be emitted, if an inappropriate sound is generated and emitted as the inverse phase sound of the vehicle interior noise due to the effects of a sudden loud sound outside the vehicle cabin, there is a fear that a sound recognized as noise by a user is emitted undesirably.

In view of this, when vehicle exterior noise is at a predetermined sound pressure level or higher at the time of the filter generation process, the sensor filter designing section 171 and the cancellation filter designing section 191 may not design filters. In addition, accordingly, at the time of the NC process, the NC process may be stopped, or a cancellation filter having been used until then may be used as is.

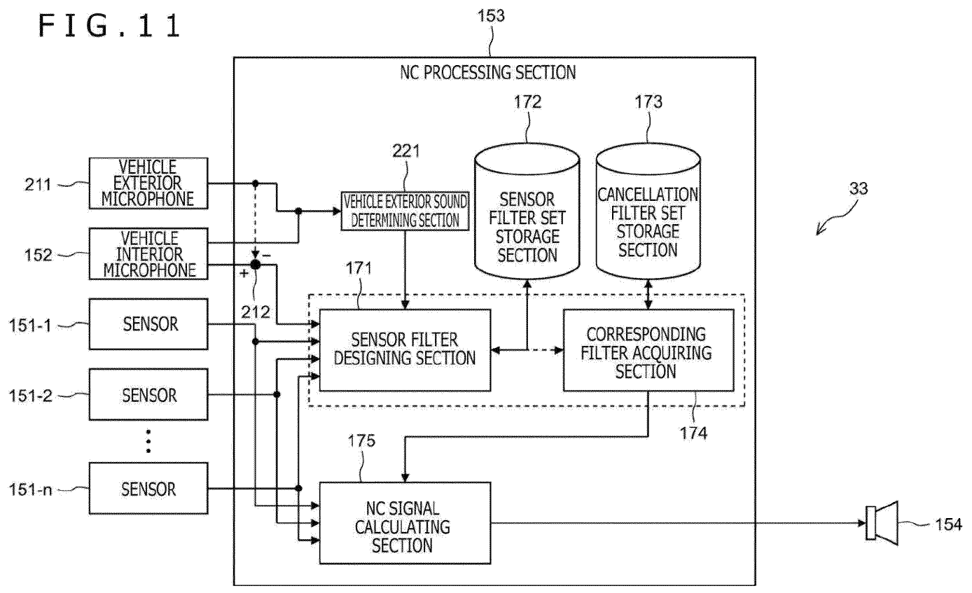

FIG. 11 depicts a configuration example of the NC apparatus 33 that stops the NC process or uses a cancellation filter having been used until then as is, when, at the time of the NC process, vehicle exterior noise is at a predetermined sound pressure level or higher.

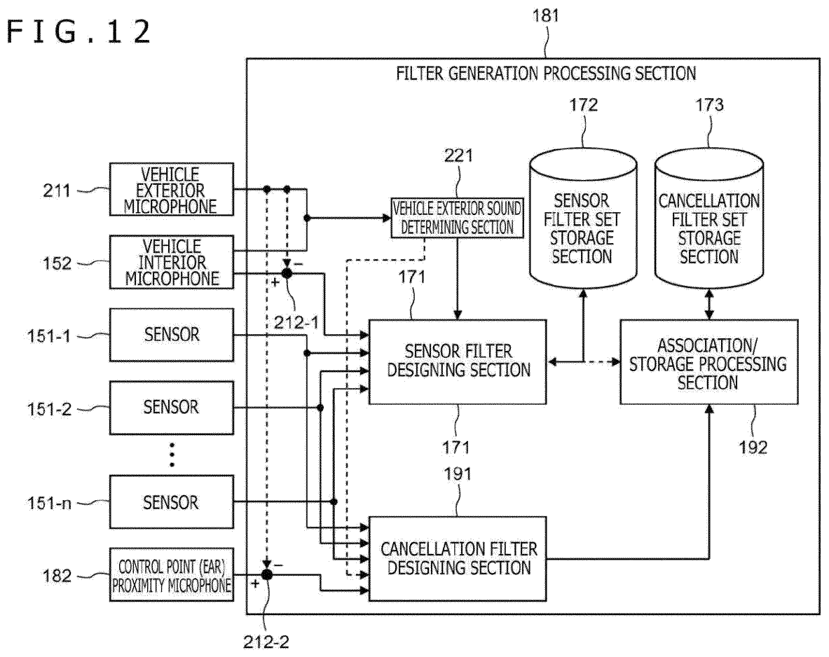

In addition, FIG. 12 depicts a configuration example of the filter generation processing section 181 that causes the sensor filter designing section 171 and the cancellation filter designing section 191 not to design filters and stores filters on the sensor filter set storage section 172 and the cancellation filter set storage section 173 of the NC apparatus 33 in FIG. 11, when, at the time of filter generation, vehicle exterior noise is at a predetermined sound pressure level or higher.

Note that components of the NC apparatus 33 in FIG. 11 and the filter generation processing section 181 in FIG. 12 that have functions identical to the functions of components of the NC apparatus 33 in FIG. 9 and the filter generation processing section 181 in FIG. 10 are given identical reference signs, and explanations thereof are omitted.

The NC apparatus 33 in FIG. 11 and the filter generation processing section 181 in FIG. 12 are different from the NC apparatus 33 in FIG. 9 and the filter generation processing section 181 in FIG. 10 in that both the NC apparatus 33 in FIG. 11 and the filter generation processing section 181 in FIG. 12 are additionally provided with a vehicle exterior sound determining section 221.

The vehicle exterior sound determining section 221 calculates a sound pressure level of the outside of the vehicle cabin by a process of calculating the sound pressure level of vehicle exterior noise and, when the comparison with a predetermined threshold reveals that the sound pressure level of the vehicle exterior noise is greater than the predetermined threshold, stops the operations performed by the sensor filter designing section 171 and the cancellation filter designing section 191.

More specifically, for example, the vehicle exterior sound determining section 221 calculates an average sound pressure level every second for a particular band or for all bands, determines, by threshold determination, whether or not the average sound pressure level is higher than the predetermined threshold, and, in a case where the average sound pressure level is higher than the predetermined threshold, stops the design of sensor filters and cancellation filters at the sensor filter designing section 171 and the cancellation filter designing section 191.

On the other hand, in a case where the average sound pressure level is lower than the predetermined threshold, the sensor filter designing section 171 and the cancellation filter designing section 191 are caused to design sensor filters and cancellation filters, and the sensor filters and the cancellation filters are caused to be stored in the sensor filter set storage section 172 and the cancellation filter set storage section 173, respectively, in association with each other.

For example, the predetermined threshold may be decided by measuring, in advance, the noise levels or the like of jet engine sounds, whistles, horns, or sirens or the noise levels or the like at the times of passage of large trucks, which are expected to cause adverse effects.

In addition, for the comparison with the predetermined threshold, instead of using the average sound pressure level, the determination may be made using a cross-correlation between signals input to the vehicle interior microphone 152 and the vehicle exterior microphone 211.

For example, since the effects of vehicle exterior noise on the vehicle interior microphone 152 become dominant in a case where vehicle exterior noise is large or a window of the vehicle is open, the correlation between signals input to the vehicle interior microphone 152 and the vehicle exterior microphone 211 increases.

In view of this, the vehicle exterior sound determining section 221 may determine the cross-correlation between signals input to the vehicle interior microphone 152 and the vehicle exterior microphone 211. When the cross-correlation is greater than a predetermined threshold (e.g., a correlation of equal to or greater than 0.7), the vehicle exterior sound determining section 221 may determine that vehicle exterior noise is large and there is a possibility that the vehicle exterior noise adversely affects the design of filters, and may cause the sensor filter designing section 171 and the cancellation filter designing section 191 to stop designing sensor filters and cancellation filters.

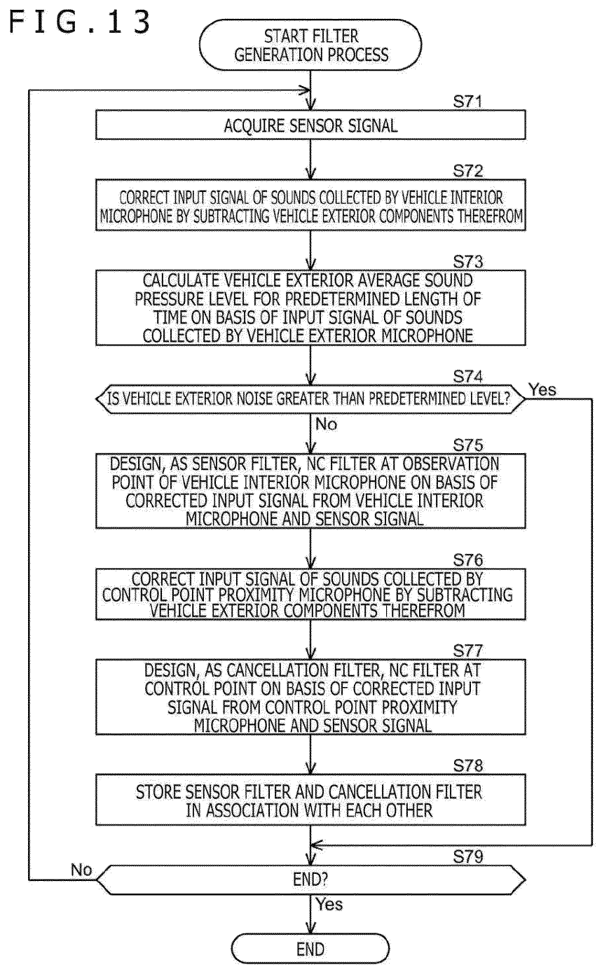

Note that the vehicle exterior sound determining section 221 in FIG. 11 and FIG. 12 is configured to be able to acquire input signals from each of the vehicle interior microphone 152 and the vehicle exterior microphone 211, and the comparison between the level of vehicle exterior noise and a predetermined threshold may be performed using either the average sound pressure level of vehicle exterior noise mentioned above or the cross-correlation between input signals of the vehicle interior microphone 152 and the vehicle exterior microphone 211, or the determination may be made using both of them.

<Filter Generation Process Performed by Filter Generation Processing Section in FIG. 12>Next, the filter generation process performed by the filter generation processing section 181 in FIG. 12 is explained with reference to a flowchart in FIG. 13.

At Step S71, the sensor filter designing section 171 and the cancellation filter designing section 191 of the filter generation processing section 181 acquire sensor signals including sensing results supplied from the sensors 151-1 to 151-n.

At Step S72, on the basis of an input signal of sounds as vehicle exterior noise collected by the vehicle exterior microphone 211, the computing unit 212-1 estimates and subtracts vehicle exterior noise components of an input signal of sounds as vehicle interior noise collected by the vehicle interior microphone 152 to correct the input signal, and supplies the corrected input signal to the sensor filter designing section 171.

At Step S73, on the basis of the input signal of the sound signal as the vehicle exterior noise collected by the vehicle exterior microphone 211, the vehicle exterior sound determining section 221 calculates the average sound pressure level. Alternatively, the vehicle exterior sound determining section 221 calculates the cross-correlation between the input signal of the sounds as the vehicle exterior noise collected by the vehicle exterior microphone 211 and the input signal of the sounds as the vehicle interior noise collected by the vehicle interior microphone 152.

At Step S74, the vehicle exterior sound determining section 221 determines whether or not the average sound pressure level or the cross-correlation is higher than or greater than the predetermined threshold and the vehicle exterior noise is higher than a predetermined level.

In a case where it is determined at Step S74 that the average sound pressure level or the cross-correlation is lower than or smaller than the predetermined threshold and the vehicle exterior noise is lower than the predetermined level, the process proceeds to Step S75.

At Step S75, the sensor filter designing section 171 designs an NC filter from the sensor signals including the sensing results supplied from the sensors 151-1 to 151-n and the corrected input signal of the sounds as the noise collected by the vehicle interior microphone 152, and outputs the NC filter as a sensor filter.

At Step S76, on the basis of the input signal of the sounds as the vehicle exterior noise collected by the vehicle exterior microphone 211, the computing unit 212-2 estimates and subtracts vehicle exterior noise components of an input signal of sounds as control point noise collected by the control point proximity microphone 182 to correct the input signal, and supplies the corrected input signal to the cancellation filter designing section 191.

At Step S77, the cancellation filter designing section 191 designs an NC filter from the sensor signals including the sensing results supplied from the sensors 151-1 to 151-n and the corrected input signal of the sounds as the noise collected by the control point proximity microphone 182, and outputs the NC filter as a cancellation filter.

At Step S78, the association/storage processing section 192 associates the sensor filter designed by the sensor filter designing section 171 with the cancellation filter designed by the cancellation filter designing section 191, and stores the sensor filter and the cancellation filter on the sensor filter set storage section 172 and the cancellation filter set storage section 173, respectively.

Meanwhile, in a case where it is determined at Step S74 that the average sound pressure level or the cross-correlation is higher than or greater than the predetermined threshold and the vehicle exterior noise is higher than the predetermined level, the processes at Steps S75 to S78 are skipped. That is, in a case where it is determined that the vehicle exterior noise is higher than the predetermined level, the design of sensor filters and cancellation filters is stopped since there is a possibility that sensor filters and cancellation filters to be designed are adversely affected by the vehicle exterior noise.

At Step S79, the sensor filter designing section 171 and the cancellation filter designing section 191 determine whether or not the process has been instructed to end, and, in a case where the process has not been instructed to end, the process returns to Step S71, and the subsequent process is repeated.

Then, in a case where the process has been instructed to end at Step S79, the process ends.

By the process mentioned above, a cancellation filter set for canceling noise sensed at the control point in a state where the control point proximity microphone 182 is installed is generated and stored in association with a sensor filter set for canceling noise sensed at the vehicle interior microphone 152. At this time, when it is determined that the level of vehicle exterior noise is higher than the predetermined level, the design of sensor filters and cancellation filters is stopped, and accordingly, adversely-affected inappropriate cancellation filters are not designed (generated).

### <NC Process Performed by NC Apparatus in FIG. 11>

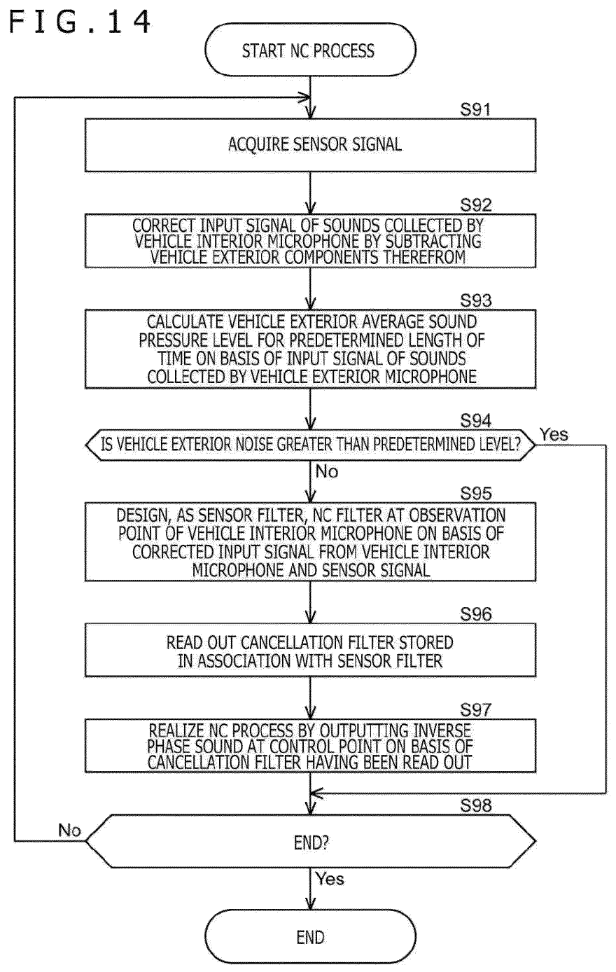

Next, the NC process performed by the NC apparatus 33 in FIG. 4 is explained with reference to a flowchart in FIG. 14. Note that this process presumes that sensor filters and cancellation filters have been stored on the sensor filter set storage section 172 and the cancellation filter set storage section 173 in association with each other by the process explained with reference to the flowchart in FIG. 7.

At Step S91, the sensor filter designing section 171 and the NC signal calculating section 175 of the NC processing section 153 acquire sensor signals including sensing results supplied from the sensors 151-1 to 151-n.

At Step S92, on the basis of an input signal of sounds as vehicle exterior noise collected by the vehicle exterior microphone 211, the computing unit 212 estimates and subtracts vehicle exterior noise components of an input signal of sounds as vehicle interior noise collected by the vehicle interior microphone 152 to correct the input signal, and supplies the corrected input signal to the sensor filter designing section 171.

At Step S93, on the basis of the input signal of the sound signal as the vehicle exterior noise collected by the vehicle exterior microphone 211, the vehicle exterior sound determining section 221 calculates the average sound pressure level. Alternatively, the vehicle exterior sound determining section 221 calculates the cross-correlation between the input signal of the sound signal as the vehicle exterior noise collected by the vehicle exterior microphone 211 and the input signal of the sound signal as the vehicle interior noise collected by the vehicle interior microphone 152.

At Step S94, the vehicle exterior sound determining section 221 determines whether or not the average sound pressure level or the cross-correlation is higher than or greater than the predetermined threshold and the vehicle exterior noise is higher than a predetermined level.

In a case where it is determined at Step S94 that the average sound pressure level or the cross-correlation is lower than or smaller than the predetermined threshold and the vehicle exterior noise is lower than the predetermined level, the process proceeds to Step S95.

At Step S95, the sensor filter designing section 171 designs an NC filter from the sensor signals including the sensing results supplied from the sensors 151-1 to 151-n and the corrected input signal of the sound signal as the noise collected by the vehicle interior microphone 152, and outputs the NC filter as a sensor filter.

At Step S96, the corresponding filter acquiring section 174 acquires the sensor filter designed by the sensor filter designing section 171, acquires a cancellation filter stored in association with the sensor filter by searching the cancellation filter set storage section 173, and outputs the cancellation filter to the NC signal calculating section 175.

At Step S97, the NC signal calculating section 175 generates an inverse phase sound of noise estimated to be observed at the control point, by use of the cancellation filter supplied from the corresponding filter acquiring section 174 and by use of sensor signals including sensing results supplied from the sensors 151-1 to 151-n, and causes the speaker 154 to emit the inverse phase sound.

Note that, in a case where the vehicle exterior sound determining section 221 determines at Step S94 that the average sound pressure level or the cross-correlation is higher than or greater than the predetermined threshold and the vehicle exterior noise is higher than the predetermined level, the processes at Steps S95 to S97 are skipped. That is, in a case where it is determined that the average sound pressure level or the cross-correlation is higher than or greater than the predetermined threshold and the vehicle exterior noise is higher than the predetermined level, a corresponding cancellation filter is not generated, and accordingly, the NC process has substantially been stopped. Note that, while the NC process is stopped in the example explained here, a cancellation filter having been used until then may be used as is.

At Step S98, the sensor filter designing section 171 and the NC signal calculating section 175 determine whether or not the process has been instructed to end, and, in a case where the process has not been instructed to end, the process returns to Step S91, and the subsequent process is repeated.

Then, in a case where the process has been instructed to end at Step S98, the process ends.

By the process mentioned above, it becomes possible to reduce noise at the control point by generating an inverse phase sound to cancel the noise at the control point and causing the speaker 154 to emit the inverse phase sound, by use of a cancellation filter set that has been pre-generated by the filter generation process and is used to cancel noise sensed at the control point, even in a state where the control point proximity microphone 182 is not installed. In addition, when it is determined that the level of vehicle exterior noise is higher than the predetermined level in the cases of sirens, whistles, horns, the traveling in tunnels, and the like, the NC process using cancellation filters is stopped, and accordingly, cancellation filters generated by adversely-affected inappropriate design are not used.

Note that, while the NC process is stopped in a case where it is determined that vehicle exterior noise is higher than the predetermined level in the example explained here, a cancellation filter having been used until then may be used as is.

### 5. Third Modification Example of First Embodiment

In the example explained thus far, NC is realized by designing a sensor filter and a cancellation filter in association with each other in advance at the time of the filter generation process, and reading out a cancellation filter corresponding to a designed sensor filter, using the cancellation filter thus read out to generate an inverse phase sound, and emitting the inverse phase sound at the time of the NC process.

However, a configuration like the one below may be adopted. That is, by training using, as student data, vehicle interior noise collected by the vehicle interior microphone 152 and sensor signals as sensing results of the sensors 151-1 to 151-n at the time of filter generation, and using, as teaching data, cancellation filters to generate inverse phase sounds at the control point and IDs of the cancellation filters, a trained model to infer an ID of a cancellation filter to generate an inverse phase sound at the control point is pre-generated.

Then, at the time of the NC process, the NC process at the control point may be realized by using the pre-generated trained model to infer an ID of a cancellation filter to generate an inverse phase sound at the control point from vehicle interior noise collected by the vehicle interior microphone 152 and sensor signals as sensing results of the sensors 151-1 to 151-n at the time of filter generation, searching for and reading out the cancellation filter corresponding to the ID as a result of the inference, and generating and emitting an inverse phase sound at the control point.

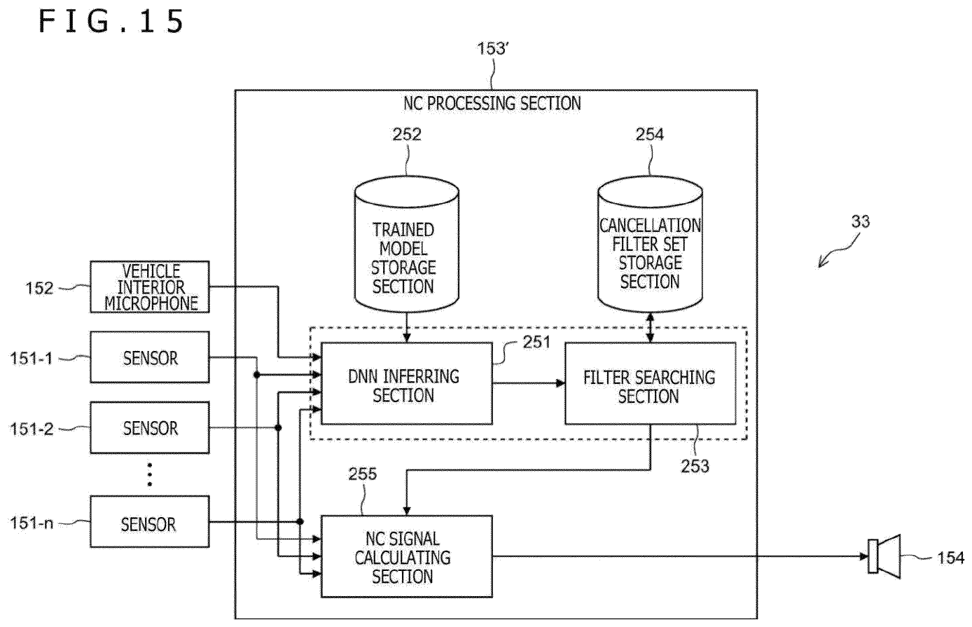

FIG. 15 depicts a configuration example 153′ of the NC processing section that, at the time of the NC process, infers an ID of a cancellation filter for generating an inverse phase sound at the control point by use of a trained model from vehicle interior noise and sensor signals, searches for and read out the cancellation filter corresponding to the ID which is a result of the inference, and realizes the NC process using the cancellation filter thus read out.

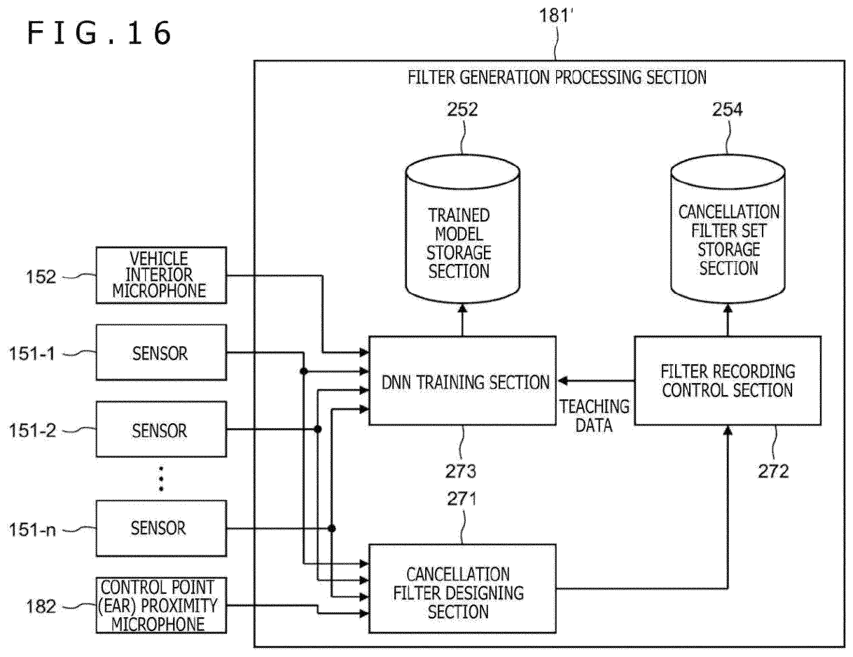

In addition, FIG. 16 depicts a configuration example of a filter generation processing section 181′ that, at the time of the filter generation process, designs a cancellation filter for generating an inverse phase sound at the control point from noise at the control point and sensor signals, stores the cancellation filter in association with an ID, and trains and stores a trained model to infer an ID of a cancellation filter from vehicle interior noise and sensor signals.

An NC processing section 153′ in FIG. 15 includes a DNN inferring section 251, a trained model storage section 252, a filter searching section 253, a cancellation filter set storage section 254, and an NC signal calculating section 255.

Note that the cancellation filter set storage section 254 and the NC signal calculating section 255 have configurations identical to the configurations of the cancellation filter set storage section 173 and the NC signal calculating section 175, and accordingly, explanations thereof are omitted.

At the time of filter generation by the filter generation processing section 181′ in FIG. 16, the DNN inferring section 251 reads out a trained model that is stored on the trained model storage section 252 and includes a DNN (Deep Neural Network) generated by machine learning performed at a DNN training section 273.

Then, the DNN inferring section 251 functions on the basis of the trained model, infers an ID of a cancellation filter for generating an inverse phase sound at the control point on the basis of vehicle interior noise collected by the vehicle interior microphone 152 and sensor signals of the sensors 151-1 to 151-n, and outputs the ID as a result of the inference to the filter searching section 253.

Because of this, the DNN inferring section 251 outputs, to the filter searching section 253 and as an inference result, an ID of a cancellation filter for generating an inverse phase sound at the control point from vehicle interior noise and sensor signals.

The filter searching section 253 accesses the cancellation filter set storage section 254, searches for a cancellation filter stored in association with the ID supplied from the DNN inferring section 251, and supplies the cancellation filter found by the search to the NC signal calculating section 255.

The filter generation processing section 181′ in FIG. 16 includes the trained model storage section 252, the cancellation filter set storage section 254, a cancellation filter designing section 271, a filter recording control section 272, and the DNN training section 273.

Note that the cancellation filter designing section 271 is similar to the cancellation filter designing section 191 in FIG. 12, and accordingly, an explanation thereof is omitted.

The filter recording control section 272 stores a cancellation filter supplied from the cancellation filter designing section 271 on the cancellation filter set storage section 254. More specifically, at the timing when it is sensed that the rate of change between steps of filter coefficients of a generated cancellation filter remains lower than a certain value, at the timing when it is sensed that the time change rate of the RMS value of sound signals of noise collected by the control point proximity microphone 182 has fallen below a predetermined value, or at another timing, the filter recording control section 272 records the cancellation filter in association with an ID on the cancellation filter set storage section 254, and further outputs the cancellation filter as teaching data of the DNN training section 273.

It is desirable that IDs that are set in association with cancellation filters be sequential according to degrees of similarity between the cancellation filters such that similar cancellation filters have similar IDs, amounts correlated with the distance scales between cancellation filters be used as IDs, and so on, to reduce performance degradation of the NC process caused by errors in results of the inference by the DNN inferring section 251.

By training using, as student data, vehicle interior noise collected by the vehicle interior microphone 152 and sensor signals, and using, as teaching data, cancellation filters to generate inverse phase sounds at the control point and IDs of the cancellation filters, the DNN training section 273 pre-generates a trained model to infer an ID of a cancellation filter to generate an inverse phase sound at the control point and stores the trained model on the trained model storage section 252.

### <Filter Generation Process Performed by Filter Generation Processing Section in FIG. 16>

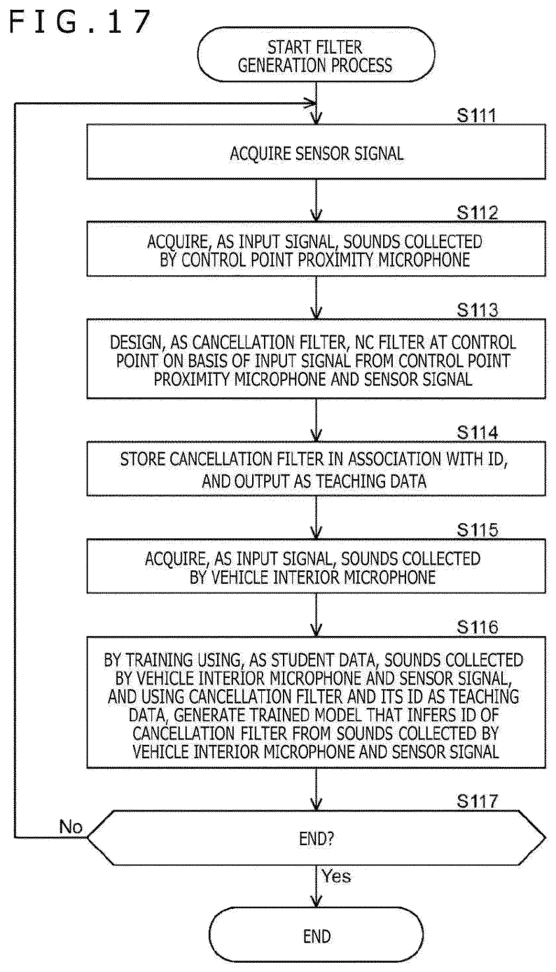

Next, the filter generation process performed by the filter generation processing section 181′ in FIG. 16 is explained with reference to a flowchart in FIG. 17.

At Step S111, the DNN training section 273 and the cancellation filter designing section 271 of the filter generation processing section 181′ acquire sensor signals including sensing results supplied from the sensors 151-1 to 151-n.

At Step S112, the cancellation filter designing section 271 acquires, as an input signal, sounds including noise collected by the control point proximity microphone 182.

At Step S113, the cancellation filter designing section 271 designs an NC filter from the sensor signals including the sensing results supplied from the sensors 151-1 to 151-n and the input signal of the sound signal as the noise collected by the control point proximity microphone 182, and outputs the NC filter as a cancellation filter.

At Step S114, the filter recording control section 272 stores, on the cancellation filter set storage section 254, the cancellation filter designed by the cancellation filter designing section 271 in association with an ID, and outputs, to the DNN training section 273, the ID of the cancellation filter as teaching data.

At Step S115, the DNN training section 273 acquires, as an input signal, sounds as noise collected by the vehicle interior microphone 152.

At Step S116, using, as student data, the sensor signals including the sensing results supplied from the sensors 151-1 to 151-n and the input signal of the sounds as the noise collected by the vehicle interior microphone 152, and using, as teaching data, cancellation filters supplied from the filter recording control section 272 and

IDs of the cancellation filters, the DNN training section 273 performs machine learning of a trained model to infer an ID of a cancellation filter for generating an inverse phase sound at the control point from sensor signals and an input signal of sounds as noise collected by the vehicle interior microphone 152, and causes the trained model to be stored on the trained model storage section 252.

At Step S117, the DNN training section 273 and the cancellation filter designing section 271 determine whether or not the process has been instructed to end, and, in a case where the process has not been instructed to end, the process returns to Step S111, and the subsequent process is repeated.

Then, in a case where the process has been instructed to end at Step S117, the process ends.

By the process mentioned above, cancellation filters for canceling noise sensed at the control point are designed in association with IDs in a state where the control point proximity microphone 182 is installed. In addition, machine learning is performed using the designed cancellation filters and their IDs as teaching data and using noise sensed at the vehicle interior microphone 152 and sensor signals of the sensors 151-1 to 151-n as student data. By this machine learning, a trained model to infer an ID of a cancellation filter for generating an inverse phase sound of noise at the control point from noise sensed at the vehicle interior microphone 152 and sensor signals of the sensors 151-1 to 151-n is generated.

### <NC Process Performed by NC Apparatus in FIG. 15>

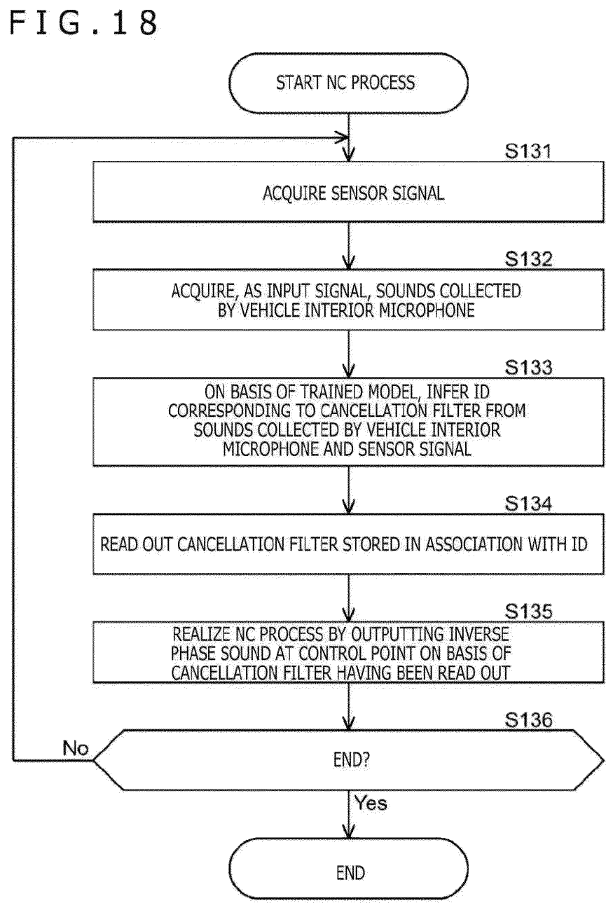

Next, the NC process performed by the NC apparatus 33 in FIG. 15 is explained with reference to a flowchart in FIG. 18. Note that this process presumes that cancellation filters have been designed by the process explained with reference to the flowchart in FIG. 17 and have been stored on the cancellation filter set storage section 254.

At Step S131, the DNN inferring section 251 and the NC signal calculating section 255 of the NC processing section 153′ acquire sensor signals including sensing results supplied from the sensors 151-1 to 151-n. At Step S132, the DNN inferring section 251 acquires, as an input signal, sounds as noise collected by the vehicle interior microphone 152.

At Step S133, the DNN inferring section 251 reads out the trained model stored on the trained model storage section 252, infers a cancellation filter for generating an inverse phase sound at the control point from sensor signals including sensing results supplied from the sensors 151-1 to 151-n and an input signal of noise collected by the vehicle interior microphone 152, and an ID of the cancellation filter, and outputs, to the filter searching section 253, the ID of the cancellation filter as a result of the inference.

At Step S134, the filter searching section 253 acquires the ID supplied from the DNN inferring section 251, searches the cancellation filter set storage section 254 for the cancellation filter stored in association with the acquired ID, and outputs the cancellation filter found by the search to the NC signal calculating section 255.

At Step S135, the NC signal calculating section 255 generates an inverse phase sound of noise estimated to be observed at the control point, by use of the cancellation filter supplied from the filter searching section 253 and by use of sensor signals including sensing results supplied from the sensors 151-1 to 151-n, and causes the speaker 154 to emit the inverse phase sound.

At Step S136, the DNN inferring section 251 and the NC signal calculating section 255 determine whether or not the process has been instructed to end, and, in a case where the process has not been instructed to end, the process returns to Step S111, and the subsequent process is repeated.

Then, in a case where the process has been instructed to end at Step S136, the process ends.

By the process mentioned above, it becomes possible to reduce noise at the control point by inferring an ID of a cancellation filter from vehicle interior noise and sensor signals, using a cancellation filter registered in association with the inferred ID of a cancellation filter, generating an inverse phase sound to cancel noise at the control point, and causing the inverse phase sound to be emitted by the speaker 154.

Note that it can be said that, by the process mentioned above, the DNN inferring section 251 and the filter searching section 253 surrounded by a dotted line in FIG. 15 realize a function to provide a cancellation filter at the control point to the NC signal calculating section 175 on the basis of sensor signals of the sensors 151-1 to 151-n and an input signal of sounds as noise collected by the vehicle interior microphone 152.

### 6. Fourth Modification Example of First Embodiment

In the example explained thus far, cancellation filters are generated, and a trained model to infer an ID of a cancellation filter is generated on the basis of vehicle interior noise and sensor signals by machine learning at the time of the filter generation process, and NC is realized by inferring an ID of a cancellation filter on the basis of vehicle interior noise and sensor signals, reading out a cancellation filter registered in association with the ID, and generating and emitting an inverse phase sound at the time of the NC process.

However, the NC process may be realized by inferring a cancellation filter itself on the basis of vehicle interior noise and sensor signals and generating and emitting an inverse phase sound using the inferred cancellation filter at the time of the NC process. In this case, in machine learning at the time of the filter generation process, cancellation filters themselves are used as teaching data, and a trained model to infer a cancellation filter itself on the basis of vehicle interior noise and sensor signals is generated.

In addition, at the time of the NC process and at the time of the filter generation process, as necessary, as explained with reference to FIG. 9 to FIG. 12, the vehicle exterior microphone 211 may be provided, vehicle exterior noise may be collected, and vehicle exterior noise components in vehicle interior noise may be removed.

Further, in addition to the sensors 151-1 to 151-n, sensor signals including sensing results of vehicle-mounted sensors including the external recognition sensor 25, the vehicle interior sensor 26, the vehicle sensor 27, and the like in the vehicle control system 11 may be used.

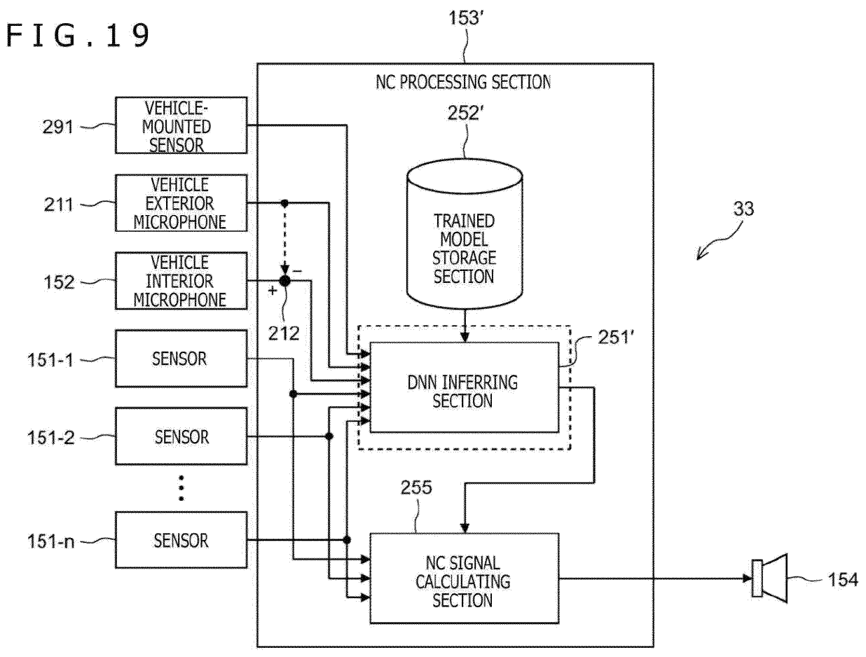

FIG. 19 depicts a configuration example of the NC apparatus 33 that realizes the NC process by inferring a cancellation filter itself on the basis of noise collected by the vehicle interior microphone 152 and sensor signals which are sensing results of the sensors 151-1 to 151-n at the time of the NC process, and generating and emitting an inverse phase sound using the inferred cancellation filter.

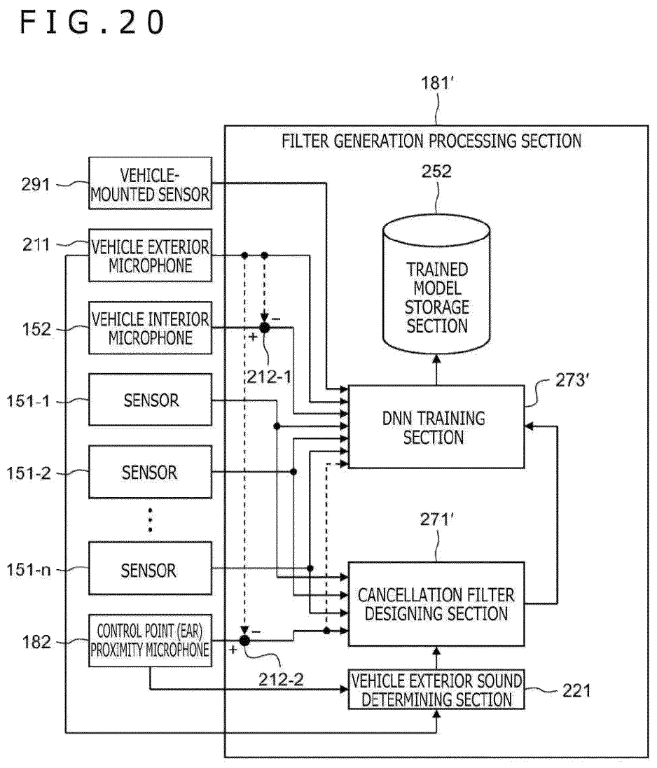

In addition, FIG. 20 depicts a configuration example of the filter generation processing section 181′ that uses cancellation filters themselves as teaching data and generates a trained model to infer a cancellation filter itself on the basis of vehicle interior noise and sensor signals in machine learning at the time of the filter generation process.

Note that components of the NC apparatus 33 in FIG. 19 and the filter generation processing section 181′ in FIG. 20 that have functions identical to the functions of components of the NC apparatus 33 in FIG. 15 and the filter generation processing section 181′ in FIG. 16 are given identical reference signs, and explanations thereof are omitted as appropriate.

That is, the NC apparatus 33 in FIG. 19 is different from the NC apparatus 33 in FIG. 15 in that the filter searching section 253 and the cancellation filter set storage section 254 are deleted, and the NC apparatus 33 in FIG. 19 includes a DNN inferring section 251′ instead of the DNN inferring section 251.

That is, since the DNN inferring section 251′ infers a cancellation filter itself in the NC process, it is sufficient if the DNN inferring section 251′ simply outputs a cancellation filter as a result of the inference to the NC signal calculating section 255. Accordingly, the filter searching section 253 and the cancellation filter set storage section 254 become unnecessary and are deleted.

In addition, the DNN inferring section 251′ in FIG. 19 uses also vehicle exterior noise from the vehicle exterior microphone 211 and a sensor signal including a sensing result of a vehicle-mounted sensor 291 together in addition to a signal of vehicle interior noise from the vehicle interior microphone 152 and sensor signals of the sensors 151-1 to 151-n, and infers a cancellation filter. Thus, it becomes possible to enhance the precision of the cancellation filter inference.

Further, the filter generation processing section 181′ in FIG. 20 is different from the filter generation processing section 181′ in FIG. 16 in that the filter recording control section 272 and the cancellation filter set storage section 254 are deleted, a cancellation filter designing section 271′ and a DNN training section 273′ are provided instead of the cancellation filter designing section 271 and the DNN training section 273, and further the vehicle exterior sound determining section 221 explained with reference to FIG. 12 is provided.

That is, since the DNN training section 273′ trains a trained model to infer cancellation filters themselves in the filter generation process, the DNN training section 273′ uses, as teaching data, cancellation filters supplied from the cancellation filter designing section 271′ as is. Accordingly, the filter searching section 253 and the cancellation filter set storage section 254 become unnecessary and are deleted.

In addition, the DNN training section 273′ in FIG. 20 uses also vehicle exterior noise from the vehicle exterior microphone 211, noise at the control point from the control point proximity microphone 182, and a sensor signal including a sensing result of the vehicle-mounted sensor 291 together in addition to a signal of vehicle interior noise from the vehicle interior microphone 152 and sensor signals of sensors 151-1 to 151-n, and trains a learning model to infer a cancellation filter. Thus, it becomes possible to enhance the precision of the cancellation filter inference using the trained model. Further, by training using also information such as road surface conditions and tire air pressures together in addition to sensor signals and noise-related sounds mentioned above, it becomes possible to infer a cancellation filter that can achieve higher noise-reducing effects. Accordingly, for example, the vehicle-mounted sensor 291 may also handle, as noise-related information, a series of traveling environment-related information such as road surface images (road surface conditions) captured with the cameras 51 of the external recognition sensor 25 mentioned above, weather conditions, date/time information such as day or night, and tire air pressures sensed by the vehicle sensor 27, and the series of traveling environment-related information may be used for the training of a learning model to infer a cancellation filter.

Further, the cancellation filter designing section 271′ in FIG. 20 stops the design when the vehicle exterior sound determining section 221 determines that vehicle exterior noise is higher than a predetermined level, since, in such a condition, it is difficult for the cancellation filter designing section 191 to design an appropriate cancellation filter. At this time, the DNN training section 273 stops training since cancellation filters as teaching data are not supplied. By doing so, in generating a learning model to infer a cancellation filter itself, inappropriate teaching data can be excluded from the training, and accordingly, it becomes possible to enhance the precision of the cancellation filter inference.

Note that the filter generation process performed by the filter generation processing section 181′ in FIG. 20 is basically similar to the filter generation process explained with reference to the flowchart in FIG. 17 except that a signal from the vehicle exterior microphone 211 and a sensor signal from the vehicle-mounted sensor 291 are additionally used as student data in addition to a signal of noise from the vehicle interior microphone 152 and sensor signals of the sensors 151-1 to 151-n, and that cancellation filters themselves are used as teaching data, and accordingly, an explanation thereof is omitted.

In addition, it can be said that, in the NC processing section 153′ in FIG. 19, the DNN inferring section 251′ surrounded by a dotted line singly realizes a function to provide a cancellation filter at the control point to the NC signal calculating section 175 on the basis of sensor signals of the sensors 151-1 to 151-n and an input signal of sounds as noise collected by the vehicle interior microphone 152.

In addition, the NC process performed by the NC apparatus 33 in FIG. 19 is basically similar to the NC process explained with reference to the flowchart in FIG. 18 except that a signal from the vehicle exterior microphone 211 and a sensor signal from the vehicle-mounted sensor 291 are additionally used in addition to a signal of noise from the vehicle interior microphone 152 and sensor signals of the sensors 151-1 to 151-n, that a determination result from the vehicle exterior sound determining section 221 is supplied to the cancellation filter designing section 271′, and that a cancellation filter itself is inferred, and accordingly, an explanation thereof is omitted.

Further, regarding the trained model stored on the trained model storage section 252 in FIG. 15 and a trained model storage section 252′, and a cancellation filter set stored on the cancellation filter set storage section 254 in FIG. 15, the NC apparatus 33 in FIG. 15 and FIG. 19 is primarily supposed to be mounted as the NC apparatus 33 of the vehicle control system 11 in the vehicle 1 such as a commercial passenger car.

Because of this, once the NC apparatus 33 becomes available on the market in a state where the trained model and the cancellation filter set are installed thereon, the conditions at the time of learning change over time undesirably due to the aging of tires and road surface changes, and there is a possibility that the initially-installed trained model and cancellation filter set gradually become unable to achieve sufficient noise reduction effects undesirably.

In such a case, by causing another filter generation processing section 181′ to additionally perform the filter generation process under new conditions of tires and road surfaces which have not been included during the training, a trained model and a cancellation filter set adapted to the new conditions (based on sounds collected by the vehicle interior microphone 152, sounds collected by the control point microphone 182, and a sensor signal of the sensors 151 under the new conditions, or based on relations with them) may be generated.

That is, by causing a trained model and a cancellation filter set generated under new conditions in this manner to be distributed to the NC apparatus 33 via a cloud server or the like, it becomes possible to update the trained model and the cancellation filter set. Accordingly, it becomes possible to sufficiently achieve noise reduction effects even if conditions change due to aging.

### 7. Second Embodiment

### <Feedback-Scheme NC Apparatus>

While the FF-scheme NC apparatus has been explained thus far, next, a feedback-scheme NC apparatus is explained as a configuration example of a second embodiment of the NC apparatus 33 of the present disclosure.

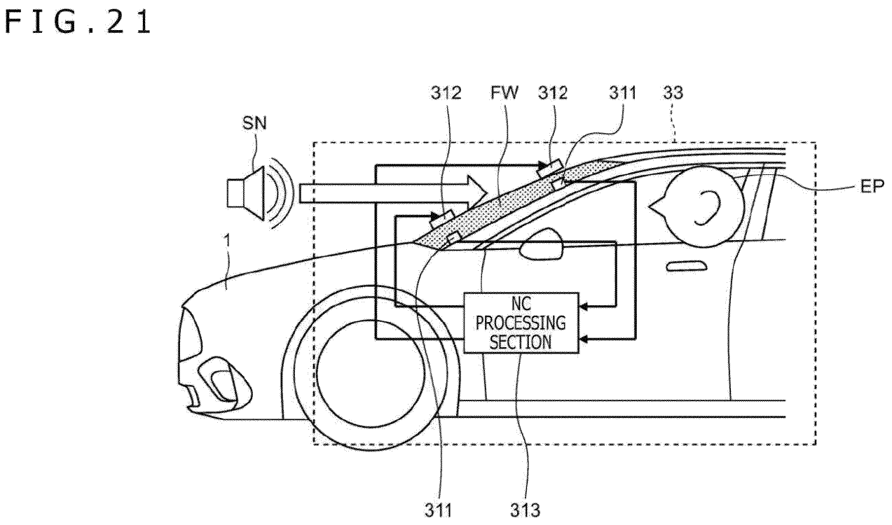

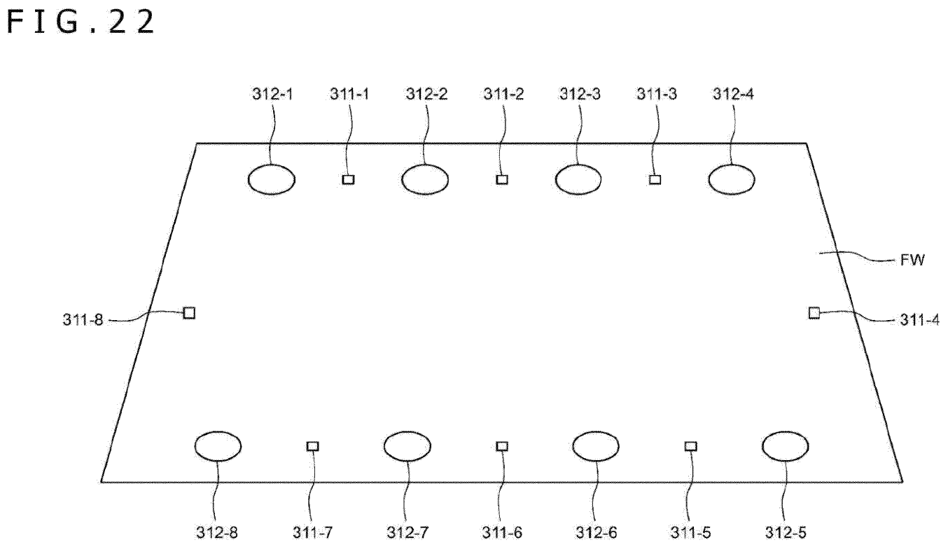

More specifically, as depicted in FIG. 21 and FIG. 22, the feedback-scheme NC apparatus 33 includes sensors 311-1 to 311-8, actuators 312-1 to 312-8, and an NC processing section 313. Note that FIG. 21 is a side cross-sectional view of the vehicle 1 provided with two sets of sensors 311 and actuators 312, and FIG. 22 is a front view of a front window (glass) FW of the vehicle 1 as seen from the front side of the vehicle 1.

The sensors 311-1 to 311-8 and the actuators 312-1 to 312-8 are pasted onto a side rim of the front window FW in pairs with adhesive or the like such that a visual field of a user who is a driver is not obstructed.

The sensors 311-1 to 311-8 are acceleration sensors that sense vibrations of the front window FW at their respective corresponding nearby positions, and output, to the NC processing section 313, sensor signals including sensing results.

The actuators 312-1 to 312-8 are pasted at positions corresponding to the sensors 311-1 to 311-8, respectively, and are controlled by the NC processing section 313 to excite their respective corresponding positions of the front window FW.

Upon acquisition of the sensor signals including information regarding accelerations corresponding to the vibrations of the front window FW supplied from the sensors 311-1 to 311-8, the NC processing section 313 controls the actuators 312-1 to 312-8 at the corresponding positions and causes them to excite the relevant portions of the front window FW in such a manner as to cancel the vibrations sensed at the sensors 311-1 to 311-8.

With such a configuration, the feedback-scheme NC apparatus 33 senses vibrations of an object that generates noise such as a panel like the front window FW, and implements a predetermined NC filtering process in response to vibration sensing results, thereby applying inverse phase excitation to the sensed vibrations. Thus, the feedback-scheme NC apparatus 33 reduces noise by suppressing the vibrations of the object.

Unlike the NC process as performed by the feedforward-scheme NC apparatus 33 that presumes that vibration sources such as tires that generate noise are known, even for noise whose vibration source is unknown, the feedback-scheme NC apparatus 33 can reduce noise by forcibly suppressing vibrations of an object such as a panel that is already generating noise by exciting the object with an actuator or the like.

### <Configuration Example of Actuator>

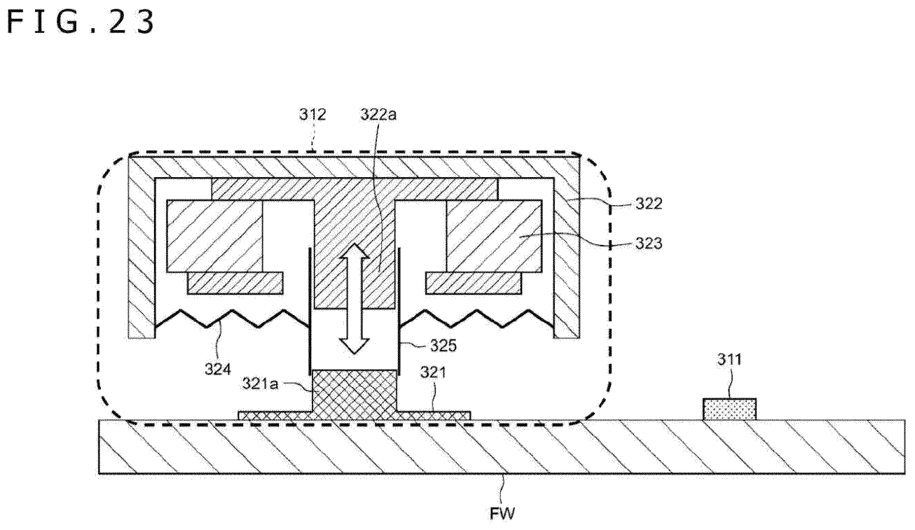

FIG. 23 is a side cross-sectional view of an actuator 312 installed in a pasted state on the front window FW. Note that the sensor 311 on the right side in the figure is paired with the actuator 312.

The actuator 312 includes an actuator base 321, a voice coil case 322, a voice coil 323, a damper 324, and a voice coil bobbin 325.

The actuator base 321 supports the whole of the actuator 312 and is pasted onto the front window FW at its bottom with adhesive or the like.

The voice coil case 322 is a case covering the whole of an outer circumference of the voice coil 323 and is configured integrally with the voice coil 323.

The voice coil 323 is electrically connected with the NC processing section 313 by an unillustrated electric wire, is excited by a drive signal applied by the NC processing section 313, and vibrates in arrow directions in the figure at a frequency according to a frequency of the drive signal. Thus, the voice coil case 322 configured integrally with the voice coil 323 vibrates in the arrow directions in the figure.

The damper 324 is a concentric bellows connecting, under a predetermined tension, an outer-circumference-side side surface of the tubular bobbin 325 including an opening in an up-down direction in the figure and an inner-circumference-side side surface of the voice coil case 322. By connecting the outer-circumference-side side surface of the bobbin 325 and the inner-circumference-side side surface of the voice coil case 322 under the predetermined tension, the damper 324 fixes the voice coil case 322 at a stationary position at which the damper 324 is maintained substantially in a horizontal direction as depicted in FIG. 23 when a drive signal is not being supplied to the voice coil 323. In addition, in a case where a drive signal is being supplied to the voice coil 323, the bellows-like damper 324 extends and contracts to restrict a movable range of the voice coil case 322 vibrating in the up-down direction.

The bobbin 325 is configured in a tubular shape and functions as a central shaft of the actuator 312. A shaft 322a of the voice coil case 322 is inserted through the opening of the bobbin 325 at its upper portion in the figure in such a state that the shaft 322a can slide in the up-down direction in the figure. In addition, a protrusion 321a of the actuator base 321 is inserted to the opening of the bobbin 325 at its lower portion in the figure in a fixed state.

With such a configuration, when a drive signal with a predetermined voltage and a predetermined frequency is supplied from the NC processing section 313, the voice coil 323 vibrates in the up-down direction as represented by the arrow in the figure, and the shaft 322a of the voice coil case 322 configured integrally with the voice coil 323 slides and thus vibrates in the up-down direction according to the tension of the damper 324 in the bobbin 325.

Due to vibrations of the voice coil case 322 in this manner, force according to a weight of the voice coil case 322 including the voice coil 323 is applied to the front window FW via the actuator base 321, and the front window FW is thus excited.

The NC processing section 313 implements the filtering process for realizing predetermined NC on a signal of an acceleration sensed at the sensor 311, to adjust and supply a drive signal to be applied to the voice coil 323, and causes excitation in such a manner as to cancel vibrations of the front window FW sensed by the sensor 311.

As a result, vibrations that are generated at the front window FW and generate noise are canceled by the actuator 312. Thus, vibrations of the front window FW are suppressed, and it becomes possible to reduce noise that occurs due to the vibrations.

### <Configuration Example of NC Processing Section>

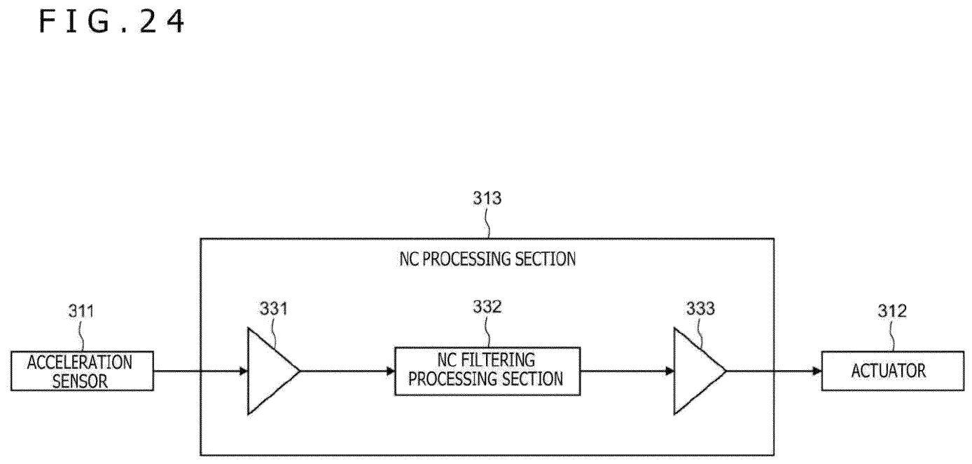

Next, a configuration example of the NC processing section 313 is explained with reference to FIG. 24. The NC processing section 313 includes an amplifier 331, an NC filtering processing section 332, and an amplifier 333.

The amplifier 331 amplifies a signal of a sensed acceleration supplied from the sensor 311 to a predetermined level and outputs the signal to the NC filtering processing section 332.

The NC filtering processing section 332 generates such a drive signal that causes vibrations with a phase and a frequency for canceling vibrations of the front window FW, by implementing a predetermined NC filtering process on the sensor signal that corresponds to the acceleration sensed by the sensor 311 and is supplied via the amplifier 331, amplifies the drive signal at a predetermined rate via the amplifier 333, and applies the drive signal to (the voice coil 323 of) the actuator 312.

Thus, the drive signal for canceling vibrations which signal corresponds to the acceleration sensed at the front window FW is applied to the voice coil 323 of the actuator 312. Accordingly, the actuator 312 is excited vertically in such a manner as to cancel the vibrations of the front window FW.

As a result, due to vibrations of the actuator 312, the front window FW is excited with force according to a weight of the actuator 312, the vibrations of the front window FW sensed by the sensor 311 are canceled, the vibrations of the front window FW are suppressed, and noise that occurs due to the vibrations of the front window FW is reduced.

### <NC Process Performed by Sensor and Actuator>

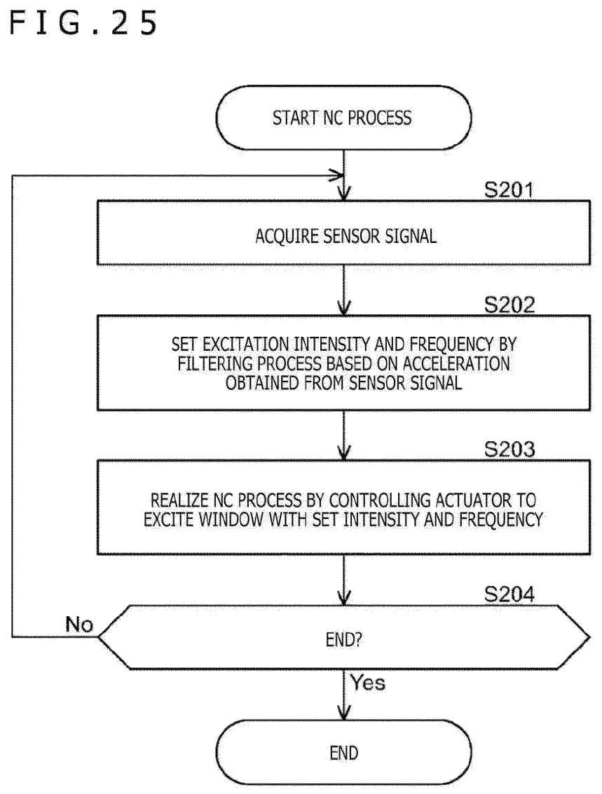

Next, the NC process performed by the sensor 311 and the actuator 312 in FIG. 23 and FIG. 24 is explained with reference to a flowchart in FIG. 25.

At Step S201, the NC filtering processing section 332 of the NC processing section 313 acquires a sensor signal of an acceleration sensed by the sensor 311 via the amplifier 331.

At Step S202, the NC processing section 313 sets a drive signal for vibrating the voice coil 323, by implementing the NC filtering process on the sensor signal supplied from the sensor 311.

At Step S203, the NC processing section 313 applies the drive signal for vibrating the voice coil 323 which signal is set by the filtering process, to the actuator 312 via the amplifier 333, vibrates the actuator 312, and causes excitation in such a manner as to cancel vibrations of the front window FW.

At Step S204, it is determined whether or not the process has been instructed to end, and, in a case where the process has not been instructed to end, the process returns to Step S201, and the subsequent process is repeated. Then, in a case where the process has been instructed to end at Step S204, the process ends.

Since the front window FW is excited due to vibrations of the actuator 312 by the process mentioned above, vibrations are suppressed, and noise caused by the vibrations of the front window FW is reduced.

### 8. First Modification Example of Second Embodiment

While the FB-scheme NC apparatus 33 has been explained as mentioned above, in a case where the eight actuators 312 in FIG. 23 paired with the same number of sensors 311 are installed and used as depicted in FIG. 22, the total of 16 components needs to be pasted along an outer circumference of the front window FW, and accordingly, workload related to the installation is significant.

In view of this, it is possible that the workload related to the installation is reduced by adopting a structure in which an actuator and a sensor are integrated.

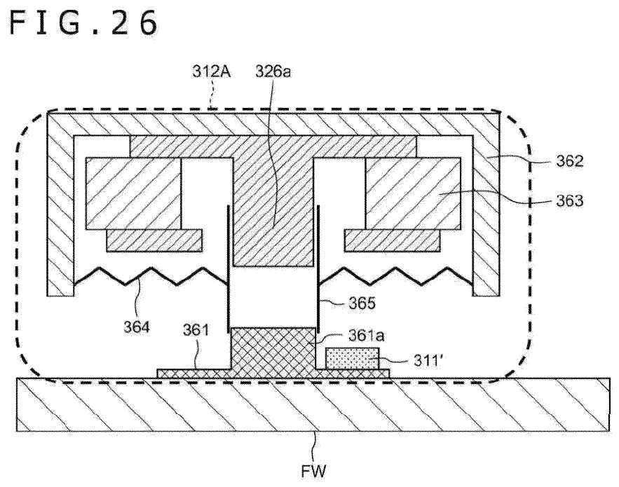

FIG. 26 is a side cross-sectional view of an actuator in which an actuator and a sensor are integrated. An actuator 312A in FIG. 26 includes an actuator base 361, a voice coil case 362, a voice coil 363, a damper 364, a voice coil bobbin 365, and a sensor 311′.

Note that the actuator base 361, the voice coil case 362, the voice coil 363, the damper 364, and the voice coil bobbin 365 are components corresponding to the actuator base 321, the voice coil case 322, the voice coil 323, the damper 324, and the voice coil bobbin 325 in FIG. 23, respectively. In addition, the sensor 311′ is a component identical to the sensor 311 in FIG. 23.

With such a configuration, it becomes possible to paste both the actuator 312A and the sensor 311′ simultaneously at the time of installation on the front window FW since the actuator 312A has a structure including the sensor 311′, and it becomes possible to reduce the workload related to the installation work by half.

Note that the NC process performed by the actuator 312A in FIG. 26 includes a process performed by the sensor 311′ which is a process similar to the process performed by the sensor 311, and a process performed by the actuator 312A which is a process similar to the process performed by the actuator 312, and accordingly, explanations thereof are omitted. Note that similar switching applies to the realization of the subsequent modification examples, and accordingly, explanations are omitted similarly.

### 9. Second Modification Example of Second Embodiment

While a configuration in which an actuator and a sensor are integrated has been explained thus far, when a malfunction occurs, for example, in the voice coil 363 which is a driving portion, and replacement is necessary in a case where an actuator and a sensor are integrated, the sensor 311′ also needs to be replaced together, resulting in replacement also of the sensor 311′, which is not malfunctioning, and increased repair costs.

In view of this, in another possible configuration, a voice coil case 362 and an actuator base 361 are configured to be attachable and detachable, and it is made possible to replace only the voice coil case 362 in a case where a malfunction occurs in the voice coil 363.

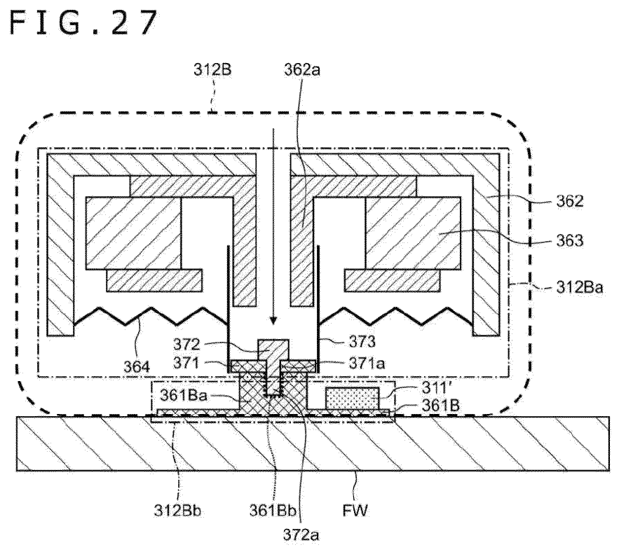

FIG. 27 is a side cross-sectional view of an actuator 312B in which a voice coil case 362 and an actuator base 361 are attachable and detachable. Note that components in the actuator 312B in FIG. 26 that have functions identical to the functions of the actuator 312A in FIG. 25 are given identical reference signs, and explanations thereof are omitted.

The actuator 312B in FIG. 27 is different from the actuator 312A in FIG. 26 in that the actuator 312B is configured to be able to be disassembled into a driving section 312Ba including the voice coil case 362 and a base 312Bb including the actuator base 361.

In addition, the actuator 312B in FIG. 27 is provided with a bobbin 373 instead of the bobbin 365. A hole into which a bolt 372 can be inserted as represented by an arrow is formed through a shaft 362a of the voice coil case 362, and the bolt 372 reaches the bobbin 373 after passing through the hole. A bottom of the bobbin 373 is provided with a base plate 371 having a hole 371a through which a screw section 372a of the bolt 372 can be inserted from above in the figure. An actuator base 361B is provided with a protrusion 361Ba having, at a central position of its top, a screw hole 361Bb that can be screwed with the screw section 372a of the bolt 372 from above in the figure.

With such a configuration, when the bolt 372 penetrates the hole 371a of the base plate 371 provided at the bottom of the bobbin 373 and is screwed with the screw hole 361Bb provided on a top of a protrusion 361a′ of the actuator base 361, the base plate 371 and the top of the protrusion 361a′ are joined, and the driving section 312Ba and the base 312Bb including the actuator base 361 are joined and integrated, so that the actuator 312B is formed.

Conversely, when the screw section 372a of the bolt 372 is pulled out from the hole 371a of the base plate 371 provided at the bottom of the bobbin 373 and from the screw hole 361Bb provided on a top of the protrusion 361Ba of the actuator base 361B, the joining between the base plate 371 and the top of the protrusion 361Ba is released, and accordingly, the driving section 312Ba and the base 312Bb can be disassembled in this state.

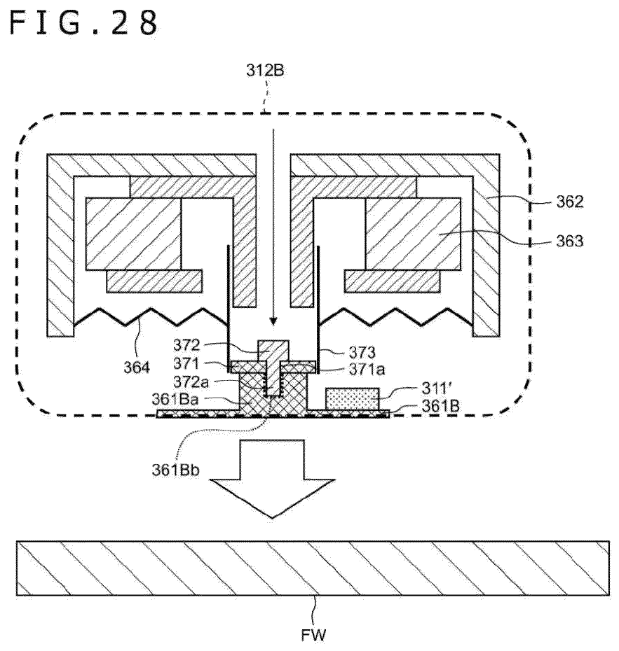

With such a configuration, when the actuator 312B is to be installed on the front window FW, as depicted in FIG. 28, the bolt 372 is caused to penetrate the hole 371a of the base plate 371 and is screwed with the screw hole 361Bb provided on the top of the protrusion 361Ba of the actuator base 361B, and the work is proceeded with in a state where the driving section 312Ba and the base 312Bb are joined and integrated.

By doing so, it becomes possible to install the actuator 312B with the sensor 311′ included therein, and it becomes possible to reduce the workload related to the installation.

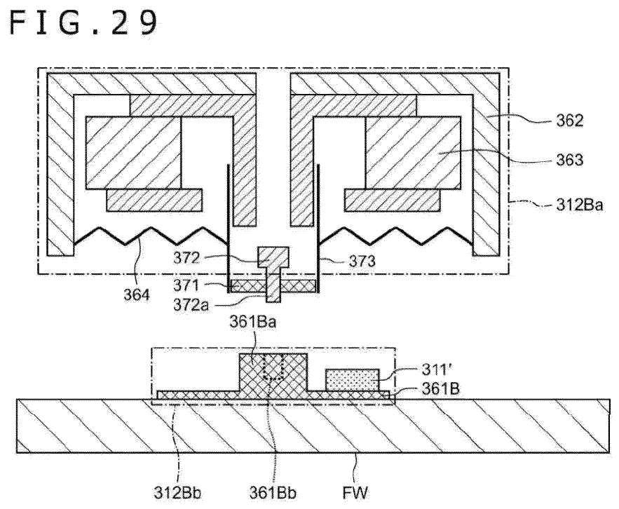

In addition, in a case where a malfunction has occurred in the voice coil 363 and replacement is necessary, as depicted in FIG. 29, the screw section 372a of the bolt 372 is removed from the screw hole 361Bb provided on the top of the protrusion 361Ba, and only the driving section 312Ba is thus removed from the base 312Bb and replaced.

Since the base 312Bb remains adhered to the front window FW in this case, it becomes possible to replace the driving section 312Ba with a new driving section 312Ba simply by connecting the new driving section 312Ba to the base 312Bb by using the bolt 372, and accordingly, the work for re-positioning becomes unnecessary. In addition, in a case where there are no abnormalities in the sensor 311′, the one having been used until then can be reused as is, and accordingly, it becomes possible to reduce the cost and effort related to the replacement.

### 10. Third Modification Example of Second Embodiment

While the actuator 312B explained thus far is provided, on the actuator base 361, with one sensor 311′ for sensing the acceleration related to vibrations of the front window FW, a sensor that senses the acceleration related to vibrations of the voice coil case 362 may be provided on the voice coil case 362.

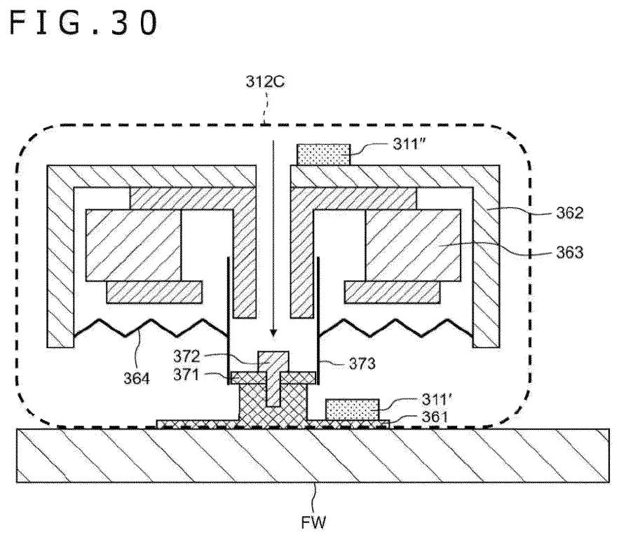

FIG. 30 depicts a side cross-sectional view of an actuator 312C provided, on the voice coil case 362, with a sensor that senses the acceleration related to vibrations of the voice coil case 362.

The actuator 312C in FIG. 30 is different from the actuator 312B in FIG. 27 in that a sensor 311″ that senses the acceleration related to vibrations of the voice coil case 362 is additionally provided on the voice coil case 362.

The sensor 311″ senses the acceleration related to vibrations of the voice coil case 362 and outputs the acceleration to the NC processing section 313.

With such a configuration, the acceleration related to vibrations of the voice coil case 362 is sensed. Accordingly, the state of excitation of the front window FW can be recognized, and it becomes possible to set a drive signal of the actuator 312C taking the state into account. Accordingly, it becomes possible to more appropriately suppress vibrations of the front window FW and more appropriately reduce noise that occurs due to the vibrations. In addition, abnormal vibrations at the voice coil case 362 can be sensed on the basis of the acceleration related to vibrations of the voice coil case 362, and accordingly, it becomes possible to sense an abnormality that occurs in the voice coil 363.

### 11. Fourth Modification Example of Second Embodiment

While a configuration that presumes the necessity for additionally performing connection work for wiring to the voice coil 363 has been explained thus far, wiring connection sections may be configured at a part of the base plate 371 and a part of the top of the protrusion 361a′ that abut against each other, and it may be made possible to establish a wiring connection simply by joining the driving section 312Ba and the base 312Bb.

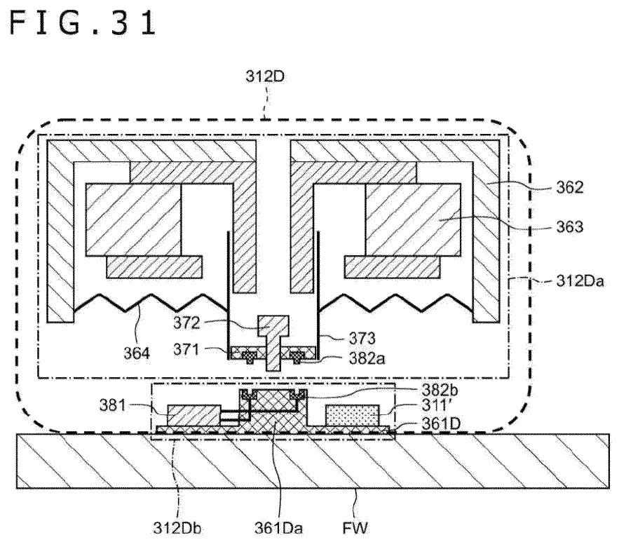

FIG. 31 depicts a side cross-sectional view of an actuator 312D in which wiring connection sections are configured at a part of the base plate 371 and a part of the top of the protrusion 361a′ and a wiring connection can be established simply by joining a driving section 312Da and a base 312Db.

The actuator 312D in FIG. 31 is different from the actuator 312B in FIG. 27 in that a wiring connection section 382a is formed at a part of a lower portion in the figure of the base plate 371 and a wiring connection section 382b is formed at a part of a top of a protrusion 361Da.

The wiring connection sections 382a and 382b are formed at positions at which the wiring connection sections 382a and 382b face each other when the driving section 312Da and the base 312Db are joined using the bolt 372.

In addition, the wiring connection section 382b is connected with a connector 381 formed on the actuator base 361. The NC processing section 313 can supply a drive signal to the voice coil 363 when an unillustrated wiring connected with the NC processing section 313 is connected with the connector 381.

With such a configuration, the work to establish an electrical connection between the voice coil 363 and the NC processing section 313 can be completed simply by joining the driving section 312Da and the base 312Db using the bolt 372, and it becomes possible to reduce the workload related to the wiring connection that is necessary at the time of the replacement of the driving section 312Da.

### 12. Fifth Modification Example of Second Embodiment

While the physical joining and electrical joining between the driving section 312Da and the base 312Db can be simultaneously realized simply by using the bolt 372 in the example explained thus far, threads may be formed on an outer circumference of the protrusion 361Da of an actuator base 361D, and it may be made possible to establish a connection between the driving section 312Da and the base 312Db by using a connector.

Provided is a side cross-sectional view of an actuator 312E in which threads are formed on an outer circumference of the protrusion 361a of the actuator base 361 and it is made possible to establish connection by using a connector.

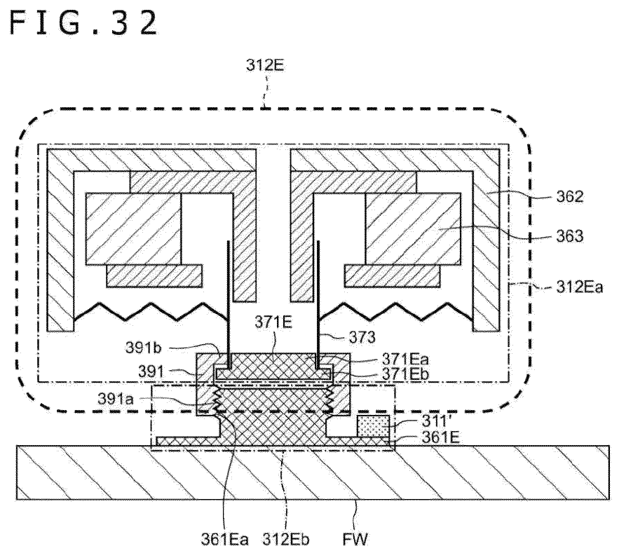

The actuator 312E in FIG. 32 is different from the actuator 312B in FIG. 27 in that threads are formed on an outer circumference of a protrusion 361Ea of an actuator base 361E and connection is established using a tubular connector 391 having threads formed on its inner side.

The connector 391 is configured in a tubular shape with substantially the same diameter as diameters of the protrusion 361Ea and a lower portion 371Eb of a base plate 371E, threads 391a are formed on an inner circumference of the connector 391, and a lid 391b having an opening only at an upper portion in the figure is formed. The opening of the lid 391b has a diameter smaller than the diameters of the protrusion 361Ea and the lower portion 371Eb of the base plate 371E and has substantially the same diameter as a diameter of the bobbin 373, and the bobbin 373 is inserted therethrough. Further, an upper portion 371Ea of the base plate 371E has the same diameter as the diameter of the bobbin 373, the lower portion 371Eb of the base plate 371E is greater in diameter than the bobbin 373 and is substantially the same in diameter as the protrusion 361Ea, and the base plate 371E is connected with adhesive or the like at a lower end in the figure of the bobbin 373.

Because of this, when the threads 391a of the connector 391 and the threads formed on the outer circumference of the protrusion 361Ea are screwed with each other, connection is established in a state where the base plate 371E and a top of the protrusion 361Ea abut against each other. In addition, when the screwing between the connector 391 and the protrusion 361Ea is released, a driving section 312Ea and a base 312Eb can be separated from each other.

With such a configuration, it becomes possible to attach or detach the driving section 312Ea and the base 312Eb to or from each other.

### 13. Sixth Modification Example of Second Embodiment

While threads are formed on the outer circumference of a protrusion 361Ca of an actuator base 361C and connection can be established using the connector 391 in the example explained thus far, a structure in which the bolt 372 and the base plate 371 are integrated may be adopted.

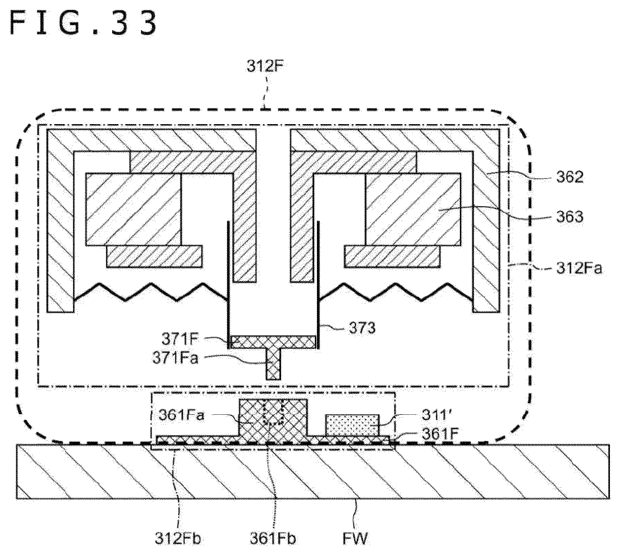

FIG. 33 is a side cross-sectional view of an actuator 312F in which the bolt 372 and the base plate 371 are integrated.

In the actuator 312F in FIG. 33, a bolt section 371Fa is formed at a lower portion in the figure of a base plate 371F, and, by screwing the bolt section 371Fa to a hole 361Fb formed through a top of a protrusion 361Fa of an actuator base 361F, a base plate 371D and the protrusion 361Da are joined, and it becomes possible to connect a driving section 312Fa and a base 312Fb.

### 14. Seventh Modification Example of Second Embodiment

While the bolt 372 and the base plate 371 have an integrated structure in the example explained thus far, in another possible configuration, threads may not be provided inside the connector 391 in FIG. 32, and a top of the protrusion 361a of the actuator base 361 may be fitted in the connector 391 in a cap-like manner and separately secured with screws.

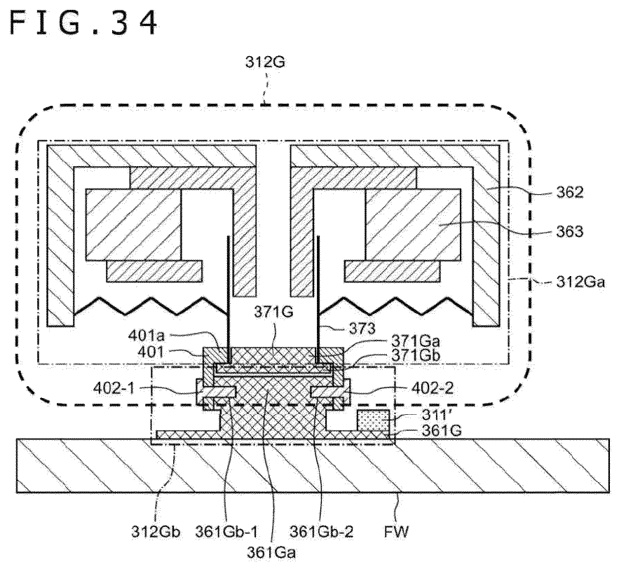

FIG. 34 is a side cross-sectional view of an actuator 312G in which a connector into which a protrusion 361Ga of an actuator base 361G is fitted in a cap-like manner is provided and it is made possible to connect a driving section 312Ga and a base 312Gb by screwing the connector and the protrusion 361Ga with each other.

In the actuator 312G in FIG. 34, the driving section 312Ga and the base 312Gb are connected by a connector 401 that fixes the protrusion 361Ga of the actuator base 361G in a state where the protrusion 361Ga is fitted in a cap-like manner.

An upper portion 401a of the connector 401 has formed therethrough an opening having a diameter which is smaller than diameters of the protrusion 361Ga and a lower portion 371Gb of a base plate 371G and is substantially the same diameter as the diameter of the bobbin 373.

An upper portion 371Ga of the base plate 371G has a diameter slightly smaller than the diameter of the bobbin 373, and the lower portion 371Gb of the base plate 371G is greater in diameter than the bobbin 373, and is substantially the same in diameter as the protrusion 361Ga.

The connector 401 is configured in such a cap-like shape that the whole head of the protrusion 361Ga is fitted into the connecter 401 in a state where the base plate 371G is placed on a top of the protrusion 361Ga.

Screw holes 361Gb-1 and 361Gb-2 are formed through a side surface of the protrusion 361Ga, and the connector 401 and the protrusion 361Ga are fixed in a connected state by causing screws 402-1 and 402-2 to penetrate a side surface of the connector 401 covering the top of the protrusion 361Ga in a cap-like manner and to be inserted and screwed to the screw holes 361Gb-1 and 361Gb-2 of the protrusion 361Ga.

By the connection and fixation between the connector 401 and the top of the protrusion 361Ga of the actuator base 361G in this manner, it becomes possible to connect the driving section 312Ga and the base 312Gb.

In addition, the connection between the connector 401 and the protrusion 361Ga is released when the screws 402-1 and 402-2 are removed from the screw holes 361Gb-1 and 361Gb-2, and hence, the connection between the driving section 312Ga and the base 312Gb is also released. Accordingly, it becomes possible to separate the driving section 312Ga and the base 312Gb.

Note that, although the actuators 312 and 312A to 312G explained in the second embodiment have different structures, for example, operations and processes in the NC process explained with reference to the flowchart in FIG. 25 are common to the actuators 312 and 312A to 312G. In view of this, while it is assumed hereinbelow that, for the explanation of processes, the actuator 312 is used representatively for the explanation as necessary, similar functions can be achieved even if the actuator 312 is replaced with any of the actuators 312A to 312G.

### <<15. Eighth Modification Example of Second Embodiment

In the example explained thus far, the NC processing section 313 generates a drive signal by implementing the NC filtering process on a sensor signal which is a sensing result from the sensor 311, supplies the drive signal to the actuator 312, and causes the actuator 312 to operate.

However, it is known that frequency characteristics of excitation force of the actuators 312 are dependent on an ambient temperature.

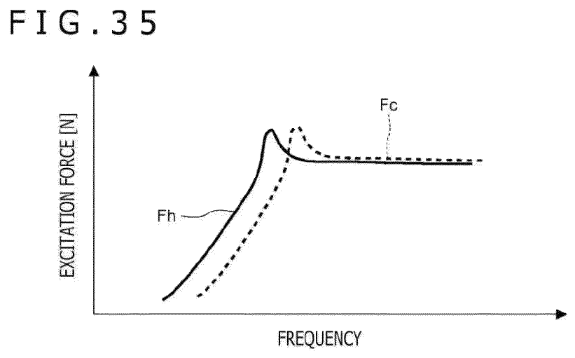

More specifically, since compliance of the damper 364 is temperature-dependent, for example, the compliance of the excitation force for each frequency is larger at higher temperature and is smaller at lower temperature as depicted in FIG. 35.

Note that, in FIG. 35, a waveform Fh represents compliance characteristics of the damper 364 at the time of high temperature, and a waveform Fc represents compliance characteristics of the damper 364 at the time of low temperature.

Because of this, the NC filtering process is a process adapted to compliance characteristics of a particular ambient temperature, and accordingly, if actuator characteristics change due to changes in ambient temperature, there is a possibility that the intended NC performance cannot be realized fully.

In view of this, the ambient temperature of the actuator 312 may be estimated using a vehicle exterior temperature sensor and a vehicle interior temperature sensor that are typically mounted on the vehicle 1, and the NC filter may be switched according to the estimated ambient temperature of the actuator 312. In addition, in a case where the ambient temperature of the actuator 312 has exceeded a safely usable range, the output from the amplifier to the actuator 312 may be muted to protect the actuator 312.

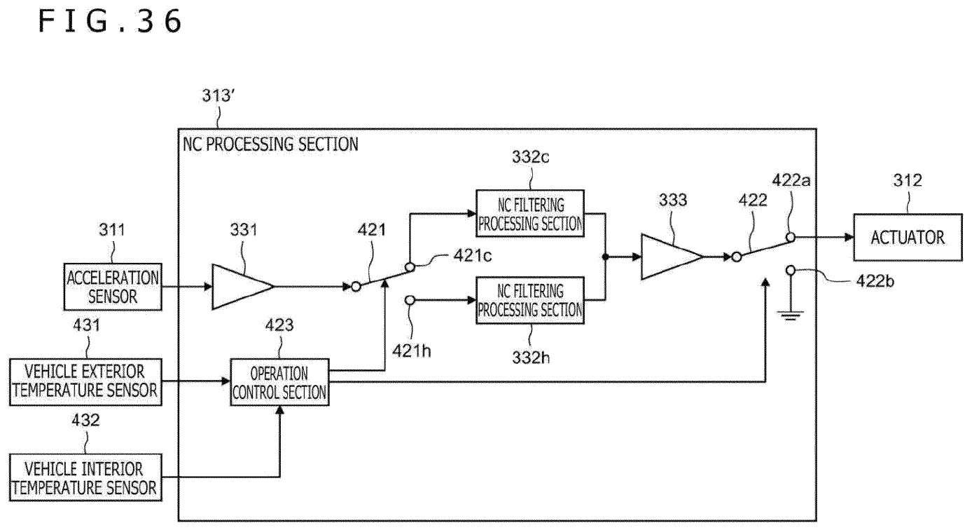

FIG. 36 depicts a configuration example of an NC processing section 313′ that switches the NC filter according to the ambient temperature of the actuator 312 and that mutes the output from the amplifier to the actuator 312 in a case where the ambient temperature of the actuator 312 has exceeded a safely usable range.

The NC processing section 313′ in FIG. 36 includes the amplifier 331, NC filtering processing sections 332c and 332h, the amplifier 333, switches 421 and 422, and an operation control section 423.

Note that the amplifier 331, the NC filtering processing sections 332c and 332h, and the amplifier 333 are basically components having functions identical to the functions of the amplifier 331, the NC filtering processing section 332, and the amplifier 333 in FIG. 24, respectively.

It should be noted that, while the NC filtering processing section 332 performs the filtering process according to the compliance characteristics of the damper 364 at the time of a predetermined ambient temperature, the NC filtering processing section 332c performs the filtering process for low temperature according to the compliance characteristics of the damper 364 when the ambient temperature is lower than a predetermined threshold, and the NC filtering processing section 332h performs the filtering process for high temperature according to the compliance characteristics of the damper 364 when the ambient temperature is higher than a predetermined threshold.

The operation control section 423 estimates the ambient temperature of the actuator 312 from a temperature outside the vehicle cabin and a temperature inside the vehicle cabin which are supplied from a vehicle exterior temperature sensor 431 and a vehicle interior temperature sensor 432 mounted on the typical vehicle 1, respectively.

In a case where the ambient temperature of the actuator 312 is lower than the predetermined threshold, the operation control section 423 connects the switch 421 to a terminal 421c such that a sensor signal from the amplifier 331 is supplied to the NC filtering processing section 332c, and switches to an operation mode in which the NC filtering process with characteristics for a temperature lower than the predetermined temperature is executed.

In a case where the ambient temperature of the actuator 312 is higher than the predetermined threshold, the operation control section 423 connects the switch 421 to a terminal 421h such that a sensor signal from the amplifier 331 is supplied to the NC filtering processing section 332h, and switches to an operation mode in which the NC filtering process with characteristics for a temperature higher than the predetermined temperature is executed.

In a case where the ambient temperature of the actuator 312 is not within a safely operable range of the actuator, the operation control section 423 connects the switch 422 to a terminal 422b, releases the output from the amplifier 333 to the ground, and switches to an operation mode in which the actuator 312 is substantially muted.

In a case where the ambient temperature of the actuator 312 is within the safely operable range of the actuator, the operation control section 423 connects the switch 422 to a terminal 422a, causes the output from the amplifier 333 to be output to the actuator 312, and switches to a mode in which the normal NC process is executed.

With such a configuration, it becomes possible for the NC processing section 313′ in FIG. 36 to realize the appropriate NC process since the NC processing section 313′ appropriately performs switching between the NC filtering processing sections 332c and 332h to use, according to temperature characteristics on the basis of the ambient temperature of the actuator 312. In addition, in a case where the ambient temperature of the actuator 312 is not within the safely operable range of the actuator 312, the output from the amplifier 333 is substantially muted by being stopped, to thereby protect the actuator 312.

### <Operation Mode Control Process Performed by NC Processing Section in FIG. 36>

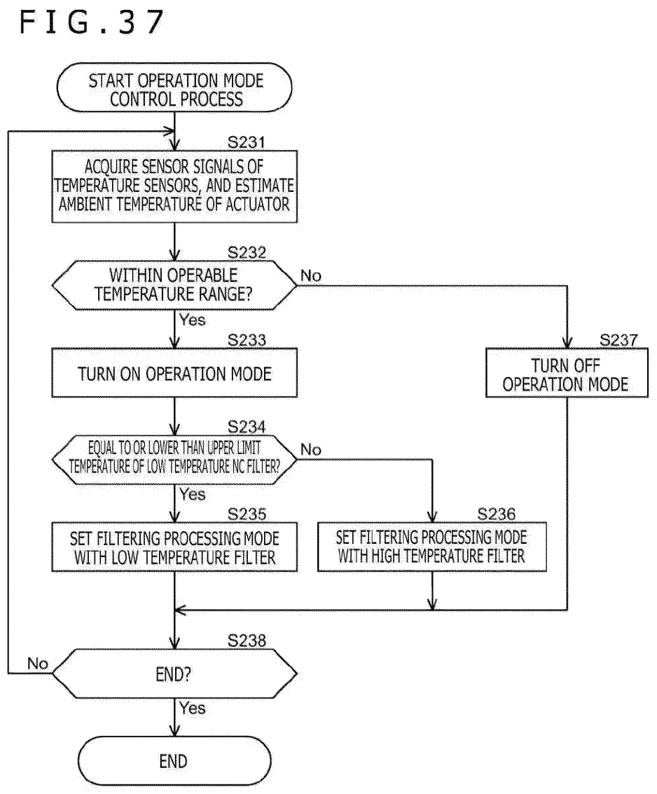

Next, an operation mode control process performed by the NC processing section 313′ in FIG. 36 is explained with reference to a flowchart in FIG. 37.

At Step S231, the operation control section 423 estimates the ambient temperature of the actuator 312 from a temperature outside the vehicle cabin and a temperature inside the vehicle cabin which are supplied from the vehicle exterior temperature sensor 431 and the vehicle interior temperature sensor 432, respectively.

At Step S232, the operation control section 423 determines whether or not the estimated ambient temperature of the actuator 312 is within the safely operable temperature range of the actuator 312.

In a case where it is determined at Step S232 that the estimated ambient temperature of the actuator 312 is within the safely operable temperature range of the actuator 312, the process proceeds to Step S233.

At Step S233, the operation control section 423 turns on the operation mode, connects the switch 422 to the terminal 422a, and enables the supply of a drive signal output from the amplifier 333, to the actuator 312.

At Step S234, the operation control section 423 determines whether or not the estimated ambient temperature of the actuator 312 is equal to or lower than an upper-limit usable temperature of a low temperature NC filter.

In a case where it is determined at Step S234 that the estimated ambient temperature of the actuator 312 is equal to or lower than the upper-limit usable temperature of the low temperature NC filter, the process proceeds to Step S235.

At Step S235, the operation control section 423 turns on an operation mode that uses the low temperature NC filter, connects the switch 421 to the terminal 421c, and enables the supply of a sensor signal from the amplifier 331 to the NC filtering processing section 332c.

On the other hand, in a case where it is determined at Step S234 that the estimated ambient temperature of the actuator 312 is not equal to or lower than the upper-limit usable temperature of the low temperature NC filter, the process proceeds to Step S236.

At Step S236, the operation control section 423 turns on an operation mode that uses a high temperature NC filter, connects the switch 421 to the terminal 421h, and enables the supply of a sensor signal from the amplifier 331 to the NC filtering processing section 332h.

In addition, in a case where it is determined at Step S232 that the estimated ambient temperature of the actuator 312 is not within the safely operable temperature range of the actuator 312, the process proceeds to Step S237.

At Step S237, the operation control section 423 turns off the operation mode, connects the switch 422 to the terminal 422b, and substantially mutes the output from the amplifier 333 such that it is not output to the actuator 312.

At Step S238, the operation control section 423 determines whether or not the operation has been instructed to end, and, in a case where the operation has not been instructed to end, the process returns to Step S231, and the subsequent process is repeated.

Then, in a case where the process has been instructed to end at Step S238, the process ends.

By the process mentioned above, it becomes possible to realize the appropriate NC process since the NC filtering processing sections 332c and 332h are appropriately switched to be used according to temperature characteristics on the basis of the ambient temperature of the actuator 312. In addition, in a case where the ambient temperature of the actuator 312 has exceeded the safely operable range of the actuator 312, the output of a drive signal from the amplifier 333 is substantially muted by being stopped, and it becomes possible to protect the actuator 312.

Note that, in the NC process hereinbelow, substantially the processes explained with reference to the flowchart in FIG. 25 are performed on the basis of the settings made in the operation mode control process explained with reference to the flowchart in FIG. 37. It should be noted that the filtering process uses the low temperature NC filter and the high temperature NC filter that are switched on the basis of the ambient temperature of the actuator 312, and, when the ambient temperature is outside the safely operable range, the output to the actuator 312 is stopped to protect the actuator 312.

For example, in a case where a lower limit temperature of the low temperature NC filter is 0 degrees, the upper limit temperature of the low temperature NC filter is lower than 20 degrees, a lower limit temperature of the high temperature NC filter is equal to or higher than 20 degrees, an upper limit temperature of the high temperature NC filter is lower than 40 degrees, and the safely operable temperature range is a range up to 40 degrees, the low temperature NC filtering process is performed when the ambient temperature of the actuator 312 is 0 to 20 degrees, the high temperature NC filtering process is performed when the ambient temperature is 20 to 40 degrees, and the NC filter processes are muted when the ambient temperature is lower than 0 degrees or exceeds 40 degrees.

### <<16. Ninth Modification Example of Second Embodiment

In the example explained thus far, the ambient temperature of an actuator is estimated using a typical vehicle interior temperature sensor and vehicle exterior temperature sensor, the NC filters are switched on the basis of an estimation result, and, when the ambient temperature is within a safely inoperable temperature range, the supply of a control signal to the actuator 312 is stopped.

Meanwhile, it may not necessarily be possible to obtain signals from the temperature sensors, and, in such a case, the process mentioned above cannot be realized. However, recently, a navigation device is mounted on many vehicles 1, and accordingly, it becomes possible to realize the process mentioned above as long as the ambient temperature can be estimated using sensor signals from sensors necessarily included in the navigation device. In addition, the compliance characteristics of the damper 364 change significantly even with a small temperature change, and it is desirable that a larger number of NC filters each for a narrower temperature range be switchable on the basis of the ambient temperature.

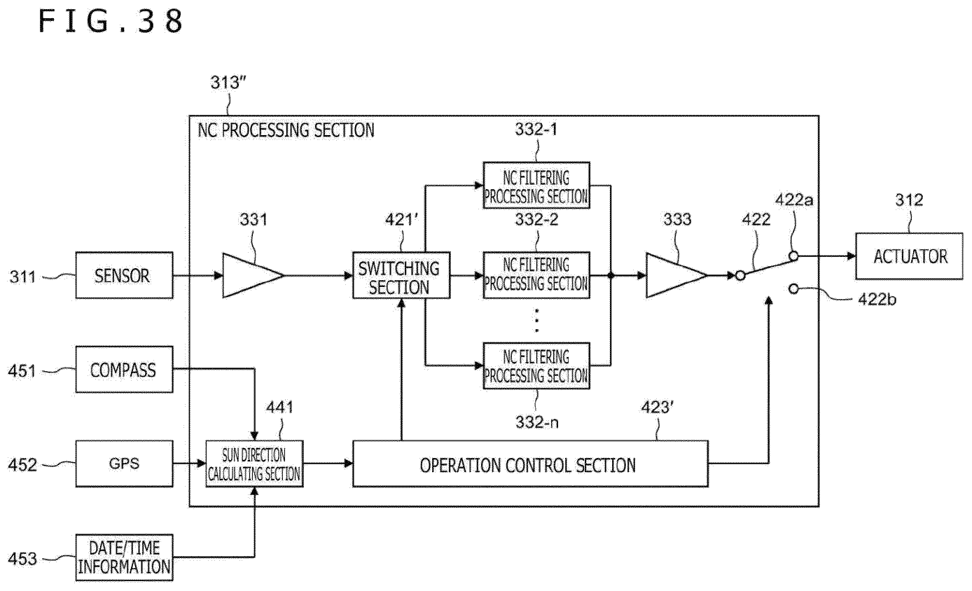

FIG. 38 depicts a configuration example of an NC processing section 313″ that estimates the ambient temperature by using sensors necessarily included in a navigation device mounted on many vehicles 1 and that can perform switching among a larger number of NC filtering processes according to temperature characteristics on the basis of an estimation result.

The NC processing section 313″ includes the amplifier 331, NC filtering processing sections 332-1 to 332-n, the amplifier 333, a switching section 421′, the switch 422, an operation control section 423′, and a sun direction calculating section 441.

Note that the amplifier 331, the NC filtering processing sections 332-1 to 332-n, and the amplifier 333 are components having functions identical to the functions of the amplifier 331, the NC filtering processing section 332, and the amplifier 333 in FIG. 24, respectively.

It should be noted that each of the NC filtering processing sections 332-1 to 332-n performs the filtering process according to the compliance characteristics of the damper 364 set for one of narrow temperature ranges of the ambient temperature of the actuator 312.

The switching section 421′ has a configuration corresponding to the switch 421 in FIG. 36, and is controlled by the operation control section 423′ to be connected to an NC filtering processing section 332 corresponding to the estimated ambient temperature of the actuator 312. The switch 422 has a configuration identical to the configuration in FIG. 36.

The sun direction calculating section 441 calculates a sun direction at a current position by acquiring directional information from a compass 451 which is a sensor typically mounted on the navigation device, acquiring positional information from a GPS 452, and acquiring date/time information 453 based on time information acquired by the GPS 452, and outputs the sun direction to the operation control section 423′.

The operation control section 423′ has basic functions which are identical to the basic functions of the operation control section 423, but acquires the directional information regarding the sun supplied from the sun direction calculating section 441 instead of temperature information from the vehicle exterior temperature sensor 431 and the vehicle interior temperature sensor 432. The operation control section 423 estimates the ambient temperature of the actuator 312 by estimating an illumination condition of direct sunlight on the basis of the directional information regarding the sun supplied from the sun direction calculating section 441.

By not using temperature sensors in this manner, it becomes possible to cope with a vehicle 1 not provided with temperature sensors, and it becomes possible to reduce wiring installation costs.

On the basis of the estimated ambient temperature of the actuator 312, the operation control section 423′ selects an NC filtering processing section 332 corresponding to a usable temperature range, applies the NC filtering process to an acceleration sensor signal from the amplifier 331, generates a drive signal for driving the actuator 312, and causes the drive signal to be output via the amplifier 333.

### <Operation Mode Control Process Performed by NC Processing Section in FIG. 38>

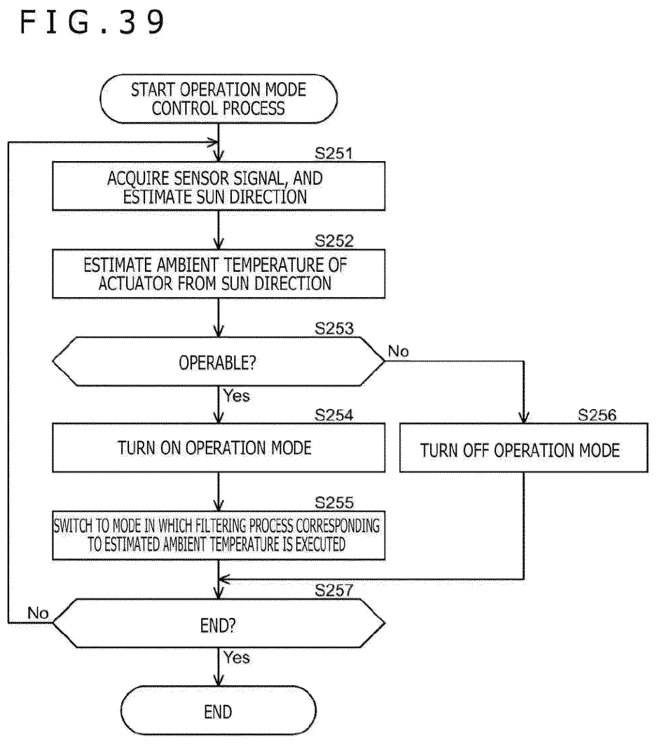

Next, an operation mode control process performed by the NC processing section 313″ in FIG. 38 is explained with reference to a flowchart in FIG. 39.

At Step S251, the sun direction calculating section 441 acquires directional information from the compass 451, acquires positional information from the GPS 452, acquires the date/time information 453 based on time information acquired by the GPS 452, calculates the sun direction at the current position from these pieces of information, and outputs the sun direction to the operation control section 423′.

At Step S252, the operation control section 423′ estimates the illumination condition of direct sunlight on the basis of the sun direction supplied from the sun direction calculating section 441, and estimates the ambient temperature of the actuator 312 from an estimation result.

At Step S253, the operation control section 423′ determines whether or not the estimated ambient temperature of the actuator 312 is within the safely operable temperature range of the actuator 312.

In a case where it is determined at Step S253 that the estimated ambient temperature of the actuator 312 is within the safely operable temperature range of the actuator 312, the process proceeds to Step S254.

At Step S254, the operation control section 423′ turns on the operation mode, connects the switch 422 to the terminal 422a, and enables the output of a drive signal output via the amplifier 333, to the actuator 312.

At Step S255, the operation control section 423′ sets the NC filtering processing mode by an NC filtering processing section 332 corresponding to the estimated ambient temperature of the actuator 312, among the NC filtering processing sections 332-1 to 322-n, and enables the supply of a sensor signal from the amplifier 331.

In addition, in a case where it is determined at Step S253 that the estimated ambient temperature of the actuator 312 is not within the safely operable temperature range of the actuator 312, the process proceeds to Step S256.

At Step S256, the operation control section 423′ turns off the operation mode, connects the switch 422 to the terminal 422b, and substantially mutes the output from the amplifier 333 such that it is not output to the actuator 312.

At Step S257, the operation control section 423′ determines whether or not the operation has been instructed to end, and, in a case where the operation has not been instructed to end, the process returns to Step S251, and the subsequent process is repeated.

Then, in a case where the process has been instructed to end at Step S257, the process ends.

By the process mentioned above, it becomes possible to realize the appropriate NC process since an NC filtering process of temperature characteristics corresponding to the estimated ambient temperature among the NC filtering processing sections 332-1 to 332-n is performed on the basis of the ambient temperature of the actuator 312. In addition, in a case where the ambient temperature of the actuator 312 has exceeded the safely operable range of the actuator 312, the output from the amplifier 333 is substantially muted by being stopped, and it becomes possible to protect the actuator 312.

### <<17. Tenth Modification Example of Second Embodiment

In the example explained thus far, the ambient temperature of an actuator is estimated, NC filters are switched on the basis of an estimation result, and the supply of a control signal to the actuator 312 is stopped when the ambient temperature is within the safely inoperable temperature range.

However, information regarding the actuator 312 may be uploaded to a cloud in association with various types of information such as positional information or traveling information, and switching among the NC filtering processing sections 332 may be performed on the basis of these pieces of information.

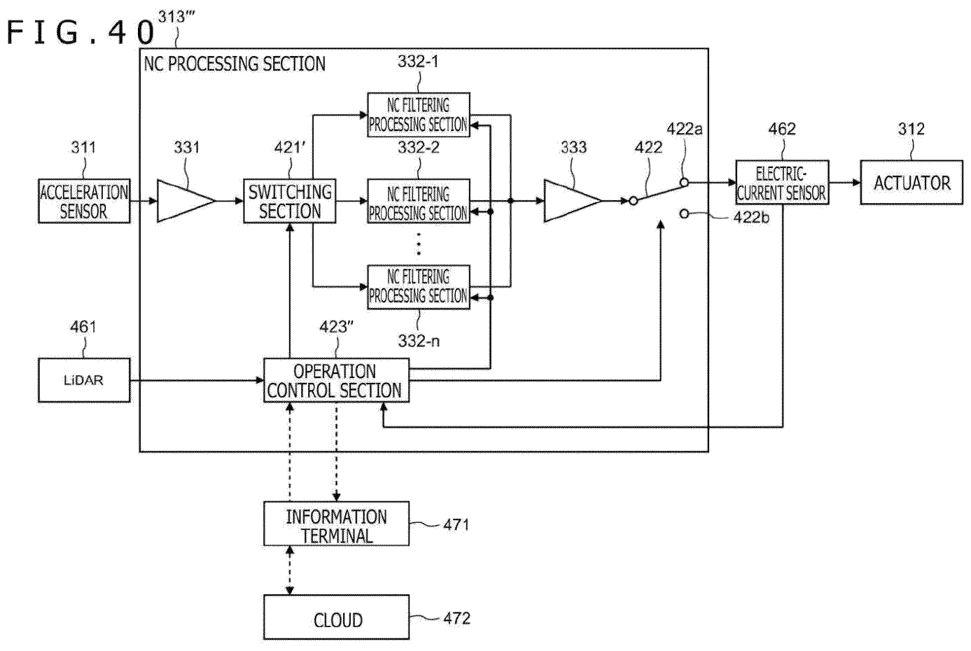

FIG. 40 depicts a configuration example of an NC processing section 313′″ that uploads, to the cloud, information regarding the actuator 312 in association with positional information and various types of information and that can perform switching between NC filtering processing sections 332 on the basis of these pieces of information.

The NC processing section 313′″ in FIG. 40 is different from the NC processing section 313″ in FIG. 38 in that the sun direction calculating section 441 is deleted, an operation control section 423″ is provided instead of the operation control section 423′, and an electric-current sensor 462 is provided between the switch 422 and the actuator.

The operation control section 423″ has basic functions similar to the basic functions of the operation control section 423′, but performs control over the switching section 421′ and the switch 422 not on the basis of the ambient temperature of the actuator 312, but on the basis of a signal of the sensor 311, positional information, road conditions, time/date information, a traveling speed of an automobile, NC Filter coefficients, traffic information (occurrence of traffic jams/traffic accidents), road surface roughness information from a LiDAR 461 (or camera), a drive signal of the actuator 312, and abnormality detection information regarding the actuator.

For example, the operation control section 423″ accesses a cloud server 472 via an information terminal 471 such as a smartphone by short distance communication means such as Bluetooth (registered trademark).

Information regarding the NC filtering processing section 332 and NC filter coefficients optimum for reducing noise identified from information such as a signal of the sensor 311, positional information, road conditions, time/date information, a traveling speed of an automobile, traffic information (occurrence of traffic jams/traffic accidents) has been registered in the cloud server 472. This is information regarding the NC filtering processing section 332 optimum for reducing the noise identified, on the basis of the information identifying noise uploaded in association with positional information from other vehicles 1.

The operation control section 423″ may access the cloud server 472 via the information terminal 471, select information regarding an optimum NC filtering processing section 332 on the basis of conditions such as a signal of the sensor 311 of itself, positional information, road conditions, time/date information, a traveling speed of an automobile, and traffic information (occurrence of traffic jams/traffic accidents), and control the switching section 421′ to perform switching such that the corresponding NC filtering processing section 332 is used.

In addition, in a case where an optimum NC filtering processing section 332 is not provided, the operation control section 423″ may download, from the cloud server 472, NC filter coefficients required for realizing the optimum NC filtering processing section 332, and update NC filter coefficients of the NC filtering processing sections 332-1 to 322-n that the NC processing section 313′″ owns.

The operation control section 423″ may upload also road surfaces roughness information obtained from the LiDAR 461 (or camera) or the like, in association with positional information.

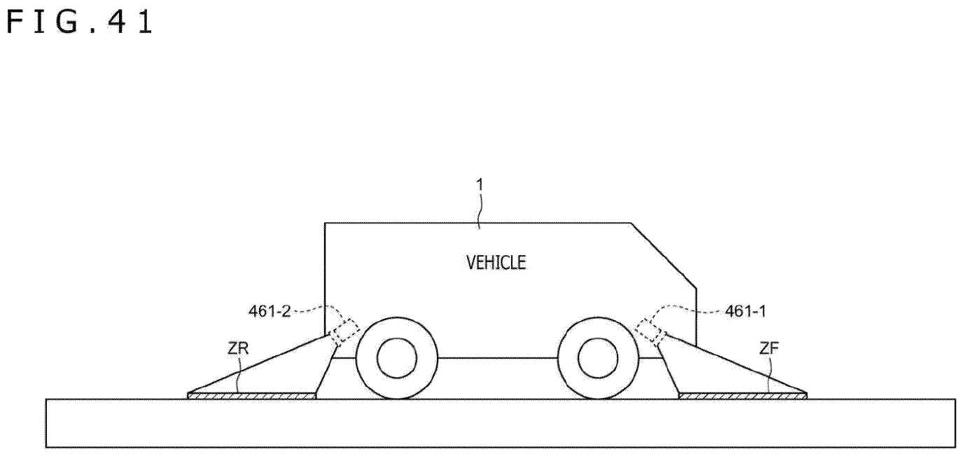

For example, as depicted in FIG. 41, a LiDAR 461-1 may be provided at the front of a vehicle 481, and roughness information regarding an area ZF that is about to be traveled may be acquired by acquiring point cloud information regarding the area ZF. A LIDAR 461-2 may be provided at the rear of the vehicle 481 so as to be able to acquire point cloud information regarding an area ZR that is about to be traveled in backward driving, and roughness information regarding the area ZR may be acquired. The operation control section 423″ may upload the roughness information regarding the areas ZF and ZR or the like along with positional information, for example.

In addition, the operation control section 423″ may compare a drive signal of the actuator 312 with a current value sensed by the electric-current sensor 462, and can detect an abnormality in the actuator caused by a disconnection or the like in a case where the drive signal and the current value do not match. Accordingly, the operation control section 423″ may also upload the actuator abnormality detection information together.

In the cloud server 472, on the basis of these pieces of information, optimum NC filtering processing sections 332 are registered according to noise that is expected according to respective positions, traveling conditions, and the like. Therefore, it becomes possible for the operation control section 423″ in the vehicle 1 used by a typical user to select an optimum NC filtering processing section 332 on the basis of positional information and traveling conditions of the vehicle 1.

### 18. Third Embodiment

### <Combination of FF-Scheme NC Apparatus and FB-Scheme NC Apparatus>

The FF-scheme NC apparatus has been explained as the first embodiment, and the FB-scheme NC apparatus has been explained as the second embodiment thus far.

However, more appropriate noise reduction can be realized by combining these two.

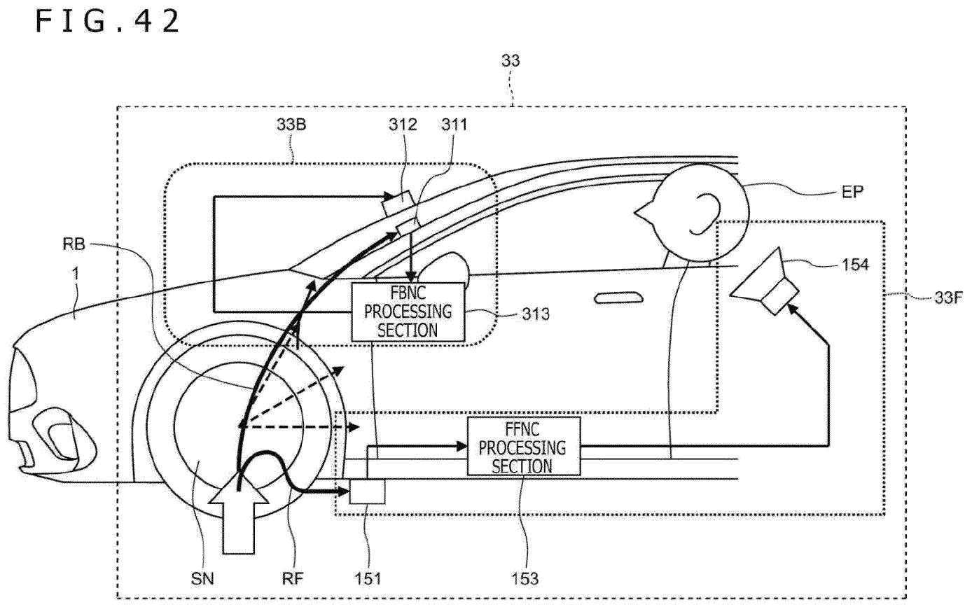

FIG. 42 depicts a configuration example of the NC apparatus 33 realized by configuring a feedback-scheme NC apparatus 33B and a feedforward-scheme NC apparatus 33F in combination in the vehicle 1.

Here, the FB-scheme NC apparatus 33B includes a sensor 311, an actuator 312 (which may be any of 312A to 312F), and an FBNC processing section 313. Note that the FBNC processing section 313 is a component corresponding to the NC processing section 313, but is hereinbelow referred to as the FBNC processing section 313 in order to make it easier to recognize that it belongs to the FB-scheme NC apparatus 33.

In addition, the FF-scheme NC apparatus 33F includes a sensor 151, an FFNC processing section 153 (which may be 153′), and the speaker 154. Note that the FFNC processing section 153 is a component corresponding to the NC processing section 153, but is hereinbelow referred to as the FFNC processing section 153 in order to make it easier to recognize that it belongs to the FF-scheme NC apparatus 33F.

By the NC apparatus 33 combining the FB-scheme NC apparatus 33B and the FF-scheme NC apparatus 33F in the vehicle 1 as depicted in FIG. 42 as mentioned above, it becomes possible to appropriately reduce both noise that can only be reduced by the FB-scheme NC apparatus 33B and noise that can only be reduced by the FF-scheme NC apparatus 33F.

Note that, hereinbelow, the following explanation presumes that the FF-scheme NC apparatus 33F mentioned thus far is any of the configurations according to the first embodiment mentioned above, and the FB-scheme NC apparatus 33B is any of the configurations according to the second embodiment mentioned above.

However, the FF-scheme NC apparatus 33F and the FB-scheme NC apparatus 33B do not necessarily need to have configurations identical to configurations in the first embodiment and the second embodiment, and may be a typical FF-scheme NC apparatus or FB-scheme NC apparatus. For example, the vehicle interior microphone 152 is not essential in the configuration of the FF-scheme NC apparatus, and, in another possible configuration, a feedback-scheme NC process may be realized only using sensor signals of other sensors 151.

### <Application Example of Combination of FF-Scheme NC Apparatus and FB-Scheme NC Apparatus>

Meanwhile, a sudden sound that occurs when crossing a bump has a large amplitude and is non-steady noise, and it can be said that it is noise desired to be reduced appropriately by the NC apparatus 33.

However, since the NC processing section 313 implements the NC process after a sudden sound is input to the sensor 311 in the FB-scheme NC apparatus 33, even if a protective function such as muting is provided, there is a possibility that the process is not performed in time and an abnormal sound occurs. That is, there is a fear that the FB-scheme NC apparatus 33F alone not only is unable to appropriately reduce noise including a sudden sound when it occurs, but also generates an unpleasant abnormal sound.

Since the FB-scheme NC apparatus 33B does not include a mechanism that acquires, in advance, a sudden sound which is the cause of an abnormal sound, it is difficult to take a countermeasure against the occurrence of an abnormal sound.

In view of this, the NC process may be appropriately realized in the FB-scheme NC apparatus 33B against noise including a sudden sound by applying the configuration including the combination of the FF-scheme NC apparatus 33F and the FB-scheme NC apparatus 33B.

### <Transmission of Sudden Sound>

As depicted in FIG. 42, in a case where a sudden sound occurs when a tire crosses a bump, the portion of the tire where the tire contacts the bump is a vibration source SN of the sudden sound. In a case where the vibration source SN is the tire, paying attention to a vibration propagation path RB from the vibration source SN to the sensor 311 of the FB-scheme NC apparatus 33B and a vibration propagation path RF from the vibration source SN to the sensor 151 of the FF-scheme NC apparatus 33F, it is obvious that the vibration propagation path RF is shorter than the vibration propagation path RB.

This is because the sensor 151 of the FF-scheme NC apparatus 33F is installed closer to the tire which is the vibration source SN of road noise. Since the vibration source SN of the input of the bump-originated sudden sound is also close to the tire as with the road noise, the vibration transmission path RF to the sensor 151 of the FF-scheme NC apparatus F is shorter than the vibration transmission path RB to the sensor 311 of the FB-scheme NC apparatus 33B.

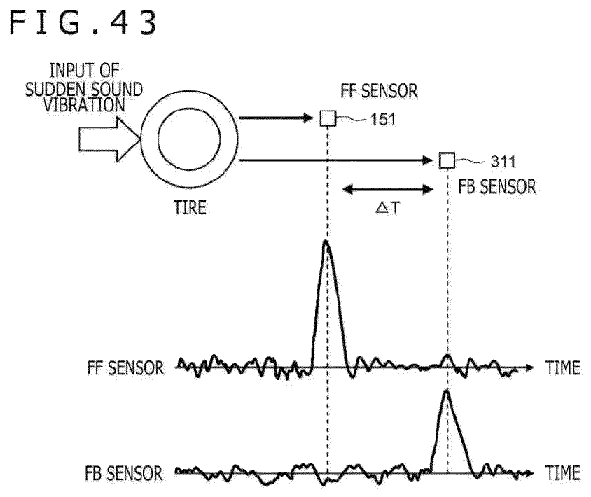

Accordingly, as depicted in FIG. 43, the sudden sound transmitted from the vibration source is transmitted to the sensor 151 of the FF-scheme NC apparatus 33F ahead of the sensor 311 of the FB-scheme NC apparatus 33B by a predetermined length of time AT according to the difference between the vibration transmission paths.

Note that a top portion in FIG. 43 depicts a manner where vibrations of the sudden sound from the tire is transmitted to the FB sensor 311 and the FF sensor 151 via the respective vibration transmission paths. In addition, a middle portion depicts time elapsed since the occurrence of the sudden sound and a waveform of sensing values at the sensor 151 (FF sensor) of the feedforward-scheme NC apparatus 33F. Further, a lower portion depicts time elapsed since the occurrence of the sudden sound and a waveform of sensing values at the sensor 151 (FB sensor) of the feedback-scheme NC apparatus 33B.

As depicted in FIG. 43, the timing when the sudden sound is sensed at the sensor 151 (FF sensor) is earlier than the timing when the sudden sound is sensed at the sensor 311 (FB sensor) by the predetermined length of time AT corresponding to the difference between the vibration propagation paths RF and RB.

That is, by use of information obtained through sensing by the sensor 151 (FF sensor) that can sense the sudden sound at the timing earlier than the sensor 311 of the FB-scheme NC apparatus 33B, it becomes possible for the FB-scheme NC apparatus 33B to avoid the occurrence of an abnormal sound by muting the level of output to the actuator 312 in the predetermined length of time AT before the sudden sound reaches the sensor 311 (FB sensor).

Stated differently, by using, at the FF-scheme NC apparatus 33F, a sensing signal of the sensor 151 (FF sensor) installed for collecting road noise, and further using the sensing signal also at the FB-scheme NC apparatus 33B, it becomes possible to acquire a sudden sound also at the FB-scheme NC apparatus 33B in advance, and it becomes possible to suppress the occurrence of an abnormal sound that would undesirably be generated by the sudden sound.

<Configuration Example of NC Apparatus That Takes Countermeasure against Sudden Sound in FB-Scheme NC Apparatus>

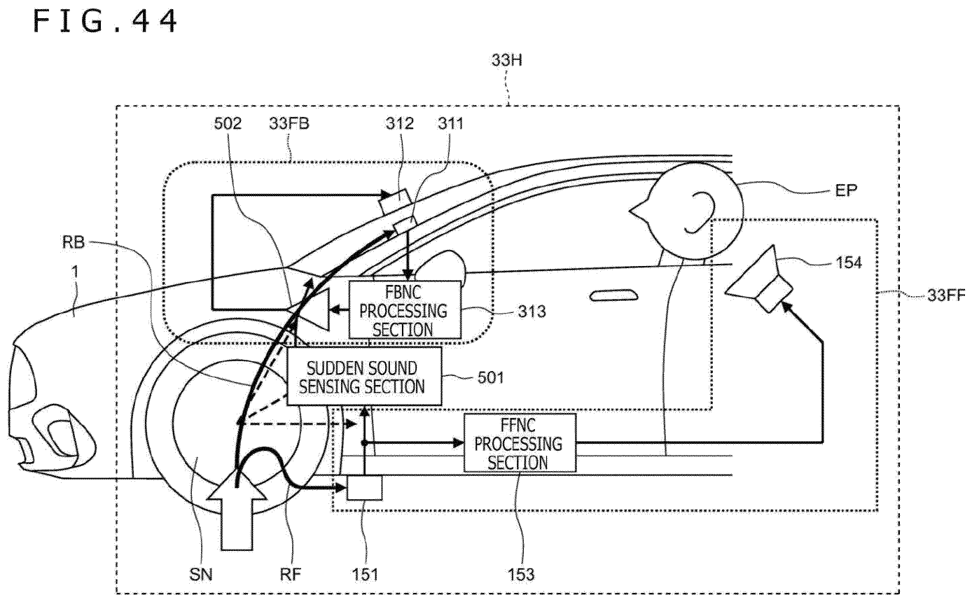

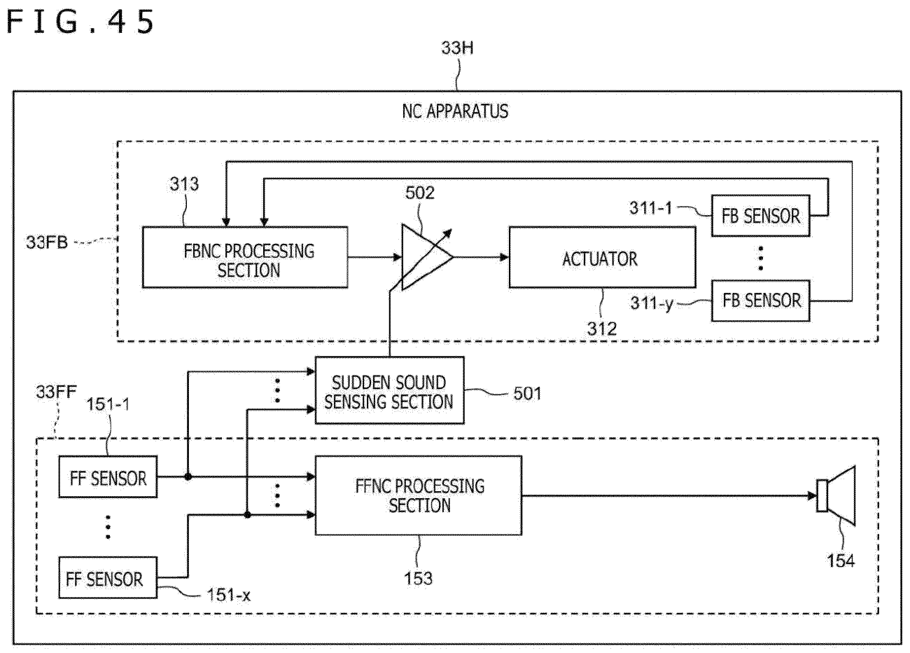

Next, a configuration example of the NC apparatus that takes a countermeasure against a sudden sound in the FB-scheme NC apparatus and can realize the appropriate NC process by applying a configuration combining the FF-scheme NC apparatus and the FB-scheme NC apparatus is explained with reference to FIG. 44 and FIG. 45.

Note that components in an NC apparatus 33H in FIG. 44 that have functions identical to the functions of the NC apparatus 33 in FIG. 42 are given identical reference signs, and explanations thereof are omitted as appropriate. In addition, FIG. 44 is an image view of the NC apparatus 33H that is mounted on the vehicle 1 and includes a configuration combining the FF-scheme NC apparatus and the FB-scheme NC apparatus, and FIG. 45 is a block diagram of the NC apparatus 33H.

In FIG. 45, a sensor 151 of an FF-scheme NC apparatus 33FF is indicated as an FF sensor 151, and this similarly applies to the description hereinbelow. In addition, a sensor 311 of a feedback-scheme NC apparatus 33FB is indicated as an FB sensor 311, and this similarly applies to the description hereinbelow.

The NC apparatus 33H in FIG. 44 is different from the NC apparatus 33 in FIG. 42 in that, instead of the configuration combining the FF-scheme NC apparatus 33F and the FB-scheme NC apparatus 33B, the NC apparatus 33H has a configuration combining the FF-scheme NC apparatus 33FF and the FB-scheme NC apparatus 33FB and further includes a sudden sound sensing section 501.

In addition, the FB-scheme NC apparatus 33FB is different from the FB-scheme NC apparatus 33B in that, in addition to the sensor 311, the actuator 312, and the FBNC processing section 313, a volume adjusting section 502 that is controlled by the sudden sound sensing section 501 and adjusts a volume of a drive signal of the actuator output by the FBNC processing section 313 is provided.

Note that the basic configuration of the FF-scheme NC apparatus 33FF is identical to the basic configuration of the FF-scheme NC apparatus 33F, but a sensor signal of the FF sensor 151 is output not only to the FFNC processing section 153 but also to the sudden sound sensing section 501.

When the sudden sound sensing section 501 senses the occurrence of a sudden sound on the basis of a sensor signal of the FF sensor 151, for a predetermined period, the sudden sound sensing section 501 controls the volume adjusting section 502 in the NC apparatus 33FB to reduce the volume to a level close to the muted level and suppress noise generated due to the sudden sound.

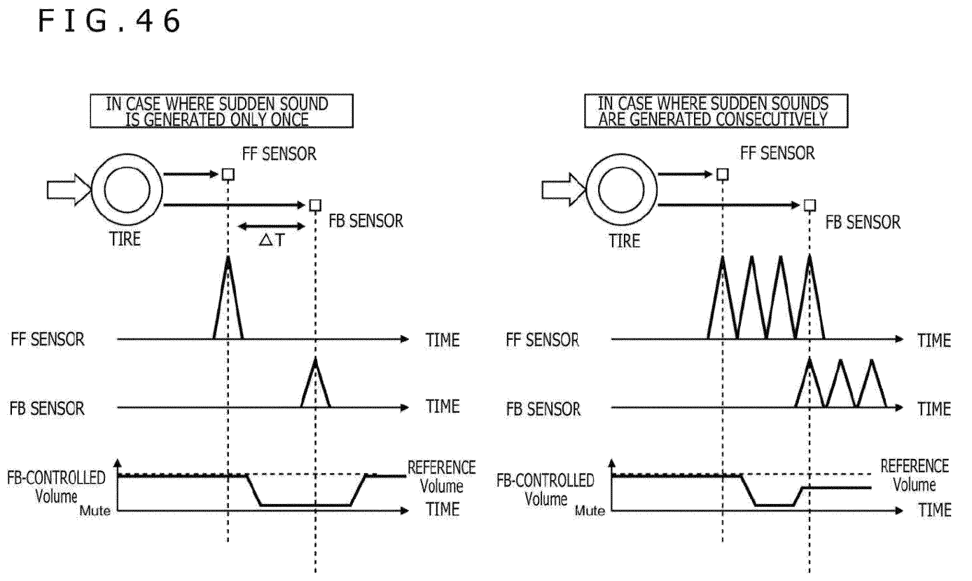

More specifically, in a case where a sudden sound occurs only once (or the frequency of occurrence is low), as depicted in a left portion in FIG. 46, the sudden sound sensing section 501 controls the volume adjusting section 502 for a predetermined period including the timing when the sudden sound is sensed at the FF sensor 151 and the timing when the predetermined length of time AT has elapsed and the sudden sound is sensed by the FB sensor 311, to thereby reduce the volume of a drive signal to the actuator 312 to the muted level (or to a level close to the muted level).

Thus, even if a sudden sound is sensed by the FB sensor 311, the FB-scheme NC apparatus 33FB suppresses the occurrence of an abnormal sound since the operation performed by the actuator 312 is substantially muted.

In addition, there can be a case where there are periodically appearing bumps depending on the road surface condition. In such a case, if the muting process is performed as long as sudden sounds are sensed consecutively, the NC process is stopped even in a zone where a sudden sound is not occurring, and accordingly, there is a possibility that noise is continuously perceived undesirably.

In view of this, as depicted in a right portion in FIG. 46, in a case where sudden sounds occur consecutively, the volume is reduced to the muted level (or a level close to the muted level) until the timing when a sudden sound is sensed by the FB sensor 311, and thereafter, for example, the volume is increased to substantially half a reference value. By doing so, it becomes possible for the feedback-scheme NC apparatus 33FB to continue the NC process while suppressing, as much as possible, abnormal sounds that are generated by the operation performed by the actuator 312, even if a sudden sound is sensed by the FB sensor 311.

Note that waveforms in upper rows and middle rows in FIG. 46 are waveforms representing time-series changes in sensing level when sudden sounds are sensed by the FF sensor 151 and the FB sensor 311, respectively. In addition, waveforms in lower rows represent changes in volume of drive signals of the actuator 312 adjusted by the volume adjusting section 502 at timings corresponding to the waveforms in the upper rows and the middle rows.

### <Sudden Sound Countermeasure Process Performed by NC Processing Section in FIG. 45>

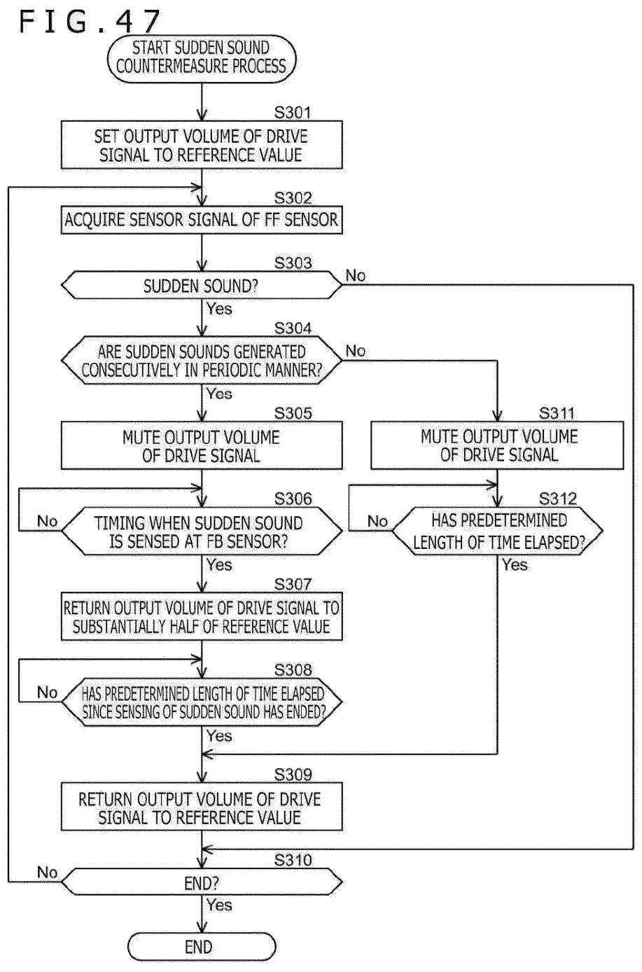

Next, a sudden sound countermeasure process performed by the NC apparatus 33H in FIG. 45 is explained with reference to a flowchart in FIG. 47. Note that the NC apparatuses 33FB and 33FF are executing the respective NC processes mentioned above.

At Step S301, the sudden sound sensing section 501 controls the volume adjusting section 502 to set the volume of a drive signal of the actuator output by the FBNC processing section 313 to a reference value.

At Step S302, the sudden sound sensing section 501 acquires a sensor signal from the FF sensor 151.

At Step S303, the sudden sound sensing section 501 determines whether or not a sudden sound is occurring, on the basis of the sensor signal from the FF sensor 151. In a case where it is determined at Step S303 that a sudden sound is occurring, the process proceeds to Step S304.

At Step S304, the sudden sound sensing section 501 determines whether or not sudden sounds are occurring consecutively in a periodic manner, on the basis of the sensor signal.

In a case where it is determined at Step S304 that sudden sounds are occurring consecutively in a periodic manner, the process proceeds to Step S305.

At Step S305, the sudden sound sensing section 501 controls the volume adjusting section 502 to reduce the volume of the drive signal of the actuator 312 output by the FBNC processing section 313 to a level close to the muted level.

At Step S306, on the basis of the time elapsed since the timing when the FF sensor 151 senses the sudden sound, the sudden sound sensing section 501 determines whether or not the timing for the FB sensor 311 to sense the sudden sound has come, and repeats a similar process until the timing comes.

In a case where it is determined at Step S306 that the timing for the FB sensor 311 to sense the sudden sound has come, the process proceeds to Step S307.

At Step S307, the sudden sound sensing section 501 controls the volume adjusting section 502 to set the volume of the drive signal of the actuator 312 output by the FBNC processing section 313 to substantially half the reference value.

At Step S308, the sudden sound sensing section 501 determines whether or not the sensing of the sudden sound by the FF sensor 151 has ended, the predetermined length of time has elapsed, and the timing for the FB sensor 311 to stop sensing the sudden sound has come, and repeats a similar process until the sensing of the sudden sound by the FF sensor 151 ends and the predetermined length of time elapses.

Then, in a case where it is determined at Step S308 that the sensing of the sudden sound by the FF sensor 151 has ended and the predetermined length of time has elapsed, the process proceeds to Step S309.

At Step S309, the sudden sound sensing section 501 controls the volume adjusting section 502 to return the volume of the drive signal of the actuator 312 output by the FBNC processing section 313 to the reference value.

Meanwhile, in a case where it is determined at Step S304 that sudden sounds are not occurring consecutively in a periodic manner, the process proceeds to Step S311.

At Step S311, the sudden sound sensing section 501 controls the volume adjusting section 502 to reduce the volume of the drive signal of the actuator 312 output by the FBNC processing section 313 to a level close to the muted level.

At Step S312, the sudden sound sensing section 501 determines whether or not a predetermined length of time which is longer than a length of time from the timing for the FF sensor 151 to sense the sudden sound until the timing for the FB sensor 311 to sense the sudden sound has elapsed, and repeats a similar process until the sensing of the sudden sound by the FF sensor 151 ends and the predetermined length of time elapses.

In a case where it is determined at Step S312 that the predetermined length of time which is longer than the length of time from the timing for the FF sensor 151 to sense the sudden sound until the timing for the FB sensor 311 to sense the sudden sound has elapsed, the process proceeds to Step S309.

Note that, in a case where it is determined at Step S303 that a sudden sound is not occurring, the processes at Steps S304 to S309, S311, and S312 are skipped.

At Step S313, the sudden sound sensing section 501 determines whether or not the process has been instructed to end, and, in a case where the process has not been instructed to end, the process returns to Step S301, and the subsequent process is repeated.

Then, in a case where the process is instructed to end at Step S313, the process ends.

By the process mentioned above, if single occurrence of a sudden sound is sensed by the FF sensor 151, the drive signal of the actuator 312 is reduced to a state close to the muted state until a predetermined length of time including the timing when the sudden sound is sensed by the FB sensor 311 elapses. Accordingly, it becomes possible to suppress the occurrence of an abnormal sound due to the sudden sound.

In addition, if sudden sounds that occur consecutively in a periodic manner are sensed by the FF sensor 151, the drive signal of the actuator 312 is reduced to a state close to the muted state until the timing for the FB sensor 311 to sense the sudden sounds, and thereafter, the drive signal is reduced to substantially half the reference value until the timing when the sensing of the sudden sounds has ended and sudden sounds are not sensed by the FB sensor 311. Accordingly, it becomes possible to continue the NC process while minimizing the effect on an abnormal sound caused by sudden sounds.

### 19. First Modification Example of Third Embodiment

In the example explained thus far, when a sudden sound is sensed, by reducing the volume of a drive signal output to the actuator 312 by the FBNC processing section 313 for a predetermined period, the occurrence of an abnormal sound caused by the sudden sound is suppressed.

However, in reducing the volume of the drive signal, a band-stop filter suited for the waveform of a sudden sound sensed by the FF sensor 151 may be selectively used to reduce the volume.

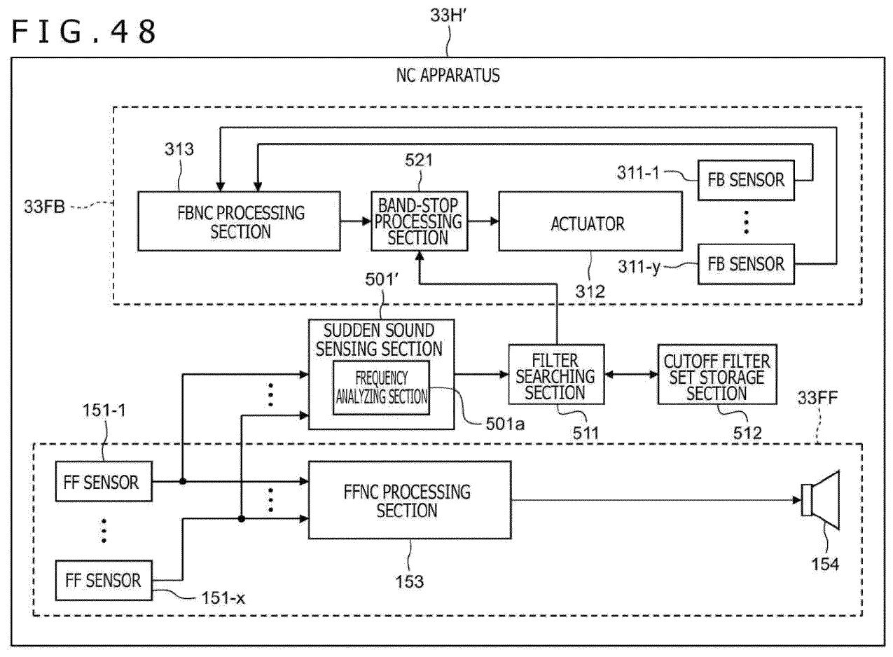

FIG. 48 depicts a configuration example of an NC processing section 33H′ that selectively uses a band-stop filter suited for the waveform of a sudden sound sensed by the FF sensor 151, to reduce the volume of a drive signal.

Components in the configuration of the NC processing section 33H′ in FIG. 48 that have functions identical to the functions of components of the NC processing section 33H in FIG. 44 are given identical reference signs, and explanations thereof are omitted as appropriate.

The NC processing section 33H′ in FIG. 48 is different from the NC processing section 33H in FIG. 44 in that a sudden sound sensing section 501′, a filter searching section 511, a cutoff filter set storage section 512, and a band-stop processing section 521 are provided instead of the sudden sound sensing section 501 and the volume adjusting section 502.

The basic functions of the sudden sound sensing section 501′ are similar to the basic functions of the sudden sound sensing section 501, but the sudden sound sensing section 501′ includes a frequency analyzing section 501a, and, upon sensing of a sudden sound, controls the frequency analyzing section 501a to perform a frequency analysis of the waveform of the sudden sound, and outputs an analysis result to the filter searching section 511.

The filter searching section 511 accesses the cutoff filter set storage section 512 having stored thereon cutoff filters corresponding to various bandwidth characteristics, searches for a cutoff filter having corresponding bandwidth characteristics on the basis of the analysis result, and supplies the cutoff filter to the band-stop processing section 521 of the NC apparatus 33FB.

The band-stop processing section 521 implements a band-stop process using the cutoff filter supplied from the filter searching section 511 on the drive signal output to the actuator 312 by the FBNC processing section 313, and outputs the drive signal.

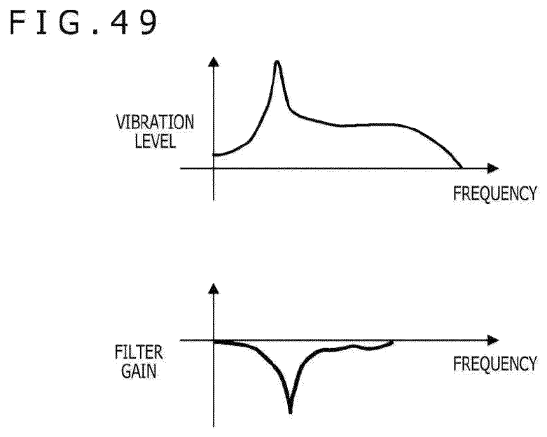

Considered here is a case where, for example, a frequency analysis result of the waveform of a sudden sound supplied from the FF sensor 151 has characteristics represented by a waveform with vibration levels like the one depicted in an upper portion in FIG. 49.

In this case, the filter searching section 511 searches the cutoff filter set storage section 512 for a cutoff filter that achieves a filter gain having bandwidth characteristics like the one depicted in a lower portion in FIG. 49, for example, such that the bandwidth characteristics represented by the waveform like the one depicted in the upper portion in FIG. 49 are canceled, and supplies the cutoff filter to the band-stop processing section 521.

### <Sudden Sound Countermeasure Process Performed by NC Processing Section in FIG. 48>

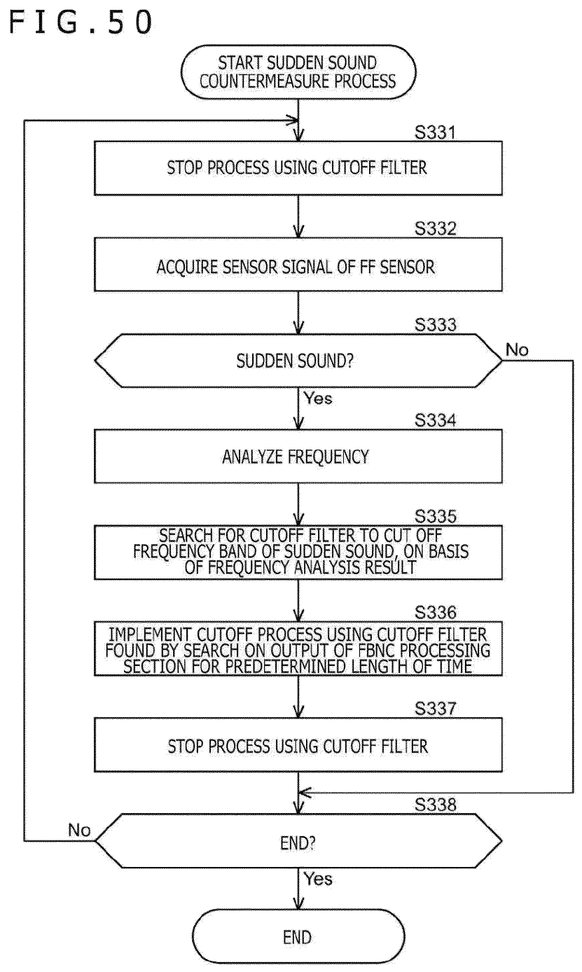

Next, a sudden sound countermeasure process performed by the NC processing section 33H′ in FIG. 48 is explained with reference to a flowchart in FIG. 50.

At Step S331, the filter searching section 511 controls the band-stop processing section 521 and causes it to stop a process using a cutoff filter, and sets the volume of a drive signal of the actuator output by the FBNC processing section 313 to a reference value.

At Step S332, the sudden sound sensing section 501′ acquires a sensor signal from the FF sensor 151.

At Step S333, the sudden sound sensing section 501′ determines whether or not a sudden sound is occurring, on the basis of the sensor signal from the FF sensor 151. In a case where it is determined at Step S333 that a sudden sound is occurring, the process proceeds to Step S334.

At Step S334, the sudden sound sensing section 501′ controls the frequency analyzing section 501a and causes it to perform a frequency analysis of a waveform representing the sudden sound, and outputs an analysis result to the filter searching section 511.

At Step S335, the filter searching section 511 accesses the cutoff filter set storage section 512, searches for a cutoff filter having corresponding bandwidth characteristics on the basis of the analysis result, and supplies the cutoff filter to the band-stop processing section 521 of the NC apparatus 33FB.

At Step S336, the band-stop processing section 521 implements a band-stop process using the cutoff filter supplied from the filter searching section 511, on the drive signal output to the actuator 312 by the FBNC processing section 313 for a predetermined length of time, and outputs the drive signal to the actuator 312.

At Step S337, the band-stop processing section 521 stops the band-stop process and sets the volume of the drive signal of the actuator output by the FBNC processing section 313 to a reference value.

Meanwhile, in a case where it is determined at Step S333 that a sudden sound is not occurring, the processes at Steps S334 to S337 are skipped.

At Step S338, the sudden sound sensing section 501′ determines whether or not the process has been instructed to end, and, in a case where the process has not been instructed to end, the process returns to Step S331, and the subsequent process is repeated.

Then, in a case where the process is instructed to end at Step S338, the process ends.

By the process mentioned above, when a sudden sound is sensed by the FF sensor 151, frequency characteristics of the waveform of the sudden sound are analyzed, a band-stop process is performed using a corresponding band-stop filter on a drive signal output to the actuator 312 by the FBNC processing section 313, and it becomes possible to suppress the occurrence of an abnormal sound caused by the sudden sound.

### 20. Second Modification Example of Third Embodiment

In the example explained thus far, when a sudden sound is sensed, by performing a frequency analysis, selecting a corresponding band-stop filter, and performing a band-stop filtering process on a drive signal output to the actuator 312 by the FBNC processing section 313 for a predetermined period, the volume is reduced only at the timing when a sudden sound occurs, and the occurrence of an abnormal sound caused by the sudden sound is suppressed.

However, when a process using a band-stop filter is performed, if a corresponding band-stop filter is searched for, read out, and supplied to the band-stop processing section 521 to perform a band-stop process after a frequency analysis has been performed, it takes time for the process undesirably, the process is delayed, and there is a fear that the appropriate NC process cannot be realized.

In view of this, a drive signal may be output selectively on the basis of a frequency analysis result after parallel processing has been implemented using band-stop filters having a plurality of bandwidth characteristics.

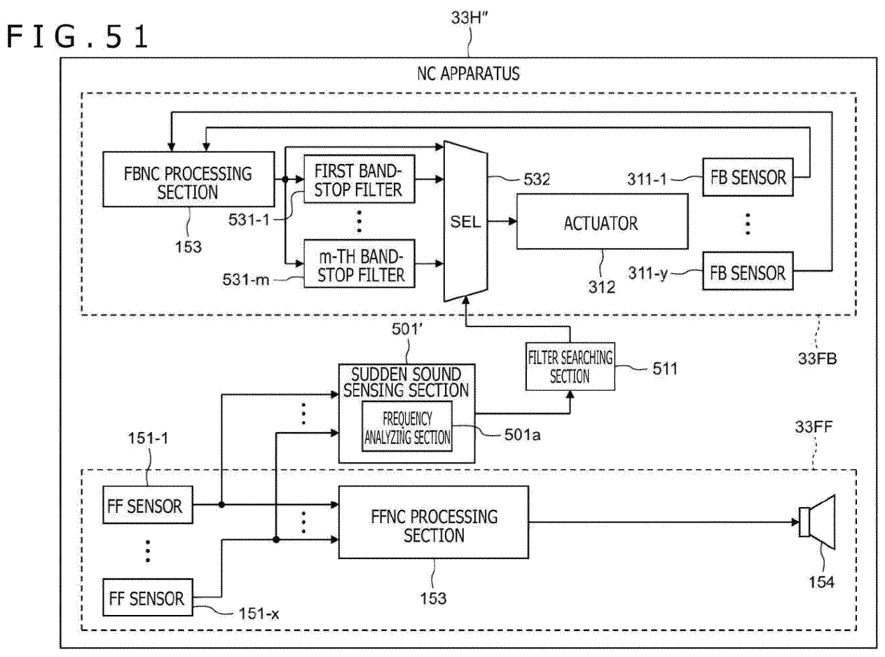

FIG. 51 depicts a configuration example of an NC processing section 33H″ that selectively outputs a drive signal on the basis of a frequency analysis result after parallel processing has been implemented using band-stop filters having a plurality of bandwidth characteristics.

Components in the configuration of the NC processing section 33H″ in FIG. 51 that have functions identical to the functions of components of the NC processing section 33H′ in FIG. 48 are given identical reference signs, and explanations thereof are omitted as appropriate.

The NC processing section 33H″ in FIG. 51 is different from the NC processing section 33H′ in FIG. 48 in that the cutoff filter set storage section 512 and the band-stop processing section 521 are deleted and a first band-stop filter 531-1 to an m-th band-stop filter 531-m and a selecting section (SEL) 532 are provided.

The first band-stop filter 531-1 to the m-th band-stop filter 531-m are band-stop filters that have been stored on the cutoff filter set storage section 512 and have various types of bandwidth characteristics, and implement respective band-stop filtering processes on a drive signal output to the actuator 312 by the FBNC processing section 313, and output the resultant drive signals to the selecting section 532. Note that a drive signal having not undergone a process using a band-stop filter is also supplied to the selecting section 532.

The selecting section 532 is controlled by the filter searching section 511 and outputs, to the actuator 312, a drive signal having undergone a band-stop filtering process having corresponding bandwidth characteristics, on the basis of the frequency analysis result, among the drive signals having undergone the filtering processes using the first band-stop filter 531-1 to the m-th band-stop filter 531-m.

Note that, in a case where it is aimed to achieve a short delay, when performing switching among the band-stop filters 531, the selecting section 532 may switch filter paths by switching, and also may switch from the current filter path to the next filter path by crossfading.

With such a configuration, drive signals having undergone band-stop filtering processes having bandwidth characteristics can be selected by switching and output to the actuator 312 immediately, without the band-stop filters being loaded, on the basis of the frequency analysis result. As a result, the processing speed can be enhanced, and it becomes possible to suppress failures of the NC process that would be caused by delays.

### <Sudden Sound Countermeasure Process Performed by NC Processing Section in FIG. 51>

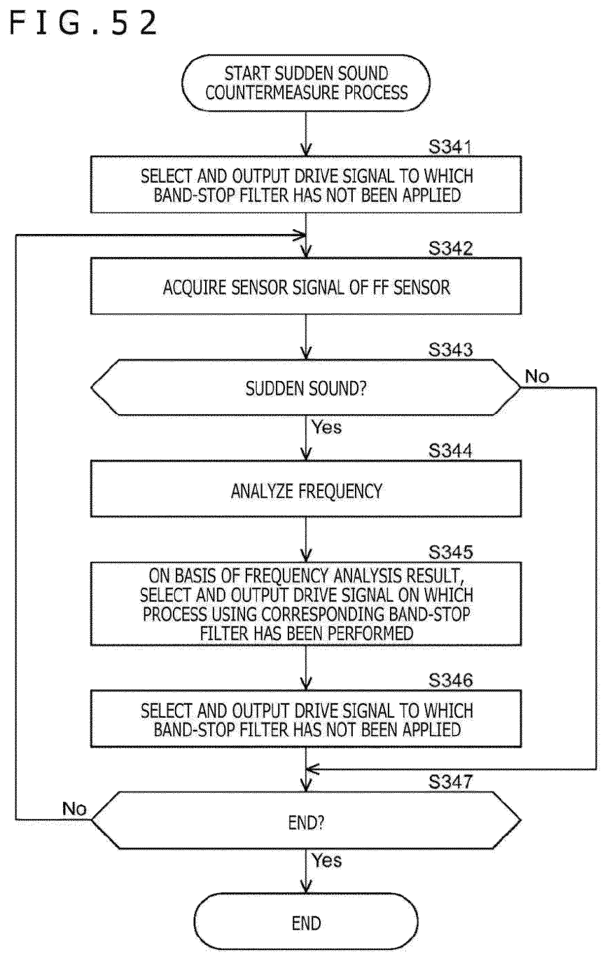

Next, a sudden sound countermeasure process performed by the NC processing section 33H′ in FIG. 51 is explained with reference to a flowchart in FIG. 52.

At Step S341, the sudden sound sensing section 501′ controls the selecting section 532 to select a drive signal having not undergone a process using a band-stop filter and cause the drive signal to be output to the actuator 312. Note that, meanwhile, the first band-stop filter 531-1 to the m-th band-stop filter 531-m keep implementing band-stop filtering processes on the drive signals with their respective bandwidth characteristics and outputting the resultant drive signals to the selecting section 532.

At Step S342, the sudden sound sensing section 501′ acquires a sensor signal from the FF sensor 151.

At Step S343, the sudden sound sensing section 501′ determines whether or not a sudden sound is occurring, on the basis of the sensor signal from the FF sensor 151. In a case where it is determined at Step S343 that a sudden sound is occurring, the process proceeds to Step S344.

At Step S344, the sudden sound sensing section 501′ controls the frequency analyzing section 501a and causes it to perform a frequency analysis of a waveform representing the sudden sound, and outputs an analysis result to the filter searching section 511.

At Step S345, the filter searching section 511 controls the selecting section 532 on the basis of the frequency analysis result to select a drive signal having undergone a band-stop filtering process corresponding to the frequency analysis result from among drive signals on which band-stop filtering processes have been implemented using the first band-stop filter 531-1 to the m-th band-stop filter 531-m for a predetermined length of time, and causes the drive signal to be output to the actuator 312.

At Step S346, the selecting section 532 selects a drive signal having not undergone a process using a band-stop filter and causes the drive signal to be output to the actuator 312.

At Step S347, the sudden sound sensing section 501′ determines whether or not the process has been instructed to end, and, in a case where the process has not been instructed to end, the process returns to Step S342, and the subsequent process is repeated.

Then, in a case where the process is instructed to end at Step S347, the process ends.

By the process mentioned above, a drive signal having undergone a band-stop filtering process having bandwidth characteristics can be output selectively to the actuator 312 immediately on the basis of a frequency analysis result, and accordingly, it becomes unnecessary to re-load a band-stop filter with different bandwidth characteristics on the basis of the frequency analysis result. As a result, the speed of a sudden sound countermeasure process can be enhanced, and it becomes possible to suppress failures of the NC process that would be caused by delays.

### 21. Third Modification Example of Third Embodiment

While whether or not there is a sudden sound is determined on the basis of a sensor signal from the FF sensor 151 in the example explained thus far, a sudden sound may be sensed using a sensor other than the FF sensor 151.

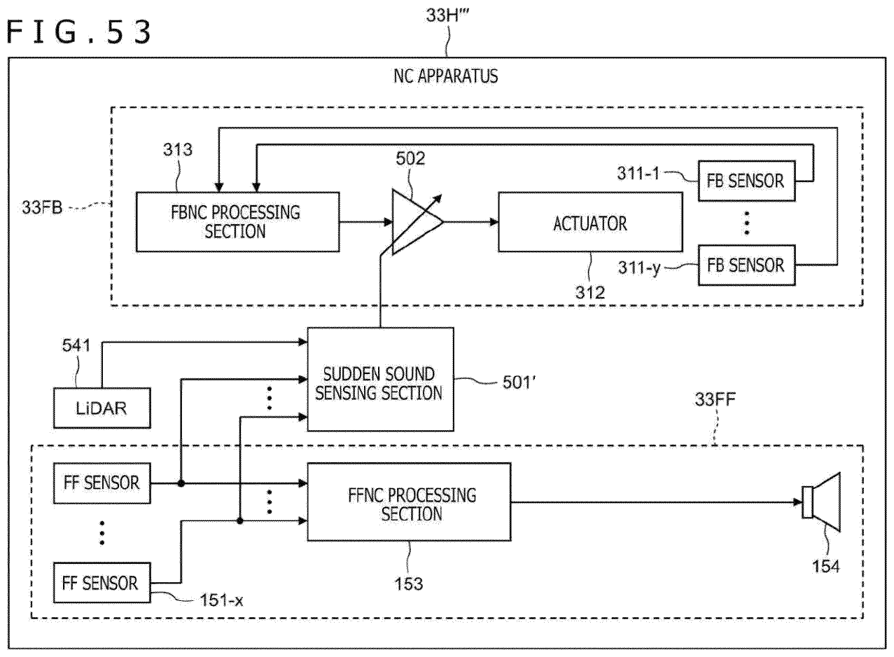

FIG. 53 depicts a configuration example of an NC apparatus 33H′″ that senses roughness of a road surface being traveled on the basis of point cloud information sensed by a LiDAR 541 that senses the road surface in addition to sensor signals from the FF sensors 151 output to the sudden sound sensing section 501, and determines whether or not there is a sudden sound on the basis of the sensed roughness of the road surface.

In this manner, in a case where a sudden sound is sensed on the basis of the 3D point cloud sensed by the LiDAR 541, whether or not there is a sudden sound can be determined early as compared with the case where changes in the road surface condition are sensed using only an acceleration sensor.

In addition, in a case where it is recognized that a sudden sound is sensed from the roughness condition of a road surface sensed by the LiDAR 541, a combined process like one in which the volume of a drive signal is muted in advance and a band-stop filter is thereafter selected on the basis of a subsequent sensor signal of the FF sensor 151 may be implemented.

Note that the sudden sound countermeasure process performed when a sudden sound is sensed using the LiDAR 541 is the process explained with reference to the flowchart in FIG. 47, the process for selecting a band-stop filter on the basis of a sensor signal of the FF sensor 151 is the process explained with reference to the flowchart in FIG. 50, and accordingly, explanations thereof are omitted.

### 22. Fourth Modification Example of Third Embodiment

While a sensor signal of the FF sensor 151 is used in the feedforward-scheme NC processing section 33FF in the example explained thus far, the NC process performed by the FF-scheme NC processing section 33FF may be executed using a sensor signal of the FB sensor 311.

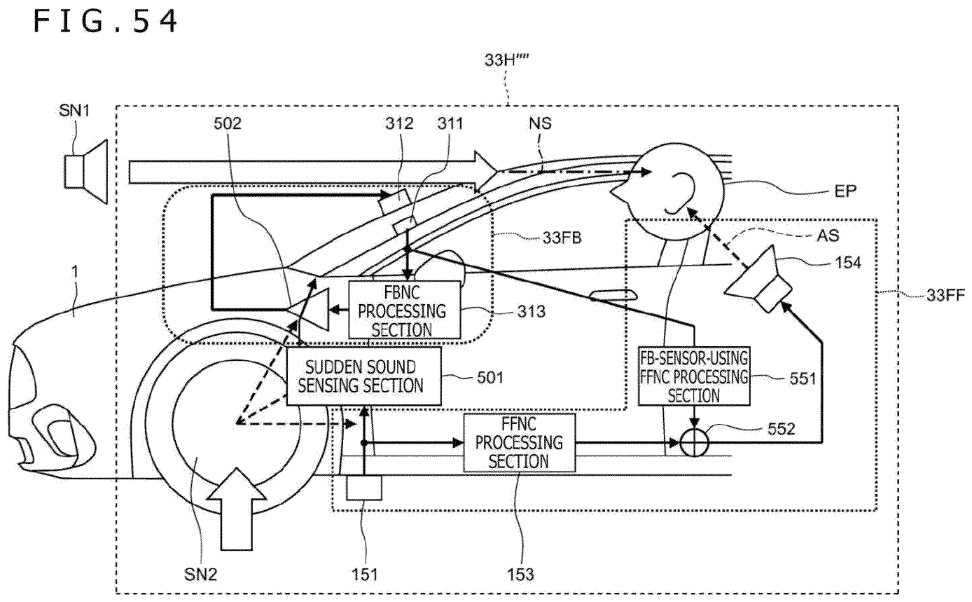

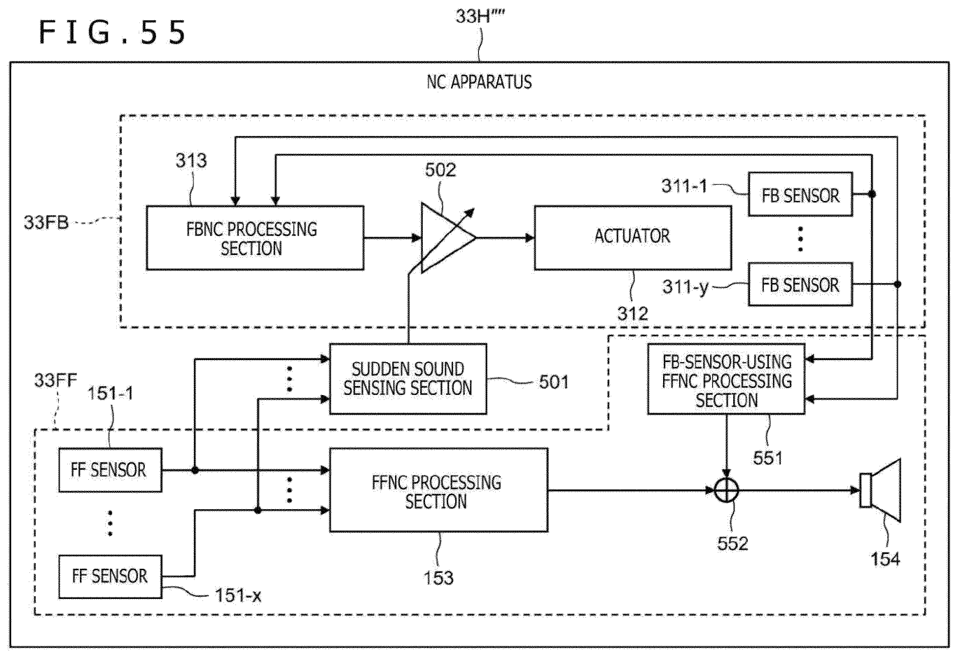

FIG. 54 and FIG. 55 depict a configuration example of an NC apparatus 33H″″ in which the NC process performed by the FF-scheme NC processing section 33FF is executed using a sensor signal of the FB sensor 311.

The NC apparatus 33H″″ in FIG. 54 and FIG. 55 is different from the NC apparatus 33H in FIG. 44 and FIG. 45 in that the NC apparatus 33FF is additionally provided with an FB-sensor-using FFNC processing section 551 and an adder 552.

The FB-sensor-using FFNC processing section 551 basically has functions identical to the functions of the FFNC processing section 153, but is different from the FFNC processing section 153 in that the FB-sensor-using FFNC processing section 551 uses not a sensor signal of the FF sensor 151 but a sensor signal of the FB sensor 311 in the NC process.

For example, as depicted in FIG. 54, noise NS emitted from the front window FW and represented by a dash-dotted line can be predicted to arrive at the control point EP through acoustic spatial propagation. That is, the FF-scheme NC processing section 33FF can realize the NC process by canceling the noise NS at the control point EP by use of the inverse phase sound AS of the noise NS by the NC process performed by the FF-scheme NC processing section 33FF on the basis of a sensor signal of the FB sensor 311 in a case where a propagation distance from the speaker 154 that emits the inverse phase sound AS to the control point EP is shorter than a propagation distance of the noise NS emitted from the front window FW.

In view of this, the FB-sensor-using FFNC processing section 551 generates an inverse phase sound using a sensor signal of the FB sensor 311 and outputs the inverse phase sound to the adder 552.

The adder 552 adds together the inverse phase sound generated on the basis of the sensor signal of the FF sensor 151 by the FFNC processing section 153 and the inverse phase sound generated using the sensor signal of the FB sensor 311 by the FB-sensor-using FFNC processing section 551, and causes the resultant inverse phase sound to be emitted from the speaker 154.

With such a configuration, it becomes possible for the FF-scheme NC apparatus 33FF to reduce both noise expected in advance and sensed by the FF sensor 151 and unknown noise sensed by the FB sensor 311.

### <NC Process Performed by FF-Scheme NC Apparatus in FIG. 55>

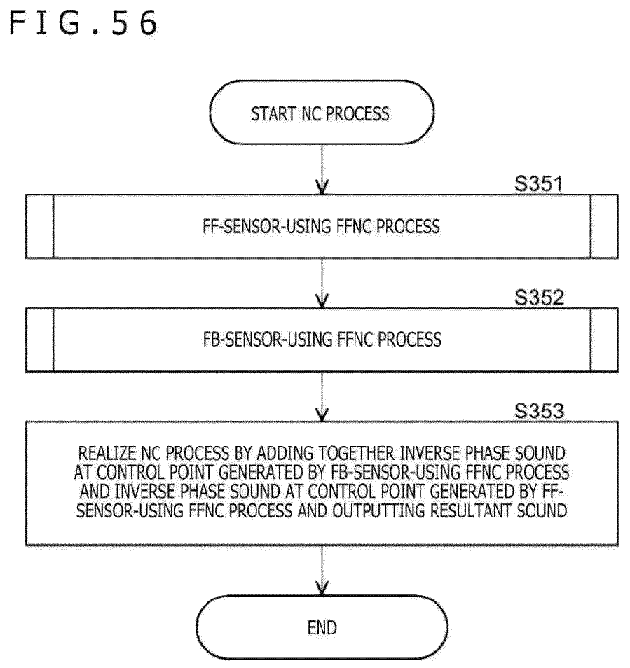

Next, the NC process performed by the FF-scheme NC apparatus 33FF in FIG. 55 is explained with reference to a flowchart in FIG. 56.

At Step S351, the FFNC processing section 153 executes an FF-sensor-using FFNC (feedforward noise cancellation) process, generates an inverse phase sound at the control point on the basis of a sensor signal of the FF sensor 151, and outputs the inverse phase sound to the adder 552. Note that, for example, the FF-sensor-using FFNC (feedforward noise cancellation) process is the NC process of each configuration in the first embodiment.

At Step S352, the FB-sensor-using FFNC processing section 551 executes an FB-sensor-using FFNC process, generates an inverse phase sound at the control point on the basis of a sensor signal of the FB sensor 311, and outputs the inverse phase sound to the adder 552. Note that, for example, the FB-sensor-using FFNC (feedforward noise cancellation) process is the NC process of each configuration in the first embodiment using a sensor signal of the FB sensor 311.

At Step S353, the adder 552 adds together the inverse phase sound at the control point generated by the FF-sensor-using FFNC process and the inverse phase sound at the control point generated by the FB-sensor-using FFNC process, and causes the speaker 154 to emit the resultant inverse phase sound toward the control point.

By the process mentioned above, it becomes possible for the FF-scheme NC apparatus 33FF to reduce both noise expected in advance and sensed by the sensor 151 and unknown noise sensed by the sensor 311.

### 23. Fifth Modification Example of Third Embodiment

While a sensor signal of the FB sensor 311 is used in the FB-scheme NC apparatus 33FB in the example explained thus far, the NC process performed by the FB-scheme NC apparatus 33FB may be executed using a sensor signal of the FF sensor 151.

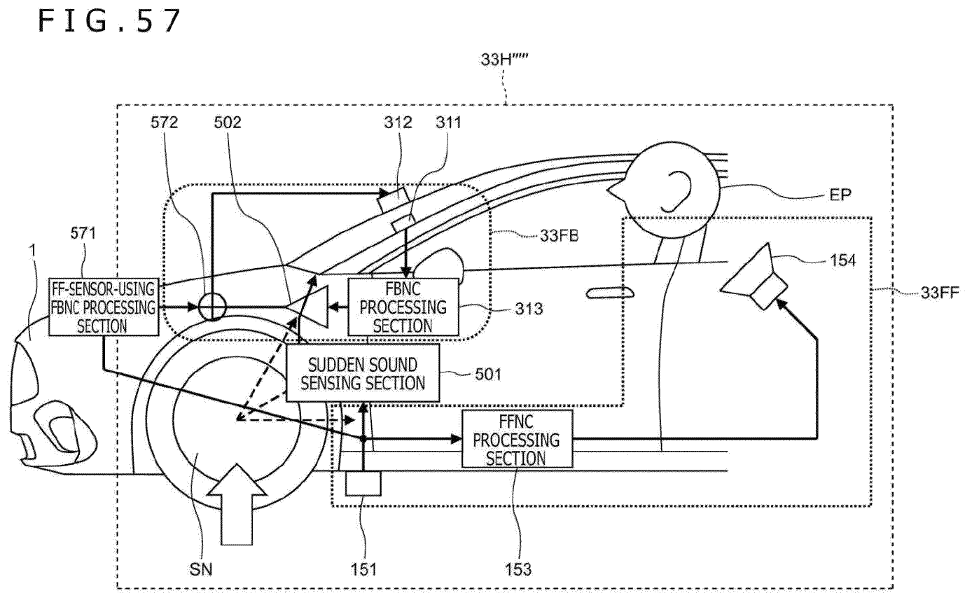

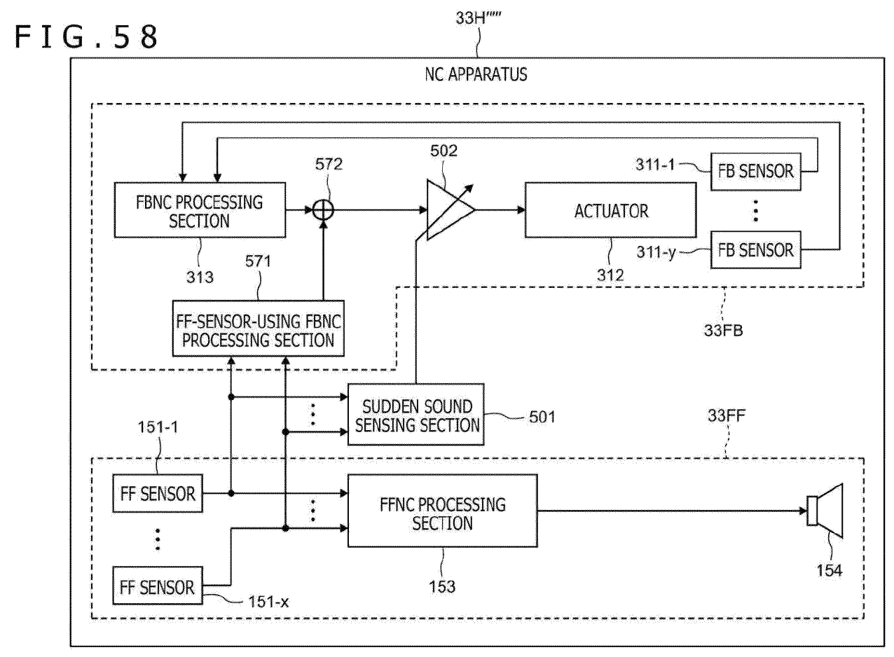

FIG. 57 and FIG. 58 depict a configuration example of an NC apparatus 33H″″′ in which the NC process performed by the FB-scheme NC apparatus 33FB is executed using a sensor signal of the FF sensor 151.

The NC apparatus 33H′ in FIG. 57 and FIG. 58 is different from the NC apparatus 33H in FIG. 44 and FIG. 45 in that the NC apparatus 33FB is additionally provided with an FF-sensor-using FBNC processing section 571 and an adder 572.

The FF-sensor-using FBNC processing section 571 basically has functions identical to the functions of the FBNC processing section 313, but is different from the FBNC processing section 313 in that the FF-sensor-using FBNC processing section 571 uses not a sensor signal of the FB sensor 311 but a sensor signal of the FF sensor 151 in the NC process.

As has been mentioned thus far, when the FB-scheme NC process is performed for a panel such as the front window FW, it becomes possible to perform control also on noise whose vibration sources are unknown.

Meanwhile, it is considered that vibration-induced noise emitted by being propagated to the front window FW is not limited only to unknown noise, and also includes noise whose input is known to some extent.

In view of this, by exciting the actuator 312 by using a sensor signal of the FF sensor 151 taking into consideration the fact that the FF sensor 151 is close to the vibration source of road noise, it becomes possible for the FBNC processing section 313 to focus its resources on a countermeasure against noise emitted by unknown noise, and enhancement of the NC performance of the feedback-scheme NC apparatus 33FB can be anticipated.

The FF-sensor-using FBNC processing section 571 generates a drive signal of the actuator 312 by using a sensor signal of the FF sensor 151 and outputs the drive signal to the adder 552.

The adder 572 adds together the drive signal of the actuator generated on the basis of the sensor signal of the FB sensor 311 by the FBNC processing section 313 and the drive signal of the actuator 312 generated using the sensor signal of the FF sensor 151 by the FF-sensor-using FBNC processing section 571, supplies the resultant drive signal to the actuator 312 via the volume adjusting section 502, and causes excitation.

With such a configuration, the FB-scheme NC apparatus 33FB can reduce known components included in unknown noise by the NC process using a sensor signal of the FF sensor 151 and can reduce pure unknown noise by the NC process using a sensor signal of the FB sensor 311, and it becomes possible to enhance the noise reduction performance.

### <NC Process Performed by FB-Scheme NC Apparatus in FIG. 58>

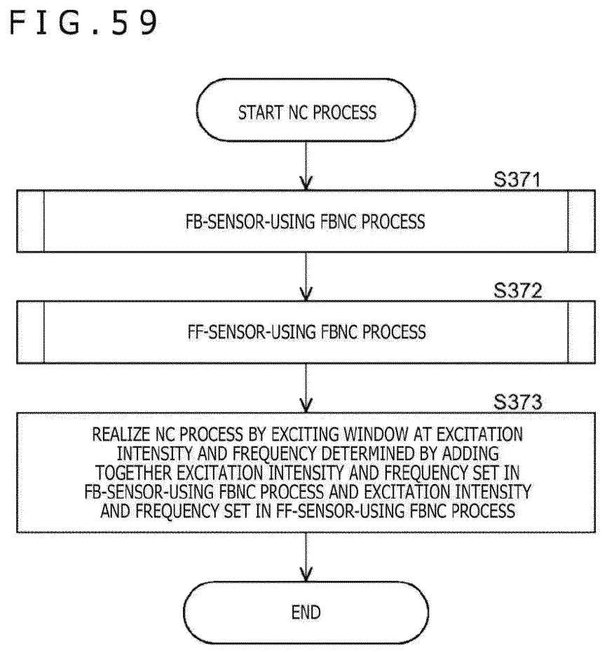

Next, the NC process performed by the FB-scheme NC apparatus 33FB in FIG. 58 is explained with reference to a flowchart in FIG. 59.

At Step S371, the FBNC processing section 313 executes an FB-sensor-using FBNC (feedback-scheme noise cancellation) process, generates a drive signal of the actuator on the basis of a sensor signal of the FB sensor 311, and outputs the drive signal to the adder 572. Note that, for example, the FB-sensor-using FFNC (feedback-scheme noise cancellation) process is the NC process of each configuration in the second embodiment.

At Step S372, the FF-sensor-using FBNC processing section 571 executes the FF-sensor-using FBNC process, generates a drive signal of the actuator 312 on the basis of a sensor signal of the FF sensor 151, and outputs the drive signal to the adder 572. Note that, for example, the FF-sensor-using FBNC (feedback-scheme noise cancellation) process is the NC process of each configuration in the second embodiment using a sensor signal of the FF sensor 151.

At Step S373, the drive signal of the actuator generated on the basis of the sensor signal of the FB sensor 311 by the FBNC processing section 313 and the drive signal of the actuator 312 generated using the sensor signal of the FF sensor 151 by the FF-sensor-using FBNC processing section 571 are added together, and the resultant drive signal is supplied to the actuator 312 via the volume adjusting section 502, thereby causing excitation.

By the process mentioned above, it becomes possible for the FB-scheme NC apparatus 33FB to reduce both noise expected in advance and sensed by the sensor 151 and unknown noise sensed by the sensor 311.

### 24. Sixth Modification Example of Third Embodiment

Thus far, a configuration example of the NC apparatus 33H″″′ combining the one FF-scheme NC apparatus 33FF and the one FB-scheme NC apparatus 33FB to execute the NC process performed by the FB-scheme NC apparatus 33FB using a sensor signal of the FF sensor 151 or the NC apparatus 33H″″ combining the one FF-scheme NC apparatus 33FF and the one FB-scheme NC apparatus 33FB to execute the NC process performed by the FF-scheme NC processing section 33FF using a sensor signal of the FB sensor 311 has been explained.

However, the combination of the numbers of the FF-scheme NC apparatus 33FF and the FB-scheme NC apparatus 33FB may be other than this. The NC process performed by the feedback-scheme NC apparatus 33FB may be executed using a sensor signal of the FF sensor 151, and the NC process performed by the FF-scheme NC processing section 33FF may be executed using a sensor signal of the FB sensor 311.

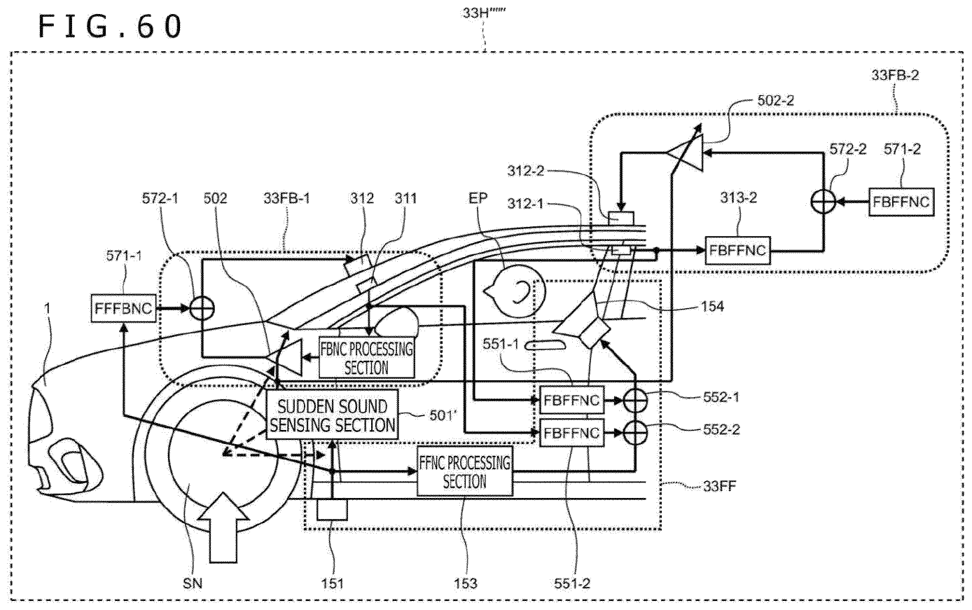

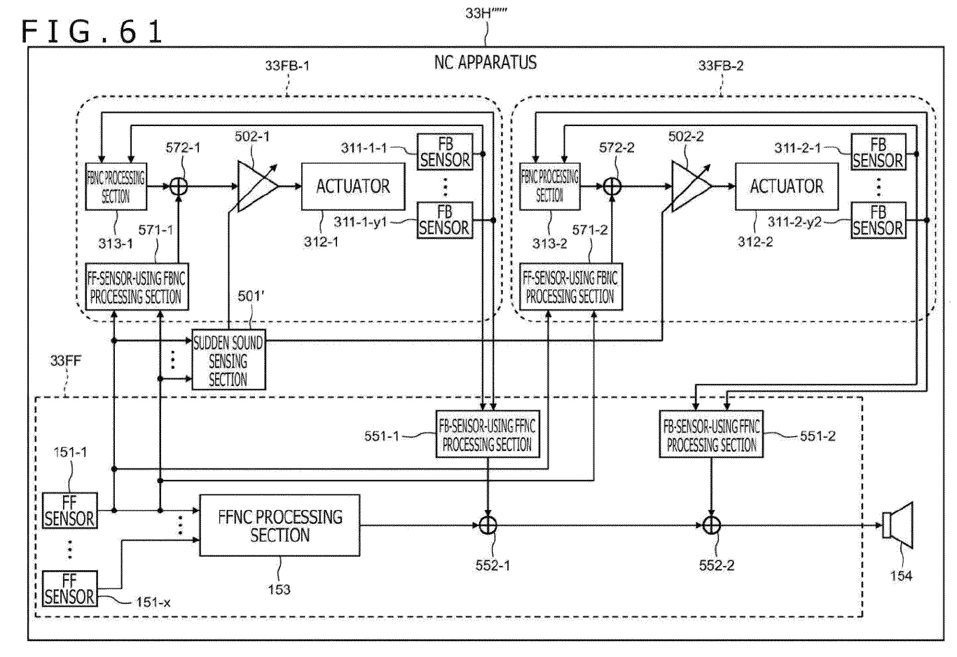

FIG. 60 and FIG. 61 depict a configuration example of an NC apparatus 33H′ configured by combining one FF-scheme NC apparatus 33FF and two FB-scheme NC apparatuses 33FB-1 and 33FB-2. In this example, as depicted in FIG. 60, the FB-scheme NC apparatus 33FB-1 is provided on the front window, and the FB-scheme NC apparatus 33FB-2 is provided on the roof window.

The one FF-scheme NC apparatus 33FF executes the FF-scheme NC process using also sensor signals of FB sensors 311-1 and 311-2 of the FB-scheme NC apparatuses 33FB-1 and 33FB-2, respectively, in addition to a sensor signal of the FF sensor 151.

In addition, the two FB-scheme NC apparatuses 33FB-1 and 33FB-2 realize the FB-scheme NC process using also a sensor signal of the FF sensor 151 in addition to sensor signals of the FB sensors 311-1 and 311-2, respectively.

The FF-scheme NC apparatus 33FF includes FB-sensor-using FFNC processing sections 551-1 and 551-2 and adders 552-1 and 552-2 in addition to FF sensors 151-1 to 151-x, the vehicle interior microphone 152, the FFNC processing section 153, and the speaker 154.

The FB-sensor-using FFNC processing section 551-1 executes the FF-scheme NC process on the basis of sensor signals of FB sensors 311-1-1 to 311-1-y1 of the FB-scheme NC apparatus 33FB-1, and outputs an inverse phase sound as a processing result to the adder 552-1.

The FB-sensor-using FFNC processing section 551-2 executes the FF-scheme NC process on the basis of sensor signals of FB sensors 311-2-1 to 311-2-y1 of the FB-scheme NC apparatus 33FB-2, and outputs an inverse phase sound as a processing result to the adder 552-2.

The adder 552-1 adds together an inverse phase sound output by the FFNC processing section 153 and the inverse phase sound output by the FB-sensor-using FFNC processing section 551-1, and outputs the resultant inverse phase sound to the adder 552-2.

The adder 552-2 adds together the inverse phase sound supplied from the adder 552-1 and the inverse phase sound output by the FB-sensor-using FFNC processing section 551-2, and causes the speaker 154 to emit the resultant inverse phase sound. That is, the adders 552-1 and 552-2 add together the respective inverse phase sounds generated at the FFNC processing section 153 and the FB-sensor-using FFNC processing sections 551-1 and 551-2, and the resultant inverse phase sound is emitted by the speaker 154.

The configurations of the FB-scheme NC apparatuses 33FB-1 and 33FB-2 are each identical to the configuration in FIG. 57 and FIG. 58, and accordingly, explanations thereof are omitted.

In addition, the sudden sound sensing section 501′ basically has functions identical to the functions of the sudden sound sensing section 501, but, when a sudden sound is sensed, performs a process to suppress the occurrence of a sudden sound by reducing the volumes of volume adjusting sections 502-1 and 502-2 of the FB-scheme NC apparatuses 33FB-1 and 33FB-2, respectively.

Note that the NC process performed by the NC apparatus 33H in FIG. 61 is basically similar to the process mentioned thus far, and accordingly, an explanation thereof is omitted.

### 25. Seventh Modification Example of Third Embodiment

In the example explained thus far, when a sudden sound is sensed, the sudden sound sensing section 501′ performs a process to suppress the occurrence of a sudden sound by reducing the volumes of the volume adjusting sections 502-1 and 502-2 of the FB-scheme NC apparatuses 33FB-1 and 33FB-2, respectively.

However, a sudden sound countermeasure process may be realized by sensing whether or not there are sudden sounds on the basis not only of a sensor signal of the FF sensor 151 but also of sensor signals of all the FB sensors 311 and centralizedly managing the volumes of drive signals of the actuators according to positions of sensors where sudden sounds are sensed.

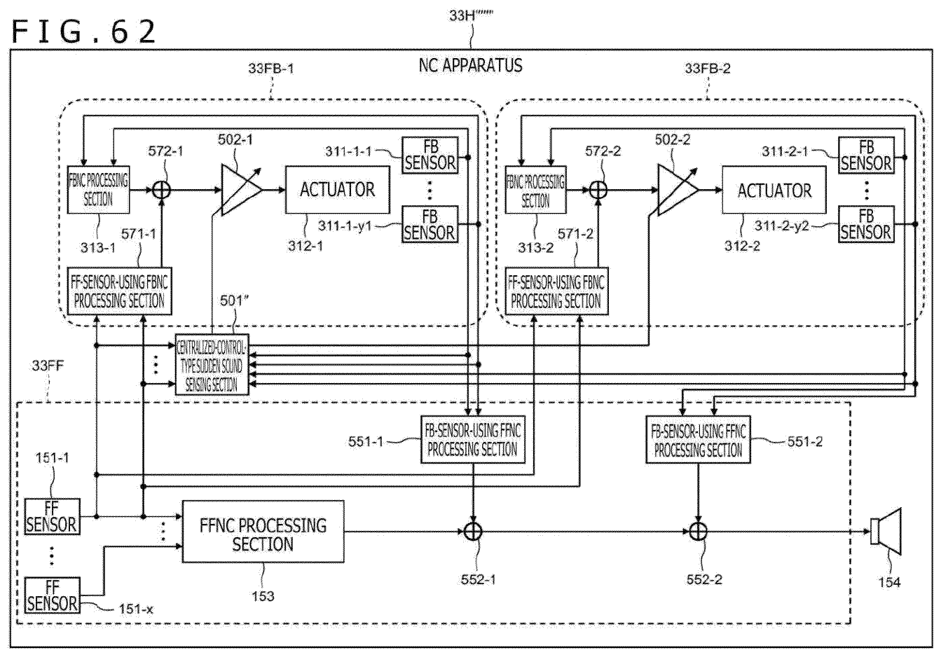

FIG. 62 depicts a configuration example of the NC apparatus 33H that senses whether there are sudden sounds on the basis not only of a sensor signal of the FF sensor 151 but also of sensor signals of all the FB sensors 311 and performs centralized control of the volumes of drive signals of the actuators according to positions of sensors where sudden sounds are sensed.

The NC apparatus 33H in FIG. 62 is different from the NC processing apparatus 33H in FIG. 61 in that a centralized-control-type sudden sound sensing section 501″ is provided instead of the sudden sound sensing section 501′.

The centralized-control-type sudden sound sensing section 501″ acquires sensor signals from all of the FF sensors 151-1 to 151-x and the FB sensors 311-1-1 to 311-1-y1 and 311-2-1 to 311-2-y2, and determines whether or not there is a sudden sound.

When a sudden sound is sensed by an FF sensor 151, the sudden sound countermeasure process is realized by the process mentioned above.

In addition, when a sudden sound is sensed by an FB sensor 311, the volume adjusting sections 502-1 and 502-1 are controlled in order and at timings according to the position of the FB sensor 311 where the sudden sound is sensed, and performs muting.

For example, in a case where it is determined that a sudden sound has been sensed on the basis of sensing of a sensor signal which is greater than a predetermined value at the FB sensor 311-1 of the front window FW due to a rapid change in atmospheric pressure at the time of entrance into a tunnel or the like, it is expected that there will be a case where sudden vibrations originated from aerodynamic effects occur.

In such a case, with the timing when the sudden sound is sensed by the sensor 311-1 of the front window FW as a trigger, a process to reduce the volume by controlling the volume adjusting section 502-2 in the FB-scheme NC apparatus 33FB-2 is performed in synchronization with the timing when a sudden sound is sensed at the roof window, to thereby realize the sudden sound countermeasure process performed by the FB-scheme NC apparatus 33FB-2.

That is, using, as a reference, an FB sensor 311 of the front window FB that has received an input which is equal to or greater than a predetermined threshold, volume control according to a vibration propagation distance to the other feedback-scheme NC apparatus 33FB may be realized, so that a centralized-control-type sudden sound countermeasure process is realized.

Note that, in the example explained thus far, when a sudden sound is sensed on the basis of a sensor signal sensed by an FF sensor 151 or an FB sensor 311, the volume of a drive signal of an actuator is adjusted.

However, when a sudden sound is sensed on the basis of a sensor signal sensed by an FF sensor 151 or an FB sensor 311, the volume of a sound emitted from the speaker 154 may be adjusted.

That is, it can also be considered that signals of inverse phase sounds that are output by the FFNC processing section 153 and the FB-sensor-using FFNC processing sections 551 and are for being emitted by the speaker 154 are drive signals for driving the speaker 154.

In view of this, a volume adjusting section X (not illustrated) that adjusts the volume of a drive signal including a signal of an inverse phase sound for driving the speaker 154 and corresponds to the volume adjusting section 502 may be provided between the adder 552-2 and the speaker 154 in FIG. 62, for example.

Then, when a sudden sound is sensed on the basis of a sensor signal sensed by an FF sensor 151 or an FB sensor 311, the centralized-control-type sudden sound sensing section 501″ may control the volume adjusting section X (not illustrated) to make such an adjustment that the volume of a sound to be emitted from the speaker 154 is lowered, for example.

### 26. Eighth Modification Example of Third Embodiment

While the FF-scheme NC apparatus 33FF and the FB-scheme NC apparatus 33FB are configured in combination in the example explained thus far, it may be made possible to freely make settings as to which functions are to be used or are not to be used.

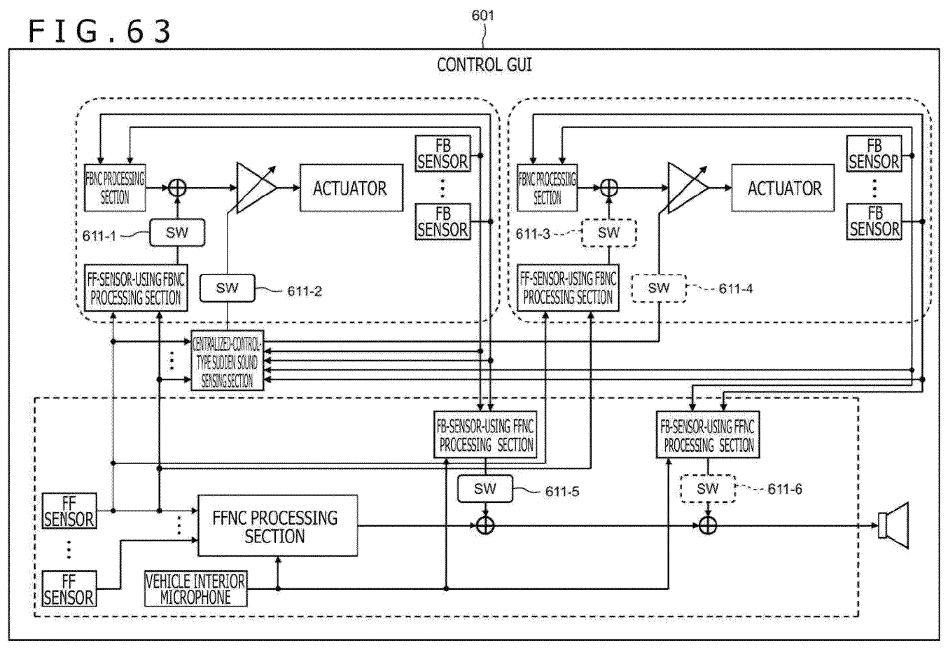

For example, it may be made possible to freely make settings by intuitive operation using a GUI 601 like the one depicted in FIG. 63.

In FIG. 63, the configuration of the NC apparatus 33H″″″′ in FIG. 62 is displayed, and whether or not to enable functions can be set by turning on or off SWs 611-1 to 611-6 and the like.

The SW 611-1 is a switch for a setting as to whether or not processing results of the FF-sensor-using FBNC processing section on the front window side are to be output.

The SW 611-2 is a switch for a setting as to whether or not the volume of a drive signal of the actuator on the front window side is to be controlled when the centralized-control-type sudden sound sensing section has sensed a sudden sound.

The SW 611-3 is a switch for a setting as to whether or not processing results of the FF-sensor-using FBNC processing section on the roof window side are to be output.

The SW 611-4 is a switch for a setting as to whether or not the volume of a drive signal of the actuator on the roof window side is to be controlled when the centralized-control-type sudden sound sensing section has sensed a sudden sound.

The SWs 611-5 and 611-6 are switches for settings as to whether or not processing results of the two respective FB-sensor-using FFNC processing sections are to be output.

The SWs 611-1 to 611-6 are each represented by a solid-line frame, which means that it has been turned on, when tapped once, and represented by a dotted-line frame, which means that it has been turned off, when tapped once more.

FIG. 63 depicts a state where the SWs 611-1, 611-2, and 611-5 have been turned on and the SWs 611-3, 611-4, and 611-6 have been turned off.

### 27. Example of Execution by Software

Meanwhile, the series of processes mentioned above can be executed by hardware and can also be executed by software. In a case where the series of processes is executed by software, a program included in the software is installed from a recording medium onto a computer incorporated in dedicated hardware, a general-purpose computer, for example, that can execute various types of function by installing various types of program, or the like.

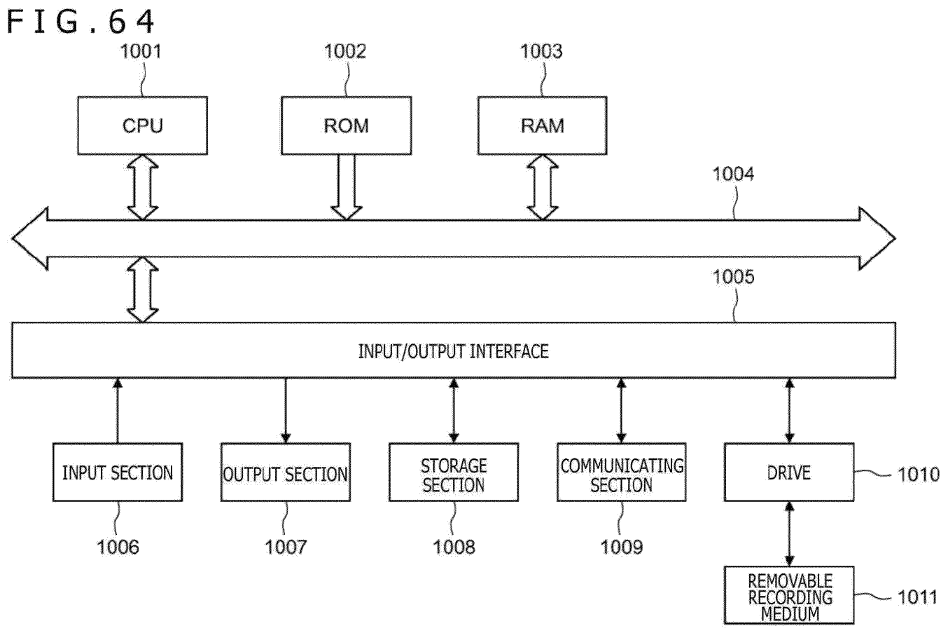

FIG. 64 depicts a configuration example of a general-purpose computer. This computer has a built-in CPU (Central Processing Unit) 1001. The CPU 1001 is connected with an input/output interface 1005 via a bus 1004. The bus 1004 is connected with a ROM (Read Only Memory) 1002 and a RAM (Random Access Memory) 1003.

The input/output interface 1005 is connected with an input section 1006 including input devices such as a keyboard and a mouse by which a user inputs operation commands, an output section 1007 that outputs, to a display device, process operation screens or processing result images, a storage section 1008 including a hard disk drive that stores programs and various types of data, and the like, and a communicating section 1009 that includes a LAN

(Local Area Network) adapter and the like and executes communication processes via a network represented by the Internet. In addition, a drive 1010 is connected. The drive 1010 reads data from and writes data onto a removable storage medium 1011 such as a magnetic disc (including a flexible disc), an optical disc (including a CD-ROM (Compact Disc-Read Only Memory) and a DVD (Digital Versatile Disc)), a magneto-optical disc (including an MD (Mini Disc)), or a semiconductor memory.

The CPU 1001 executes various types of process in accordance with programs that have been stored on the ROM 1002 or programs that are read out from the removable storage medium 1011 such as a magnetic disc, an optical disc, a magneto-optical disc, or a semiconductor memory, installed on the storage section 1008, and loaded onto the RAM 1003 from the storage section 1008. The RAM 1003 further stores, as appropriate, data that is required for the execution of various types of process by the CPU 1001, or the like.

In the thus-configured computer, the series of processes mentioned above is performed by the CPU 1001, for example, loading a program stored on the storage section 1008 onto the RAM 1003 via the input/output interface 1005 and the bus 1004 and executing the program.

For example, programs to be executed by the computer (CPU 1001) can be provided being recorded on the removable storage medium 1011 as a package medium or the like. In addition, programs can be provided via a cable transfer medium or a wireless transfer medium like a local area network, the Internet, or digital satellite broadcasting.

In the computer, programs can be installed on the storage section 1008 via the input/output interface 1005 by the removable storage medium 1011 being attached to the drive 1010. In addition, programs can be received at the communicating section 1009 via a cable transfer medium or a wireless transfer medium and installed on the storage section 1008. Other than these, programs can be installed in advance on the ROM 1002 or the storage section 1008.

Note that programs to be executed by the computer may be programs that perform processes sequentially in the order explained in the present specification or may be programs that perform processes in parallel or at necessary timings such as timings when the processes are called.

Note that the CPU 1001 in FIG. 64 realizes the functions of the NC apparatus 33.

In addition, in the present specification, a system means a set of a plurality of constituent elements (apparatuses, modules (parts), etc.), and it does not matter whether or not all the constituent elements are in a single housing. Accordingly, a plurality of apparatuses housed in separate housings and connected via a network, and one apparatus with one housing having housed therein a plurality of modules are both systems.

Note that embodiments of the present disclosure are not limited to the embodiments mentioned above and can be changed in various manners within the scope not departing from the gist of the present disclosure.

For example, the present disclosure can have a configuration of cloud computing that processes one function in a shared and cooperative manner by a plurality of apparatuses via a network.

In addition, other than being executed by one apparatus, each step explained with reference to the flowcharts mentioned above can be executed in a shared manner by a plurality of apparatuses.

Furthermore, in a case where one step includes a plurality of processes, other than being executed by one apparatus, the plurality of processes included in the one step can be executed in a shared manner by a plurality of apparatuses.

Note that the present disclosure can also adopt configurations like the ones below.

<1>

A noise suppressing apparatus including:
a first processing section that executes a process to reduce noise at a control point by generating and outputting a sound to cancel the noise or a vibration to excite a noise-source vibrating object, on the basis of a first sensor signal including an acceleration of the object; and
a second processing section that executes a process to reduce noise at a control point by generating and outputting a sound to cancel the noise or a vibration to excite a noise-source vibrating object, on the basis of a second sensor signal that is different from the first sensor signal and includes an acceleration of the object, in which,
when a sudden sound is sensed on the basis of the first sensor signal, a drive signal at the second processing section is adjusted.
   <2>

The noise suppressing apparatus according to <1>, in which
the second processing section is an FBNC (feedback noise cancellation) processing section that executes an FBNC process to generate a drive signal for an excitation device that excites the object, by implementing an NC (noise cancellation) filtering process on the second sensor signal, suppress a vibration of the object by causing excitation, and reduce the noise, and,
when the sudden sound is sensed on the basis of the first sensor signal, the drive signal at the FBNC processing section is adjusted.
   <3>

The noise suppressing apparatus according to <1>, in which
the first processing section is an FFNC (feedforward noise cancellation) processing section that executes an FFNC process to reduce noise at the control point by generating and emitting a sound to cancel the noise on the basis of the first sensor signal,
the second processing section is an FBNC (feedback noise cancellation) processing section that executes an FBNC process to generate a drive signal for an excitation device that excites the object, by implementing an NC (noise cancellation) filtering process on the second sensor signal, suppress a vibration of the object by causing excitation, and reduce the noise, and,
when information regarding the sudden sound is sensed on the basis of the first sensor signal, the drive signal at the FBNC processing section is adjusted.
   <4>

The noise suppressing apparatus according to <1>, in which
the second processing section is an FFNC processing section that executes an FFNC process to generate a drive signal for emitting a sound to cancel noise at the control point, on the basis of the second sensor signal, and reduce the noise by emitting the sound on the basis of the drive signal, and,
when information regarding the sudden sound is sensed on the basis of the first sensor signal, the drive signal at the FFNC processing section is adjusted.
   <5>

The noise suppressing apparatus according to <3>, further including:
an FF (feedforward) sensor that senses, as the first sensor signal, an acceleration to be used at the FFNC processing section;
an FB (feedback) sensor that senses, as the second sensor signal, an acceleration to be used at the FBNC processing section;
an adjusting section that adjusts the drive signal for the excitation device; and
a sudden sound sensing section that senses a sudden sound on the basis of the first sensor signal of the FF sensor, in which,
when the sudden sound sensing section senses the sudden sound, the sudden sound sensing section controls the adjusting section and causes the adjusting section to adjust the drive signal.
   <6>

The noise suppressing apparatus according to <5>, in which
the adjusting section adjusts a volume of the drive signal, and,
when the sensed sudden sound occur once, the sudden sound sensing section controls the adjusting section and causes the adjusting section to reduce an output volume of the drive signal to a muted state for a predetermined length of time including a timing when the second sensor signal corresponding to the sudden sound is sensed at the FB sensor.
   <7>

The noise suppressing apparatus according to <5>, in which
the adjusting section adjusts a volume of the drive signal, and,
when the sensed sudden sound occurs consecutively in a periodic manner, the sudden sound sensing section controls the adjusting section and causes the adjusting section to reduce an output volume of the drive signal to a muted state until a timing when a sensor signal corresponding to the sudden sound is sensed at the FB sensor, and thereafter adjust the output volume to a value smaller than a reference value.
   <8>

The noise suppressing apparatus according to <5>, in which
the adjusting section implements a band-stop filtering process on the drive signal, and,
when the sudden sound sensing section senses the sudden sound, the sudden sound sensing section controls the adjusting section and causes the adjusting section to apply, to the drive signal, a band-stop filtering process according to a frequency of the sudden sound.
   <9>

The noise suppressing apparatus according to <8>, further including:
a frequency analyzing section that analyzes the frequency of the sudden sound; and
a filter searching section that searches for a corresponding band-stop filter on the basis of a frequency analysis result of the frequency analyzing section, in which,
when the sudden sound sensing section senses the sudden sound, the sudden sound sensing section controls the filter searching section and causes the filter searching section to search for a band-stop filter corresponding to the analysis result of the frequency analyzing section, and
the adjusting section applies the band-stop filtering process to the drive signal by using the band-stop filter which is a search result of the filter searching section.
   <10>

The noise suppressing apparatus according to <9>, further including:
a storing section that stores a plurality of band-stop filters, in which
the filter searching section searches for a band-stop filter according to corresponding frequency characteristics among the plurality of band-stop filters stored on the storing section, on the basis of the frequency analysis result, and supplies the band-stop filter which is a search result to the adjusting section, and
the adjusting section applies, to the drive signal, the band-stop filtering process using the band-stop filter supplied from the filter searching section.
   <11>

The noise suppressing apparatus according to <9>, in which
the adjusting section further includes
   a plurality of band-stop filtering processing sections that perform, in parallel, band-stop filtering processes corresponding to a plurality of frequency bands on the drive signal, and
   a selecting section that selects any of outputs of the drive signal on which the band-stop filtering processes have been implemented by the plurality of band-stop filtering processing sections, and outputs the selected output to the excitation device, and,
on the basis of the frequency analysis result, the filter searching section controls the selecting section and causes the selecting section to output, from among the outputs of the plurality of band-stop filtering processing sections, the drive signal having undergone a band-stop filtering process found by a search based on the frequency analysis result, to the excitation device.
   <12>

The noise suppressing apparatus according to <5>, further including:
another FFNC processing section that is different from the FFNC processing section and executes the FFNC process on the basis of a sensor signal sensed by the FB sensor.
   <13>

The noise suppressing apparatus according to <12>, further including:
an adder that adds together a sound to cancel noise at the control point which sound is a result of the process performed by the FFNC processing section and a sound to cancel noise at the control point which sound is a result of the process performed by the other FFNC processing section.
   <14>

The noise suppressing apparatus according to <5>, further including:
another FBNC processing section that is different from the FBNC processing section and executes the FBNC process on the basis of a sensor signal sensed by the FF sensor.
   <15>

The noise suppressing apparatus according to <12>, further including:
an adder that adds together the drive signal which is a result of the process performed by the FBNC processing section and the drive signal which is a result of the process performed by the other FBNC processing section.
   <16>

The noise suppressing apparatus according to <5>, further including:
another FFNC processing section that is different from the FFNC processing section and executes the FFNC process on the basis of a sensor signal sensed by the FB sensor; and
another FBNC processing section that is different from the FBNC processing section and executes the FBNC process on the basis of a sensor signal sensed by the FF sensor.
   <17>

The noise suppressing apparatus according to <16>, further including:
a first adder that adds together a sound to cancel noise at the control point which sound is a result of the process performed by the FFNC processing section and a sound to cancel noise at the control point which sound is a result of the process performed by the other FFNC processing section; and
a second adder that adds together the drive signal which is a result of the process performed by the FBNC processing section and the drive signal which is a result of the process performed by the other FBNC processing section.
   <18>

The noise suppressing apparatus according to <16>, in which, in a case where there are a plurality of the FBNC processing sections, when the sudden sound sensing section senses the sudden sound, the sudden sound sensing section controls the adjusting section of the plurality of FBNC processing sections and causes the adjusting section to adjust the drive signal.

<19>

The noise suppressing apparatus according to <16>, in which, in a case where there are a plurality of the FBNC processing sections, the sudden sound sensing section senses a sudden sound on the basis of a sensor signal of the FB sensor in addition to a sensor signal of the FF sensor, and, when the sudden sound sensing section senses the sudden sound on the basis of the sensor signal of the FB sensor, controls the adjusting section of the plurality of FBNC processing sections and causes the adjusting section to adjust the drive signal according to a position of the FB sensor having sensed the sudden sound.

<20>

A noise suppression method including steps of:
executing a first process to reduce noise at a control point by generating and outputting a sound to cancel the noise or a vibration to excite a noise-source vibrating object, on the basis of a first sensor signal including an acceleration of the object; and
executing a second process to reduce noise at a control point by generating and outputting a sound to cancel the noise or a vibration to excite a noise-source vibrating object, on the basis of a second sensor signal that is different from the first sensor signal and includes an acceleration of the object, in which,
when a sudden sound is sensed on the basis of the first sensor signal, a drive signal in the second process is adjusted.
   <21>

A program for causing a computer to function as:
a first processing section that executes a process to reduce noise at a control point by generating and outputting a sound to cancel the noise or a vibration to excite a noise-source vibrating object, on the basis of a first sensor signal including an acceleration of the object; and
a second processing section that executes a process to reduce noise at a control point by generating and outputting a sound to cancel the noise or a vibration to excite a noise-source vibrating object, on the basis of a second sensor signal that is different from the first sensor signal and includes an acceleration of the object, in which,
when a sudden sound is sensed on the basis of the first sensor signal, a drive signal at the second processing section is adjusted.

### REFERENCE SIGNS LIST

33, 33B, 33F, 33FB, 33FF, 33H, 33H′ to 33H″″″′: NC apparatus
151, 151-1 to 151-n: Sensor (FF sensor)
152: Vehicle interior microphone
153, 153′: NC processing section (FFNC processing section)
154: Speaker
171: Sensor filter designing section
172: Sensor filter set storage section
173: Cancellation filter set storage section
174: Corresponding filter acquiring section
175: NC signal calculating section
181, 181′: Filter generation processing section
182: Control point proximity microphone
191: Cancellation filter designing section
192: Association/storage processing section
211: Vehicle exterior microphone
221: Vehicle exterior sound determining section
251, 251′: DNN inferring section
252, 252′: Trained model storage section
253: Filter searching section
254: Cancellation filter storage section
255: NC signal calculating section
271, 271′: Cancellation filter designing section
272: Filter recording control section
273, 273′: DNN training section
311, 311′,311″: Sensor (FB sensor)
312, 312A to 312G: Actuator
312Ba to 312Ga: Driving section
312Bb to 312Gb: Base
313, 313′: NC processing section (FBNC processing section)
331: Amplifier
332, 332-1 to 332-n, 332c, 332h: NC filtering processing section
333: Amplifier
371: Base plate
372: Bolt
382a, 382b: Wiring connection section
391, 401: Connector
402: Screw
421: Switch
421′: Switching section
422: Switch
423, 423′,423″: Operation control section
441: Sun direction calculating section
501, 501′: Sudden sound sensing section
501″: Centralized-control-type sudden sound sensing section
502: Volume adjusting section
511: Filter searching section
512: Cutoff filter set storage section
531, 531-1 to 531-m: First band-stop filter to m-th band-stop filter
532: Selecting section
551: FB-sensor-using FFNC processing section
552: Adder
571: FF-sensor-using FBNC processing section
572: Adder

1. A noise suppressing apparatus comprising:
a first processing section that executes a process to reduce noise at a control point by generating and outputting a sound to cancel the noise or a vibration to excite a noise-source vibrating object, on a basis of a first sensor signal including an acceleration of the object; and
a second processing section that executes a process to reduce noise at a control point by generating and outputting a sound to cancel the noise or a vibration to excite a noise-source vibrating object, on a basis of a second sensor signal that is different from the first sensor signal and includes an acceleration of the object, wherein,
when a sudden sound is sensed on the basis of the first sensor signal, a drive signal at the second processing section is adjusted.

2. The noise suppressing apparatus according to claim 1, wherein
the second processing section is an FBNC (feedback noise cancellation) processing section that executes an FBNC process to generate a drive signal for an excitation device that excites the object, by implementing an NC (noise cancellation) filtering process on the second sensor signal, suppress a vibration of the object by causing excitation, and reduce the noise, and,
when the sudden sound is sensed on the basis of the first sensor signal, the drive signal at the FBNC processing section is adjusted.

3. The noise suppressing apparatus according to claim 1, wherein
the first processing section is an FFNC (feedforward noise cancellation) processing section that executes an FFNC process to reduce noise at the control point by generating and emitting a sound to cancel the noise on the basis of the first sensor signal,
the second processing section is an FBNC (feedback noise cancellation) processing section that executes an FBNC process to generate a drive signal for an excitation device that excites the object, by implementing an NC (noise cancellation) filtering process on the second sensor signal, suppress a vibration of the object by causing excitation, and reduce the noise, and,
when information regarding the sudden sound is sensed on the basis of the first sensor signal, the drive signal at the FBNC processing section is adjusted.

4. The noise suppressing apparatus according to claim 1, wherein
the second processing section is an FFNC processing section that executes an FFNC process to generate a drive signal for emitting a sound to cancel noise at the control point, on the basis of the second sensor signal, and reduce the noise by emitting the sound on a basis of the drive signal, and,
when information regarding the sudden sound is sensed on the basis of the first sensor signal, the drive signal at the FFNC processing section is adjusted.

5. The noise suppressing apparatus according to claim 3, further comprising:
an FF (feedforward) sensor that senses, as the first sensor signal, an acceleration to be used at the FFNC processing section;
an FB (feedback) sensor that senses, as the second sensor signal, an acceleration to be used at the FBNC processing section;
an adjusting section that adjusts the drive signal for the excitation device; and
a sudden sound sensing section that senses a sudden sound on a basis of the first sensor signal of the FF sensor, wherein,
when the sudden sound sensing section senses the sudden sound, the sudden sound sensing section controls the adjusting section and causes the adjusting section to adjust the drive signal.

6. The noise suppressing apparatus according to claim 5, wherein
the adjusting section adjusts a volume of the drive signal, and,
when the sensed sudden sound occur once, the sudden sound sensing section controls the adjusting section and causes the adjusting section to reduce an output volume of the drive signal to a muted state for a predetermined length of time including a timing when the second sensor signal corresponding to the sudden sound is sensed at the FB sensor.

7. The noise suppressing apparatus according to claim 5, wherein
the adjusting section adjusts a volume of the drive signal, and,
when the sensed sudden sound occurs consecutively in a periodic manner, the sudden sound sensing section controls the adjusting section and causes the adjusting section to reduce an output volume of the drive signal to a muted state until a timing when a sensor signal corresponding to the sudden sound is sensed at the FB sensor, and thereafter adjust the output volume to a value smaller than a reference value.

8. The noise suppressing apparatus according to claim 5, wherein
the adjusting section implements a band-stop filtering process on the drive signal, and,
when the sudden sound sensing section senses the sudden sound, the sudden sound sensing section controls the adjusting section and causes the adjusting section to apply, to the drive signal, a band-stop filtering process according to a frequency of the sudden sound.

9. The noise suppressing apparatus according to claim 8, further comprising:
a frequency analyzing section that analyzes the frequency of the sudden sound; and
a filter searching section that searches for a corresponding band-stop filter on a basis of a frequency analysis result of the frequency analyzing section, wherein,
when the sudden sound sensing section senses the sudden sound, the sudden sound sensing section controls the filter searching section and causes the filter searching section to search for a band-stop filter corresponding to the analysis result of the frequency analyzing section, and
the adjusting section applies the band-stop filtering process to the drive signal by using the band-stop filter which is a search result of the filter searching section.

10. The noise suppressing apparatus according to claim 9, further comprising:
a storing section that stores a plurality of band-stop filters, wherein
the filter searching section searches for a band-stop filter according to corresponding frequency characteristics among the plurality of band-stop filters stored on the storing section, on the basis of the frequency analysis result, and supplies the band-stop filter which is a search result to the adjusting section, and
the adjusting section applies, to the drive signal, the band-stop filtering process using the band-stop filter supplied from the filter searching section.

11. The noise suppressing apparatus according to claim 5, further comprising:
another FFNC processing section that is different from the FFNC processing section and executes the FFNC process on a basis of a sensor signal sensed by the FB sensor.

12. The noise suppressing apparatus according to claim 11, further comprising:
an adder that adds together a sound to cancel noise at the control point which sound is a result of the process performed by the FFNC processing section and a sound to cancel noise at the control point which sound is a result of the process performed by the other FFNC processing section.

13. The noise suppressing apparatus according to claim 5, further comprising:
another FBNC processing section that is different from the FBNC processing section and executes the FBNC process on a basis of a sensor signal sensed by the FF sensor.

14. The noise suppressing apparatus according to claim 11, further comprising:
an adder that adds together the drive signal which is a result of the process performed by the FBNC processing section and the drive signal which is a result of the process performed by the other FBNC processing section.

15. The noise suppressing apparatus according to claim 5, further comprising:
another FFNC processing section that is different from the FFNC processing section and executes the FFNC process on a basis of a sensor signal sensed by the FB sensor; and
another FBNC processing section that is different from the FBNC processing section and executes the FBNC process on a basis of a sensor signal sensed by the FF sensor.

16. The noise suppressing apparatus according to claim 15, further comprising:
a first adder that adds together a sound to cancel noise at the control point which sound is a result of the process performed by the FFNC processing section and a sound to cancel noise at the control point which sound is a result of the process performed by the other FFNC processing section; and
a second adder that adds together the drive signal which is a result of the process performed by the FBNC processing section and the drive signal which is a result of the process performed by the other FBNC processing section.

17. The noise suppressing apparatus according to claim 15, wherein, in a case where there are a plurality of the FBNC processing sections, when the sudden sound sensing section senses the sudden sound, the sudden sound sensing section controls the adjusting section of the plurality of FBNC processing sections and causes the adjusting section to adjust the drive signal.

18. The noise suppressing apparatus according to claim 15, wherein, in a case where there are a plurality of the FBNC processing sections, the sudden sound sensing section senses a sudden sound on a basis of a sensor signal of the FB sensor in addition to a sensor signal of the FF sensor, and, when the sudden sound sensing section senses the sudden sound on the basis of the sensor signal of the FB sensor, controls the adjusting section of the plurality of FBNC processing sections and causes the adjusting section to adjust the drive signal according to a position of the FB sensor having sensed the sudden sound.

19. A noise suppression method comprising steps of:
executing a first process to reduce noise at a control point by generating and outputting a sound to cancel the noise or a vibration to excite a noise-source vibrating object, on a basis of a first sensor signal including an acceleration of the object; and
executing a second process to reduce noise at a control point by generating and outputting a sound to cancel the noise or a vibration to excite a noise-source vibrating object, on a basis of a second sensor signal that is different from the first sensor signal and includes an acceleration of the object, wherein,
when a sudden sound is sensed on the basis of the first sensor signal, a drive signal in the second process is adjusted.

20. A program for causing a computer to function as:
a first processing section that executes a process to reduce noise at a control point by generating and outputting a sound to cancel the noise or a vibration to excite a noise-source vibrating object, on a basis of a first sensor signal including an acceleration of the object; and
a second processing section that executes a process to reduce noise at a control point by generating and outputting a sound to cancel the noise or a vibration to excite a noise-source vibrating object, on a basis of a second sensor signal that is different from the first sensor signal and includes an acceleration of the object, wherein,
when a sudden sound is sensed on the basis of the first sensor signal, a drive signal at the second processing section is adjusted.
